(19) United States
(12) Patent Application Publication
(10) Pub. No.: US 2026/0277012 A1
(43) Pub. Date: Sep. 17, 2026

(54) OPTICAL SYSTEM, OPTICAL DEVICE, AND METHOD FOR MANUFACTURING OPTICAL SYSTEM

(71) Applicant: NIKON CORPORATION, Tokyo (JP)

(72) Inventor: Takamichi KURASHIGE, Tokyo (JP)

(21) Appl. No.: 19/668,038

(22) Filed: May 5, 2026

Related U.S. Application Data
(63) Continuation of application No. PCT/JP2024/039543, filed on Nov. 7, 2024.

(30) Foreign Application Priority Data
Nov. 8, 2023 (JP) 2023-191050

(51) Int. Cl. G02B 27/12; G02B 3/00; G02B 7/02; G02B 13/18

(52) U.S. Cl. CPC G02B 27/126; G02B 7/025; G02B 13/18; G02B 2003/0093

(57) ABSTRACT

An optical system includes a first optical system including, in order from the object side, a front lens group, an optical path splitter having a splitting plane, and a first rear lens group on which light that enters the front lens group and the optical path splitter and that is reflected by the splitting plane is incident. The optical system further includes a second optical system including, in order from the object side, the front lens group, the optical path splitter, and a second rear lens group on which light that enters the front lens group and the optical path splitter and that is transmitted through the splitting plane is incident. The second optical system is configured to have a total focal length different from a total focal length of the first optical system.

### CROSS-REFERENCE TO RELATED APPLICATIONS

This application is a continuation of International Patent Application No. PCT/JP2024/039543 filed Nov. 7, 2024, which claims priority from Japanese Patent Application No. 2023-191050 filed Nov. 8, 2023, and which are incorporated herein by reference.

### FIELD

The present disclosure relates to an optical system, an optical device, and a method for manufacturing an optical system.

### BACKGROUND

A proposed optical device separates light from a subject passing through a photographic lens into visible light and infrared light, and forms a visible light image and an infrared light image at mutually different positions (see, e. g., Japanese Unexamined Patent Publication No. 2010-102281).

### SUMMARY

An optical system of the present disclosure includes, in order from an object side, a first optical system having a front lens group having negative refractive power, an optical path splitter with a splitting plane that transmits a first part of incident light and reflects at least a second part of the incident light different from the first part, and a first rear lens group on which first light that is at least a part of light reflected by the splitting plane is incident; and a second optical system having, in order from the object side, the front lens group, the optical path splitter, and a second rear lens group on which second light that is at least a part of light transmitted through the splitting plane is incident, wherein the second optical system has a total focal length different from a total focal length of the first optical system.

The method for manufacturing an optical system of the present disclosure is a method for manufacturing an optical system having a splitting plane that transmits a first part of incident light and reflects at least a second part of the incident light different from the first part, and that forms images of first light that is at least a part of light reflected by the splitting plane and second light that is at least a part of light transmitted through the splitting plane, the method including: arranging a first optical system to include, in order from an object side, a front lens group having negative refractive power, an optical path splitter having the splitting plane, and a first rear lens group on which the first light is incident; arranging a second optical system to include, in order from the object side, the front lens group, the optical path splitter, and a second rear lens group on which the second light is incident; and configuring the second optical system to have a total focal length different from a total focal length of the first optical system.

### BRIEF DESCRIPTION OF THE DRAWINGS

FIG. 1 schematically shows an example of an overall configuration of the optical system of the embodiment.

FIG. 2 is a cross-sectional view of a first optical system included in the optical system of Example 1.

FIG. 3 shows aberrations of the first optical system included in the optical system of Example 1.

FIG. 4 is a cross-sectional view of a second optical system included in the optical system of Example 1.

FIG. 5 shows aberrations of the second optical system included in the optical system of Example 1.

FIG. 6 is a cross-sectional view of a first optical system included in the optical system of Example 2.

FIG. 7 shows aberrations of the first optical system included in the optical system of Example 2.

FIG. 8 is a cross-sectional view of a second optical system included in the optical system of Example 2.

FIG. 9 shows aberrations of the second optical system included in the optical system of Example 2.

FIG. 10 is a cross-sectional view of a first optical system included in the optical system of Example 3.

FIG. 11 shows aberrations of the first optical system included in the optical system of Example 3.

FIG. 12 is a cross-sectional view of a second optical system included in the optical system of Example 3.

FIG. 13 shows aberrations of the second optical system included in the optical system of Example 3.

FIG. 14 is a cross-sectional view of a first optical system included in the optical system of Example 4.

FIG. 15 shows aberrations of the first optical system included in the optical system of Example 4.

FIG. 16 is a cross-sectional view of a second optical system included in the optical system of Example 4.

FIG. 17 shows aberrations of the second optical system included in the optical system of Example 4.

FIG. 18 is a cross-sectional view of a first optical system included in the optical system of Example 5.

FIG. 19 shows aberrations of the first optical system included in the optical system of Example 5.

FIG. 20 is a cross-sectional view of a second optical system included in the optical system of Example 5.

FIG. 21 shows aberrations of the second optical system included in the optical system of Example 5.

FIG. 22 is a cross-sectional view of a first optical system included in the optical system of Example 6.

FIG. 23 shows aberrations of the first optical system included in the optical system of Example 6.

FIG. 24 is a cross-sectional view of a second optical system included in the optical system of Example 6.

FIG. 25 shows aberrations of the second optical system included in the optical system of Example 6.

FIG. 26 schematically shows an overall configuration of the optical system of Example 7.

FIG. 27 is a cross-sectional view of a first optical system included in the optical system of Example 7.

FIG. 28 shows aberrations of the first optical system included in the optical system of Example 7.

FIG. 29 is a cross-sectional view of a second optical system included in the optical system of Example 7.

FIG. 30 shows aberrations of the second optical system included in the optical system of Example 7.

FIG. 31 schematically shows an overall configuration of the optical system of Example 8.

FIG. 32 is a cross-sectional view of a first optical system included in the optical system of Example 8-1.

FIG. 33 shows aberrations of the first optical system included in the optical system of Example 8-1.

FIG. 34 is a cross-sectional view of a second optical system included in the optical system of Example 8-1.

FIG. 35 shows aberrations of the second optical system included in the optical system of Example 8-1.

FIG. 36 is a cross-sectional view of a first optical system included in the optical system of Example 8-2.

FIG. 37 shows aberrations of the first optical system included in the optical system of Example 8-2.

FIG. 38 is a cross-sectional view of a second optical system included in the optical system of Example 8-2.

FIG. 39 shows aberrations of the second optical system included in the optical system of Example 8-2.

FIG. 40 is a cross-sectional view of a second optical system included in the optical system of Example 9-1.

FIG. 41 shows aberrations of the second optical system included in the optical system of Example 9-1.

FIG. 42 is a cross-sectional view of a second optical system included in the optical system of Example 9-2.

FIG. 43 shows aberrations of the second optical system included in the optical system of Example 9-2.

FIG. 44 is a cross-sectional view of a first optical system included in the optical system of Example 10.

FIG. 45 shows aberrations of the first optical system included in the optical system of Example 10.

FIG. 46 is a cross-sectional view of a second optical system included in the optical system of Example 10.

FIG. 47 shows aberrations of the second optical system included in the optical system of Example 10.

FIG. 48 schematically shows an optical device including the optical system of the embodiment.

FIG. 49 is a diagram illustrating an example of operation of a driving unit in the optical device of the embodiment.

FIG. 50 is a diagram showing an example of image information generated by the optical device of the embodiment.

FIG. 51 is a flowchart outlining a method for manufacturing an optical system of the embodiment.

### DESCRIPTION OF EMBODIMENTS

The following describes an optical system, an optical device, and a method for manufacturing an optical system of an embodiment of the present application.

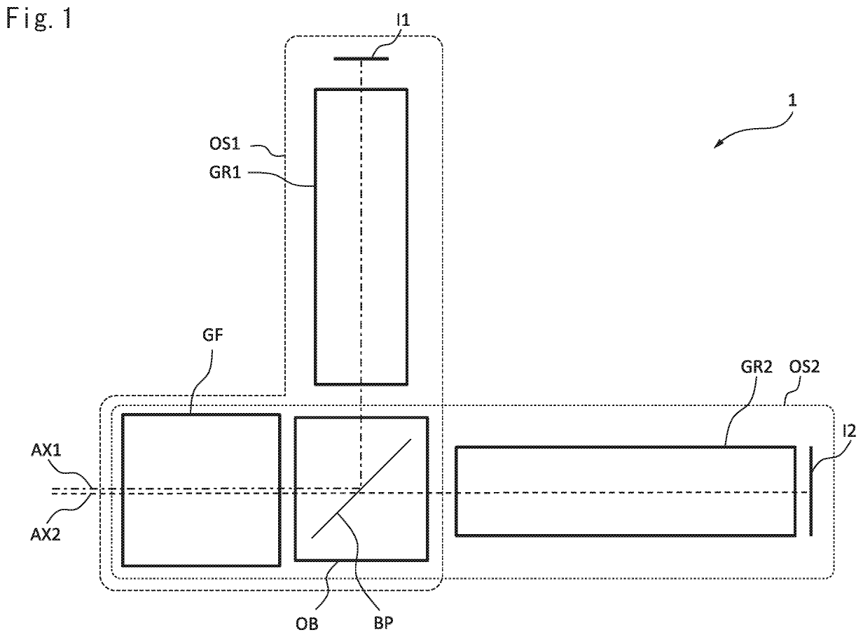

FIG. 1 schematically shows an example of an overall configuration of the optical system of the embodiment.

The optical system 1 of the present embodiment has a first optical system OS1 including, in order from the object side, a front lens group GF, an optical path splitter OB having a splitting plane BP1, and a first rear lens group GR1 on which light that enters the front lens group GF and the optical path splitter OB and that is reflected by the splitting plane BP1 is incident. The optical system 1 of the present embodiment has a second optical system OS2 including, in order from the object side, the front lens group GF, the optical path splitter OB, and a second rear lens group GR2 on which light that enters the front lens group GF and the optical path splitter OB and that is transmitted through the splitting plane BP1 is incident. The front lens group GF has negative refractive power.

On the object side of the splitting plane BP, FIG. 1 shows the first optical axis AX1 of the first optical system OS1 and the second optical axis AX2 of the second optical system OS2 without overlap for illustrative purposes.

In the optical system 1 of the present embodiment, light emitted from the front lens group GF enters the optical path splitter OB. The optical path splitter OB is a cube-type beam splitter (prism) having a splitting plane BP1 that transmits a first part of incident light and reflects at least a second part of the incident light different from the first part. The optical path splitter OB may be a plate-type beam splitter (half mirror) having the splitting plane BP1.

In the first optical system OS1 of the optical system 1 of the present embodiment, light emitted from the front lens group GF and incident on the optical path splitter OB is reflected by the splitting plane BPT, is incident on the first rear lens group GR1, and forms an image on a first image plane I1.

In the second optical system OS2 of the optical system 1 of the present embodiment, light emitted from the front lens group GF and incident on the optical path splitter OB is transmitted through the splitting plane BPT, is incident on the second rear lens group GR2, and forms an image on a second image plane 12.

In the optical system 1 of the present embodiment, the second optical system OS2 has a total focal length different from a total focal length of the first optical system OS1.

The optical system 1 of the present embodiment with the front lens group GF having negative refractive power can have sufficiently wide angle of view of the wide-angle optical system, which has the shorter total focal length among the first optical system OS1 and the second optical system OS2, can have sufficiently large magnification of the telephoto optical system, which has the longer total focal length among the first optical system OS1 and the second optical system OS2, and can appropriately form image of incident light by each optical system.

The optical system 1 of the present embodiment preferably satisfies the following conditional expression.

$$1.2 < fB / fA < 13.00 \qquad ( 1 )$$

where
fB: the longer of the total focal length of the first optical system OS1 and the total focal length of the second optical system OS2
fA: the shorter of the total focal length of the first optical system OS1 and the total focal length of the second optical system OS2

Conditional expression (1) restricts the ratio of the total focal length of the telephoto optical system to the total focal length of the wide-angle optical system. The optical system 1 of the present embodiment, which satisfies conditional expression (1), can ensure sufficiently wide angle of view of the wide-angle optical system and sufficiently large magnification of the telephoto optical system, and correct aberrations appropriately.

If the value of conditional expression (1) exceeds the upper limit in the optical system 1 of the present embodiment, the angle of view of the wide-angle optical system cannot be sufficiently wide and the magnification of the telephoto optical system cannot be sufficiently large.

In the optical system 1 of the present embodiment, the effect of the present embodiment can be ensured by setting the upper limit of conditional expression (1) to 13.00. To further ensure the effect of the present embodiment, the upper limit of conditional expression (1) is preferably set to 12.55, 12.05, 11.62, 11.16 or 10.70, more preferably to 10.00.

If the value of conditional expression (1) is below the lower limit in the optical system 1 of the present embodiment, it will be difficult to correct aberrations, such as axial chromatic aberration, lateral chromatic aberration, and distortion.

In the optical system 1 of the present embodiment, the effect of the present embodiment can be ensured by setting the lower limit of conditional expression (1) to 1.20. To further ensure he effect of the present embodiment, the lower limit of conditional expression (1) is preferably set to 1.35, 1.50, 1.65, 1.80 or 1.95, more preferably to 2.00.

The optical system 1 of the present embodiment preferably satisfies the following conditional expression.

$$0.20 < - fF / fA < 10.00 \qquad ( 2 )$$

where
fF: focal length of the front lens group GF
fA: the shorter of the total focal length of the first optical system OS1 and the total focal length of the second optical system OS2

Conditional expression (2) restricts the ratio of the focal length of the front lens group GF to the total focal length of the wide-angle optical system. The optical system 1 of the present embodiment, which satisfies conditional expression (2), can correct aberrations appropriately.

If the value of conditional expression (2) exceeds the upper limit in the optical system 1 of the present embodiment, it will be difficult to correct aberrations such as field curvature, astigmatism, and distortion appropriately.

In the optical system 1 of the present embodiment, the effect of the present embodiment can be ensured by setting the upper limit of conditional expression (2) to 10.00. To further ensure the effect of the present embodiment, the upper limit of conditional expression (2) is preferably set to 9.60, 9.20, 8.805, 8.40 or 8.00, more preferably to 7.00.

If the value of conditional expression (2) is below the lower limit in the optical system 1 of the present embodiment, it will be difficult to correct various aberrations such as field curvature, astigmatism, and distortion appropriately.

In the optical system 1 of the present embodiment, the effect of the present embodiment can be ensured by setting the lower limit of conditional expression (2) to 0.20. To further ensure the effect of the present embodiment, the lower limit of conditional expression (2) is preferably set to 0.26, 0.32, 0.38, 0.44 or 0.50, more preferably to 1.00.

The optical system 1 of the present embodiment preferably satisfies the following conditional expression.

$$0.05 < - fF / fB < 3. 50 \qquad ( 3 )$$

where
fF: focal length of the front lens group GF
fB: the longer of the total focal length of the first optical system OS1 and the total focal length of the second optical system OS2

Conditional expression (3) restricts the ratio of the focal length of the front lens group GF to the focal length of the telephoto optical system. The optical system 1 of the present embodiment, which satisfies conditional expression (3), can avoid an increase in the overall optical length and correct aberrations appropriately.

If the value of conditional expression (3) exceeds the upper limit in the optical system 1 of the present embodiment, it will be difficult to correct various aberrations such as field curvature and astigmatism appropriately.

In the optical system 1 of the present embodiment, the effect of the present embodiment can be ensured by setting the upper limit of conditional expression (3) to 3.50. To further ensure the effect of the present embodiment, the upper limit of conditional expression (3) is preferably set to 3.30, 3.10, 2.90, 2.70 or 2.50, more preferably to 2.00.

If the value of conditional expression (3) is below the lower limit in the optical system 1 of the present embodiment, the negative power of the front lens group GF will be too strong, the total focal length of the telephoto optical system will be longer, and the overall optical length of the telephoto optical system will be longer. Furthermore, it will be difficult to correct various aberrations such as field curvature, astigmatism, axial chromatic aberration, and lateral chromatic aberration appropriately.

In the optical system 1 of the present embodiment, the effect of the present embodiment can be ensured by setting the lower limit of conditional expression (3) to 0.05. To further ensure the effect of the present embodiment, the lower limit of conditional expression (3) is preferably set to 0.06, 0.07, 0.08, 0.09 or 0.10, more preferably to 0.20.

The optical system 1 of the present embodiment preferably satisfies the following conditional expression.

$$3.5 < - fl < fA < 50.30 \qquad ( 4 )$$

where
f1: the focal length of the lens disposed closest to the object side in the front lens group GF
fA: the shorter of the total focal length of the first optical system OS1 and the total focal length of the second optical system OS2

Conditional expression (4) restricts the ratio of the focal length of the lens disposed closest to the object side in the front lens group GF to the focal length of the wide-angle optical system. The optical system 1 of the present embodiment, which satisfies conditional expression (4), can avoid an increase in size of the lens disposed closest to the object side in the front lens group GF, and correct aberrations appropriately.

If the value of conditional expression (4) exceeds the upper limit in the optical system 1 of the present embodiment, the lens disposed closest to the object side in the front lens group GF will be too large and it will be difficult to correct various aberrations such as field curvature, astigmatism, and distortion appropriately.

In the optical system 1 of the present embodiment, the effect of the present embodiment can be ensured by setting the upper limit of conditional expression (4) to 50.30. To further ensure the effect of the present embodiment, the upper limit of conditional expression (4) is preferably set to 49.00, 46.00, 43.00 or 40.00, more preferably to 36.00.

If the value of conditional expression (4) is below the lower limit in the optical system 1 of the present embodiment, it will be difficult to correct aberrations, such as field curvature, astigmatism, and distortion.

In the optical system 1 of the present embodiment, the effect of the present embodiment can be ensured by setting the lower limit of conditional expression (4) to 3.50. To further ensure the effect of the present embodiment, the lower limit of conditional expression (4) is preferably set to 3.74, 3.98, 4.22, 4.46 or 4.70, more preferably to 6.50.

The optical system 1 of the present embodiment preferably satisfies the following conditional expression.

$$0.25 < - fl / fB / 15. \qquad ( 5 )$$

where
f1: the focal length of the lens disposed closest to the object side in the front lens group GF
fB: the longer of the total focal length of the first optical system OS1 and the total focal length of the second optical system OS2

Conditional expression (5) restricts the ratio of the focal length of the lens disposed closest to the object side in the front lens group GF to the focal length of the telephoto optical system. The optical system 1 of the present embodiment, which satisfies conditional expression (5), can avoid an increase in size of the lens disposed closest to the object side in the front lens group GF and an increase in the total optical length and correct aberrations appropriately.

If the value of conditional expression (5) exceeds the upper limit in the optical system 1 of the present embodiment, the lens disposed closest to the object side in the front lens group GF will increase in size and it will be difficult to correct aberrations, such as field curvature and astigmatism.

In the optical system 1 of the present embodiment, the effect of the present embodiment can be ensured by setting the upper limit of conditional expression (5) to 15.00. To further ensure the effect of the present embodiment, the upper limit of conditional expression (5) is preferably set to 14.40, 13.80, 13.20, 12.60 or 12.00, more preferably to 11.50.

If the value of conditional expression (5) is below the lower limit in the optical system 1 of the present embodiment, the negative power of the front lens group GF will be too strong, the total focal length of the telephoto optical system will be longer, and the overall optical length of the telephoto optical system will increase. Furthermore, it will be difficult to correct aberrations such as field curvature, astigmatism, axial chromatic aberration, and lateral chromatic aberration appropriately.

In the optical system 1 of the present embodiment, the effect of the present embodiment can be ensured by setting the lower limit of conditional expression (5) to 0.25. To further ensure the effect of the present embodiment, the lower limit of conditional expression (5) is preferably set to 0.30, 0.35, 0.40, 0.45 or 0.50, more preferably to 1.00.

The optical system 1 of the present embodiment preferably satisfies the following conditional expression.

$$0.04 < - D 12 / f 1 < 1.5 \qquad ( 6 )$$

where
D12: the distance on the optical axis between the image side lens surface of the lens disposed closest to the object side in the front lens group GF and the object side lens surface of the lens disposed adjacent to the image side of the lens disposed closest to the object side in the front lens group GF
f1: the focal length of the lens disposed closest to the object side in the front lens group GF

Conditional expression (6) restricts the ratio of the distance on the optical axis between the lens disposed closest to the object side in the front lens group GF and the lens disposed adjacent to the image side of this lens to the focal length of the lens disposed closest to the object side in the front lens group GF. The optical system 1 of the present embodiment, which satisfies conditional expression (6), can avoid an increase in size of the lens disposed closest to the object side in the front lens group GF and an increase in the total optical length and correct aberrations appropriately.

If the value of conditional expression (6) exceeds the upper limit in the optical system 1 of the present embodiment, the lens disposed closest to the object side in the front lens group GF will increase in size, the total optical lengths of the wide-angle optical system and the telephoto optical system will be to large, and it will be difficult to correct aberrations, such as field curvature, coma, and lateral chromatic aberration.

In the optical system 1 of the present embodiment, the effects of the present embodiment can be ensured by setting the upper limit of conditional expression (6) to 1.50. To further ensure the effects of the present embodiment, the upper limit of conditional expression (6) is preferably set to 1.44, 1.38, 1.32, 1.26 or 1.20, more preferably to 0.85.

If the value of conditional expression (6) is below the lower limit in the optical system 1 of the present embodiment, it will be difficult to correct aberrations, such as field curvature, coma, and lateral chromatic aberration.

In the optical system 1 of the present embodiment, the effect of the present embodiment can be ensured by setting the lower limit of conditional expression (6) to 0.04. To further ensure the effect of the present embodiment, the lower limit of conditional expression (6) is preferably set to 0.05, 0.06, 0.07, 0.08 or 0.09, more preferably to 0.11.

The optical system 1 of the present embodiment preferably satisfies the following conditional expression.

$$0.30 < TLB / TLA < 3.5 \qquad ( 7 )$$

where
TLB: the total optical length of the optical system having the longer total focal length among the first optical system OS1 and the second optical system OS2
TLA: the total optical length of the optical system having the shorter total focal length among the first optical system OS1 and the second optical system OS2

Conditional expression (7) restricts the ratio of the total optical length of the telephoto optical system to the total optical length of the wide-angle optical system. The optical system 1 of the present embodiment, which satisfies conditional expression (7), can avoid an increase in the overall optical length correct aberrations appropriately.

If the value of conditional expression (7) exceeds the upper limit in the optical system 1 of the present embodiment, the total optical length of the telephoto optical system will increase. Furthermore, it will be difficult to correct aberrations, such as field curvature, astigmatism, and distortion in the wide-angle optical system.

In the optical system 1 of the present embodiment, the effect of the present embodiment can be ensured by setting the upper limit of conditional expression (7) to 3.50. To further ensure the effect of the present embodiment, the upper limit of conditional expression (7) is preferably to set to 3.30, 3.10, 2.90, 2.70 or 2.50, more preferably to 2.25.

If the value of conditional expression (7) is below the lower limit in the optical system 1 of the present embodiment, the total optical length of the wide-angle optical system will increase. Furthermore, it will be difficult to correct aberrations, such as field curvature, astigmatism, and coma in the wide-angle optical system.

In the optical system 1 of the present embodiment, the effect of the present embodiment can be ensured by setting the lower limit of conditional expression (7) to 0.30. To further ensure the effect of the present embodiment, the lower limit of conditional expression (7) is preferably set to 0.38, 0.46, 0.54, 0.62 or 0.70, more preferably to 0.85.

The optical system 1 of the present embodiment preferably satisfies the following conditional expression.

$$0.30 < - ( r 12 + r 11 ) / ( r 12 - r 11 ) < 4.70 \qquad ( 8 )$$

where
r12: the radius of curvature of the image side lens surface of the lens disposed closest to the object side in the front lens group GF
r11: the radius of curvature of the object side lens surface of the lens disposed closest to the object side in the front lens group GF

Conditional expression (8) restricts the shape factor of the lens disposed closest to the object side in the front lens group GF. The optical system 1 of the present embodiment, which satisfies conditional expression (8), can correct aberrations, such as field curvature, astigmatism, distortion, and coma appropriately.

If the value of conditional expression (8) exceeds the upper limit in the optical system 1 of the present embodiment, it will be difficult to correct aberrations, such as field curvature, astigmatism, and distortion.

In the optical system 1 of the present embodiment, the effect of the present embodiment can be ensured by setting the upper limit of conditional expression (8) to 4.70. To further ensure the effect of the present embodiment, the upper limit of conditional expression (8) is preferably set to 4.60, 4.50, 4.40, 4.30 or 4.20, more preferably to 3.50.

If the value of conditional expression (8) is below the lower limit in the optical system 1 of the present embodiment, it will be difficult to correct aberrations, such as field curvature, astigmatism, and coma.

In the optical system 1 of the present embodiment, the effect of the present embodiment can be ensured by setting the lower limit of conditional expression (8) to 0.30. To further ensure the effect of the present embodiment, the lower limit of conditional expression (8) is preferably set to 0.34, 0.38, 0.42, 0.46 or 0.50, more preferably to 0.90.

The optical system 1 of the present embodiment preferably satisfies the following conditional expression.

$$0.10 < ( r 21 + r 12 ) / ( r 21 - r 12 ) < 3.30 \qquad ( 9 )$$

where
r21: radius of curvature of the object side lens surface of the lens disposed adjacent to the image side of the lens disposed closest to the object side in the front lens group GF
r12: the radius of curvature of the image side lens surface of the lens disposed closest to the object side in the front lens group GF

Conditional expression (9) restricts the shape factor of the air lens formed between the lens disposed closest to the object side in the front lens group GF and the lens disposed adjacent to the image side of the lens disposed closest to the object side in the front lens group GF. The optical system 1 of the present embodiment, which satisfies conditional expression (9), can correct aberrations, such as field curvature and astigmatism, appropriately.

If the value of conditional expression (9) exceeds the upper limit in the optical system 1 of the present embodiment, it will be difficult to correct aberrations, such as field curvature and astigmatism.

In the optical system 1 of the present embodiment, the effect of the present embodiment can be ensured by setting the upper limit of conditional expression (9) to 3.30. To further ensure the effect of the present embodiment, the upper limit of conditional expression (9) is preferably set to 3.00, 2.90, 2.60 or 2.30, more preferably to 2.00.

If the value of conditional expression (9) is below the lower limit in the optical system 1 of the present embodiment, it will be difficult to correct aberrations, such as field curvature and astigmatism.

In the optical system 1 of the present embodiment, the effect of the present embodiment can be ensured by setting the lower limit of conditional expression (9) to 0.10. To further ensure the effect of the present embodiment, the lower limit of conditional expression (9) is preferably set to 0.14, 0.18, 0.22 or 0.26, more preferably to 0.29.

The optical system 1 of the present embodiment preferably satisfies the following conditional expression.

$$0.30 < D 12 / fA < 11.3 \qquad ( 10 )$$

where
D12: the distance on the optical axis between the image side lens surface of the lens disposed closest to the object side in the front lens group GF and the object side lens surface of the lens disposed adjacent to the image side of the lens disposed closest to the object side in the front lens group GF
fA: the shorter of the total focal length of the first optical system OS1 and the total focal length of the second optical system OS2

Conditional expression (10) restricts the ratio of the distance on the optical axis between the lens disposed closest to the object side in the front lens group GF and the lens disposed adjacent to the image plane side of that lens, to the total focal length of the wide-angle optical system. The optical system 1 of the present embodiment, which By satisfies conditional expression (10), can avoid an increase in the overall optical length and correct aberrations appropriately.

If the value of conditional expression (10) exceeds the upper limit in the optical system 1 of the present embodiment, the overall optical length of the wide-angle side optical system will increase. Furthermore, it will be difficult to correct aberrations, such as field curvature and coma.

In the optical system 1 of the present embodiment, the effect of the present embodiment can be ensured by setting the upper limit of conditional expression (10) to 11.30. To further ensure the effect of the present embodiment, the upper limit of conditional expression (10) is preferably set to 10.80, 10.30, 9.80, 9.30 or 8.85, more preferably to 8.40.

If the value of conditional expression (10) is below the lower limit in the optical system 1 of the present embodiment, it will be difficult to correct aberrations, such as coma.

In the optical system 1 of the present embodiment, the effect of the present embodiment can be ensured by setting the lower limit of conditional expression (10) to 0.30. To further ensure the effect of the present embodiment, the lower limit of conditional expression (10) is preferably set to 0.35, 0.40, 0.45, 0.50 or 0.55, more preferably to 1.00.

The optical system 1 of the present embodiment preferably satisfies the following conditional expression.

$$0.07 < D 12 / fB < 4.30 \qquad ( 11 )$$

where
D12: the distance on the optical axis between the image side lens surface of the lens disposed closest to the object side in the front lens group GF and the object side lens surface of the lens disposed adjacent to the image side of the lens disposed closest to the object side in the front lens group GF
fB: the longer of the total focal length of the first optical system OS1 and the total focal length of the second optical system OS2

Conditional expression (11) restricts the ratio of the distance on the optical axis between the lens disposed closest to the object side in the front lens group GF and the lens disposed adjacent to the image plane side of that lens, to the total focal length of the telephoto optical system. The optical system 1 of the present embodiment, which satisfies conditional expression (11), can avoid an increase in the overall optical length and can correct aberrations appropriately.

If the value of conditional expression (11) exceeds the upper limit in the optical system 1 of the present embodiment, the total optical length of the telephoto side optical system will increase. Furthermore, it will be difficult to correct aberrations, such as field curvature and coma.

In the optical system 1 of the present embodiment, the effect of the present embodiment can be ensured by setting the upper limit of conditional expression (11) to 4.30. To further ensure the effect of the present embodiment, the upper limit of conditional expression (11) is preferably set to 4.05, 3.80, 3.55, 3.30 or 3.00, more preferably to 2.70.

If the value of conditional expression (11) is below the lower limit in the optical system 1 of the present embodiment, it will be difficult to correct aberrations, such as coma, axial chromatic aberration, and lateral chromatic aberration.

In the optical system 1 of the present embodiment, the effect of the present embodiment can be ensured by setting the lower limit of conditional expression (11) to 0.07. To further ensure the effect of the present embodiment, the lower limit of conditional expression (11) is preferably set to 0.08, 0.09, 0.11, 0.12 or 0.13, more preferably to 0.35.

The optical system 1 of the present embodiment preferably satisfies the following conditional expression.

$$1.2 < ω A / ω B < 15.00 \qquad ( 12 )$$

where,
oA: the semi-field angle of the optical system having the shorter total focal length among the first optical system OS1 and the second optical system OS2
(oB: the semi-field angle of the optical system having the longer total focal length among the first optical system OS1 and the second optical system OS2

Conditional expression (12) restricts the ratio of the semi-field angle of the wide-angle optical system to the semi-field angle of the telephoto optical system. The optical system 12 of the present embodiment, which satisfies conditional expression (1), can have the sufficiently wide semi-field angle of the wide-angle optical system and the sufficiently large magnification of the telephoto optical system, and can correct aberrations appropriately.

If the value of conditional expression (12) exceeds the upper limit in the optical system 1 of the present embodiment, it will be difficult to correct aberrations, such as field curvature, astigmatism, and distortion in the wide-angle optical system, and it will also be difficult to correct aberrations, such as field curvature, astigmatism, axial chromatic aberration, and lateral chromatic aberration in the telephoto optical system.

In the optical system 1 of the present embodiment, the effect of the present embodiment can be ensured by setting the upper limit of conditional expression (12) to 15.00. To further ensure the effect of the present embodiment, the upper limit of conditional expression (12) is preferably set to 14.60, 14.20, 13.80, 13.40 or 13.00, more preferably to 11.40.

If the value of conditional expression (12) is below the lower limit in the optical system 1 of the present embodiment, it is not possible to have sufficiently wide semi-field angle of the wide-angle optical system while the magnification of the telephoto optical system being sufficiently large.

In the optical system 1 of the present embodiment, the effect of the present embodiment can be ensured by setting the lower limit of conditional expression (12) to 1.20. To further ensure the effect of the present embodiment, the lower limit of conditional expression (12) is preferably set to 1.31, 1.42, 1.53, 1.64 or 1.75, more preferably to 2.00.

The optical system 1 of the present embodiment preferably satisfies the following conditional expression.

$$0.20 < fpA / fpB < 2.50 \qquad ( 13 )$$

where
fpA: the combined focal length of positive lens components continuously disposed toward the image plane side from the positive lens component disposed closest to the object side in a rear lens group among the first rear lens group GR1 and the second rear lens group GR2, the rear lens group included in the optical system having the shorter total focal length among the first optical system OS1 and the second optical system OS2
fpB: the combined focal length of positive lens components continuously disposed toward the image plane side from the positive lens component disposed closest to the object side in a rear lens group among the first rear lens group GR1 and the second rear lens group GR2, the rear lens group included in the optical system having the longer total focal length among the first optical system OS1 and the second optical system OS2

Conditional expression (13) restricts the ratio of the combined focal length of positive lens components continuously disposed toward the image plane side from the positive lens component disposed closest to the object side in the rear lens group included in the wide-angle optical system, to the combined focal length of positive lens components continuously disposed toward the image plane side from the positive lens component disposed closest to the object side in the rear lens group included in the telephoto optical system. The optical system 1 of the present embodiment, which satisfies conditional expression (13), can correct aberrations appropriately.

If the value of conditional expression (13) exceeds the upper limit in the optical system 1 of the present embodiment, it will be difficult to correct aberrations, such as spherical aberration and coma.

In the optical system 1 of the present embodiment, the effect of the present embodiment can be ensured by setting the upper limit of conditional expression (13) to 2.50. To further ensure the effects of the present embodiment, the upper limit of conditional expression (13) is preferably set to 2.40, 2.30, 2.20 or 2.10, more preferably to 2.00.

If the value of conditional expression (13) is below the lower limit, in the optical system 1 of the present embodiment, it will be difficult to correct aberrations, such as spherical aberration and coma.

In the optical system 1 of the present embodiment, the effect of the present embodiment can be ensured by setting the lower limit of conditional expression (13) to 0.20. To further ensure the effect of the present embodiment, the lower limit of conditional expression (13) is preferably set to 0.24, 0.28, 0.32 or 0.36, more preferably to 0.40.

The optical system 1 of the present embodiment preferably satisfies the following conditional expression.

$$0.33 < \vert fRB / fRA \vert < 65. \qquad ( 14 )$$

where
fRB: the focal length of a rear lens group included in the first rear lens group GR1 and the second rear lens group GR2, the rear lens group included in the optical system having the longer total focal length among the first optical system OS1 and the second optical system OS2
fRA: the focal length of a rear lens group included in the first rear lens group GR1 and the second rear lens group GR2, the rear lens group included in the optical system having the shorter total focal length among the first optical system OS1 and the second optical system OS2

Conditional expression (14) restricts the ratio of the focal length of the rear lens group included in the telephoto optical system to the focal length of the rear lens group included in the wide-angle optical system. The optical system 1 of the present embodiment, which satisfies conditional expression (14), can correct aberrations appropriately.

If the value of conditional expression (14) exceeds the upper limit in the optical system 1 of the present embodiment, it will be difficult to correct aberrations, such as spherical aberration and coma.

In the optical system 1 of the present embodiment, the effect of the present embodiment can be ensured by setting the upper limit of conditional expression (14) to 65.00. To further ensure the present embodiment, the upper limit of conditional expression (14) is preferably set to 63.70, 62.40, 61.10, 59.80 or 58.50, more preferably to 50.50.

If the value of conditional expression (14) is below the lower limit in the optical system 1 of the present embodiment, it will be difficult to correct aberrations, such as spherical aberration and coma.

In the optical system 1 of the present embodiment, the effect of the present embodiment can be ensured by setting the lower limit of conditional expression (14) to 0.33. To further ensure the effect of the present embodiment, the lower limit of conditional expression (14) is preferably set to 0.39, 0.45, 0.51, 0.57 or 0.63, more preferably to 0.75.

The optical system 1 of the present embodiment preferably satisfies the following conditional expression.

$$7.00 < TLB / fA < 110.00 \qquad ( 15 )$$

where
TLB: the total optical length of the optical system having the longer total focal length among the first optical system OS1 and the second optical system OS2
fA: the shorter of the total focal length of the first optical system OS1 and the total focal length of the second optical system OS2

Conditional expression (15) restricts the ratio of the total optical length of the telephoto optical system to the total focal length of the wide-angle optical system. The optical system 1 of the present embodiment, which satisfies conditional expression (15), can avoid an increase in the total optical length, and can correct aberrations appropriately.

If the value of conditional expression (15) exceeds the upper limit in the optical system 1 of the present embodiment, the total optical length of the telephoto optical system will increase. Furthermore, it will be difficult to correct aberrations, such as field curvature, astigmatism, and coma.

In the optical system 1 of the present embodiment, the effect of the present embodiment can be ensured by setting the upper limit of conditional expression (15) to 110.00. To further ensure the effect of the present embodiment, the upper limit of conditional expression (15) is preferably set to 107.50, 105.00, 102.50 or 100.00, more preferably to 97.50.

If the value of conditional expression (15) is below the lower limit in the optical system 1 of the present embodiment, it will be difficult to correct aberrations, such as distortion, field curvature, and astigmatism, particularly in the wide-angle-side optical system.

In the optical system 1 of the present embodiment, the effect of the present embodiment can be ensured by setting the lower limit of conditional expression (15) to 7.00. To further ensure the effect of the present embodiment, the lower limit of conditional expression (15) is preferably set to 8.16, 9.32, 10.48, 11.64 or 12.80, more preferably to 20.00.

The optical system 1 of the present embodiment preferably satisfies the following conditional expression.

$$0.30 < TLA / fB < 20.50 \qquad ( 16 )$$

where
TLA: the total optical length of the optical system having the shorter total focal length among the first optical system OS1 and the second optical system OS2
fB: the longer of the total focal length of the first optical system OS1 and the total focal length of the second optical system OS2

Conditional expression (16) restricts the ratio of the total optical length of the wide-angle optical system to the total focal length of the telephoto optical system. The optical system 1 of the present embodiment, which satisfies conditional expression (16), can avoid an increase in the total optical length, and can correct aberrations appropriately.

If the value of conditional expression (16) exceeds the upper limit in the optical system 1 of the present embodiment, the total optical length of the wide-angle optical system will increase. Furthermore, it will be difficult to correct aberrations, such as field curvature, astigmatism, and coma.

In the optical system 1 of the present embodiment, the effect of the present embodiment can be ensured by setting the upper limit of conditional expression (16) to 20.50. To further ensure the effect of the present embodiment, the upper limit of conditional expression (16) is preferably set to 19.80, 19.10, 18.40, 17.80, more preferably to 16.50.

If the value of conditional expression (16) is below the lower limit in the optical system 1 of the present embodiment, it will be difficult to correct aberrations, such as field curvature, astigmatism, axial chromatic aberration, and lateral chromatic aberration, particularly in the telephoto optical system.

In the optical system 1 of the present embodiment, the effect of the present embodiment can be ensured by setting the lower limit of conditional expression (16) to 0.30. To further ensure the effect of the present embodiment, the lower limit of conditional expression (16) is preferably set to 0.35, 0.40, 0.45, 0.50 or 0.55, more preferably to 2.05.

The optical system 1 of the present embodiment preferably satisfies the following conditional expression.

$$1.7 < nd 1 < 2. 01 \qquad ( 17 )$$

where
nd1: the refractive index at d-line of the lens disposed closest to the object side in the front lens group GF

Conditional expression (17) restricts the refractive index at d-line of the lens disposed closest to the object side in the front lens group GF. The optical system 1 of the present embodiment, which satisfies conditional expression (17), can correct aberrations appropriately.

If the value of conditional expression (17) exceeds the upper limit in the optical system 1 of the present embodiment, the flexibility in selecting the glass material used for the lens will decrease, and color correction will be difficult.

In the optical system 1 of the present embodiment, the effect of the present embodiment can be ensured by setting the upper limit of conditional expression (17) to 2.01. To further ensure the effect of the present embodiment, the upper limit of conditional expression (17) is preferably set to 1.97, 1.93, 1.88 or 1.84, more preferably to 1.80.

If the value of conditional expression (17) is below the lower limit in the optical system 1 of the present embodiment, the power of the lens disposed closest to the object side in the front lens group GF will be too weak, and correction of field curvature will be difficult, particularly in the wide-angle optical system.

In the optical system 1 of the present embodiment, the effect of the present embodiment can be ensured by setting the lower limit of conditional expression (17) to 1.70. To further ensure the effect of the present embodiment, the lower limit of conditional expression (17) is preferably set to 1.71.

The optical system 1 of the present embodiment preferably satisfies the following conditional expression.

$$1. 50 < n d 2 < 2.01 \qquad ( 18 )$$

where
nd2: the refractive index at d-line of the lens disposed adjacent to the image plane side of the lens disposed closest to the object side in the front lens group GF

Conditional expression (18) restricts the refractive index at d-line of the lens disposed adjacent to the image plane side of the lens disposed closest to the object side in the front lens group GF. The optical system 1 of the present embodiment, which satisfies conditional expression (18), can correct aberrations appropriately.

If the value of conditional expression (18) exceeds the upper limit in the optical system 1 of the present embodiment, the flexibility in selecting the glass material used for the lens will decrease, and color correction will be difficult.

In the optical system 1 of the present embodiment, the effect of the present embodiment can be ensured by setting the upper limit of conditional expression (18) to 2.01. To further ensure the effect of the present embodiment, the upper limit of conditional expression (18) is preferably set to 1.95, 1.89, 1.82 or 1.76, more preferably to 1.70.

If the value of conditional expression (18) is below the lower limit in the optical system 1 of the present embodiment, the power of the lens disposed adjacent to the image plane side of the lens disposed closest to the object side in the front lens group GF will be too weak, and correction of field curvature will be difficult, particularly in the wide-angle optical system.

In the optical system 1 of the present embodiment, the effect of the present embodiment can be ensured by setting the lower limit of conditional expression (18) to 1.50. To further ensure the effect of the present embodiment, the lower limit of conditional expression (18) is preferably set to 1.55.

The optical system 1 of the present embodiment preferably satisfies the following conditional expression.

$$1.55 < ndaveF < 2.01 \qquad ( 19 )$$

where
ndaveF: an average of the refractive indices at d-line of the lenses included in the front lens group GF

Conditional expression (19) restricts an average of the refractive indices at d-line of the lenses included in the front lens group GF. The optical system 1 of the present embodiment, which satisfies conditional expression (19), can correct aberrations appropriately.

If the value of conditional expression (19) exceeds the upper limit in the optical system 1 of the present embodiment, the flexibility in selecting the glass material used for the lenses included in the front lens group GF will decrease, and it will be difficult to correct chromatic aberration.

In the optical system 1 of the present embodiment, the effect of the present embodiment can be ensured by setting the upper limit of conditional expression (19) to 2.01. To further ensure the effect of the present embodiment, the upper limit of conditional expression (19) is preferably set to 1.95, 1.89, 1.83 or 1.77, more preferably to 1.71.

If the value of conditional expression (19) is below the lower limit in the optical system 1 of the present embodiment, it will be difficult to correct aberrations.

In the optical system 1 of the present embodiment, the effect of the present embodiment can be ensured by setting the lower limit of conditional expression (19) to 1.55. To further ensure the effect of the present embodiment, the lower limit of conditional expression (19) is preferably set to 1.55, 1.57, 1.59, 1.61 or 1.63, more preferably to 1.65.

The optical system 1 of the present embodiment preferably satisfies the following conditional expression.

$$45 ° < ω A < 120 ° \qquad ( 20 )$$

where
oA: the semi-field angle of the optical system having the shorter total focal length among the first optical system OS1 and the second optical system OS2

Conditional expression (20) restricts the semi-field angle of the wide-angle optical system. The optical system 1 of the present embodiment, which satisfies conditional expression (20), can have the wide-angle-side optical system with sufficiently wide semi-field angle, and can correct aberrations, such as field curvature, astigmatism, and distortion appropriately.

If the value of conditional expression (20) exceeds the upper limit in the optical system 1 of the present embodiment, it will be difficult to correct aberrations, such as field curvature, astigmatism, and distortion.

In the optical system 1 of the present embodiment, the effect of the present embodiment can be ensured by setting the upper limit of conditional expression (20) to 120°. To further ensure the effect of the present embodiment, the upper limit of conditional expression (20) is preferably set to 118°, 115°, 110° or 105°, more preferably to 100°.

If the value of conditional expression (20) is below the lower limit in the optical system 1 of the present embodiment, the semi-field angle of the wide-angle optical system cannot be made sufficiently wide.

In the optical system 1 of the present embodiment, the effect of the present embodiment can be ensured by setting the lower limit of conditional expression (20) to 45°. To further ensure the effects of the present embodiment, the lower limit value of conditional expression (20) is preferably set to 50°, 55°, 60° or 65°, more preferably to 70°.

The optical system 1 of the present embodiment preferably satisfies the following conditional expression.

$$3 ° < ω B < 30 ° \qquad ( 21 )$$

where
oB: the semi-field angle of the optical system having the longer total focal length among the first optical system OS1 and the second optical system OS2

Conditional expression (21) restricts the semi-field angle of the telephoto optical system. The optical system 1 of the present embodiment, which satisfies conditional expression (21), can have sufficiently large magnification of the telephoto optical system and correct chromatic aberration.

If the value of conditional expression (21) exceeds the upper limit in the optical system 1 of the present embodiment, it will be difficult to have sufficiently large magnification of the telephoto optical system.

In the optical system 1 of the present embodiment, the effect of the present embodiment can be ensured by setting the upper limit of conditional expression (21) to 30°. To further ensure the effect of the present embodiment, the upper limit of conditional expression (21) is preferably set to 28°, 26°, 240 or 22°, more preferably to 20°.

If the value of conditional expression (21) is below the lower limit in the optical system 1 of the present embodiment, it will be difficult to correct chromatic aberration.

In the optical system 1 of the present embodiment, the effect of the present embodiment can be ensured by setting the lower limit of conditional expression (21) to 3°. To further ensure the effect of the present embodiment, the lower limit value of conditional expression (21) is preferably set to 4°, 5°, 6° or 7°, more preferably to 8°.

The optical system 1 of the present embodiment preferably satisfies the following conditional expression.

$$0. 10 < W i / ( 1 - Wi ) \leq 1. \qquad ( 22 )$$

where,
Wi: When the optical path of the optical system with the shorter total focal length among the first optical system OS1 and the second optical system OS2 is reflected by the splitting plane BP, the reflectance of the splitting plane BP; when the optical path of the optical system with the shorter total focal length among the first optical system OS1 and the second optical system OS2 is transmitted through the splitting plane BP, the transmittance of the splitting plane BP

Conditional expression (22) restricts the ratio of the reflectance or transmittance when the optical path of the wide-angle optical system is reflected or transmitted through the splitting plane BP, and the proportion of light that is not reflected or transmitted when the optical path of the wide-angle optical system is reflected or transmitted, respectively, by the splitting plane BP. the optical system 1 of the present embodiment, which satisfies conditional expression (22), can keep the difference between the brightness of the image formed on the image plane by the wide-angle optical system with a smaller F-number and the brightness of the image formed on the image plane by the telephoto optical system with a larger F-number within an appropriate range.

If the value of conditional expression (22) exceeds the upper limit in the optical system 1 of the present embodiment, the image formed on the image plane by the telephoto optical system will be too dark.

In the optical system 1 of the present embodiment, the effect of the present embodiment can be ensured by setting the upper limit of conditional expression (22) to 1.00. To further ensure the effect of the present embodiment, the upper limit of conditional expression (22) is preferably set to 0.94, 0.88, 0.82 or 0.76, more preferably to 0.70.

If the value of conditional expression (22) is below the lower limit in the optical system 1 of the present embodiment, the image formed on the image plane by the wide-angle optical system will be too dark.

In the optical system 1 of the present embodiment, the effect of the present embodiment can be ensured by setting the lower limit of conditional expression (22) to 0.10. To further ensure the effect of the present embodiment, the lower limit of conditional expression (22) is preferably set to 0.11.

In the optical system 1 of the present embodiment, the optical path splitter OB is preferably a prism.

The optical system 1 of the present embodiment with such a configuration can appropriately correct field curvature, and can increase the accuracy of the splitting plane BP1 included in the optical path splitter OB.

In the optical system 1 of the present embodiment, the lens disposed closest to the object side in the front lens group GF preferably has negative refractive power.

The optical system 1 of the present embodiment with such a configuration can have sufficiently wide semi-field angle of the wide-angle optical system.

In the optical system 1 of the present embodiment, the front lens group GF preferably consists of three or more lens components. A “lens component” herein refers to a single lens or a cemented lens.

The optical system 1 of the present embodiment with such a configuration can be configured to be compact.

In the optical system 1 of the present embodiment, it is preferable that at least one of the first rear lens group GR1 and the second rear lens group GR2 has a second optical path splitter having a second splitting plane that reflects a part of incident light and transmits at least a part different from the part of incident light, a third rear lens group on which at least a part of the light reflected by the second splitting plane is incident, and a fourth rear lens group on which at least a part of the light transmitted through the second splitting plane is incident.

The optical system 1 of the present embodiment with such a configuration can form multiple images by the first optical system OS1 or the second optical system OS2.

In the optical system 1 of the present embodiment, it is preferable that a lens group among the first rear lens group GR1 and the second rear lens group GR2, having the second optical path splitter, the third rear lens group, and the fourth rear lens group, has an intermediate lens group with positive refractive power between the optical path splitter OB and the second optical path splitter.

The optical system 1 of the present embodiment with such a configuration can reduce the number of lens components constituting the rear lens group among the first rear lens group GR1 and the second rear lens group GR2 having the intermediate lens group, and can be configured to be compact.

In the optical system 1 of the present embodiment, it is preferable that the image plane of the first optical system OS1 and the image plane of the second optical system OS2 are disposed on the same plane.

The optical system 1 of the present embodiment with such a configuration can receive the image formed by the first optical system OS1 and the image formed by the second optical system OS2 by a single light receiving unit disposed on the image plane, so that an optical device including the optical system can be made compact. In the optical device including the optical system with such a configuration, it is easy to synchronize the timing of capturing two images.

In the optical system 1 in which the image plane of the first optical system OS1 and the image plane of the second optical system OS2 are disposed on the same plane, it is preferable that the total focal length of the first optical system OS1 is longer than the total focal length of the second optical system OS2.

The optical system 1 of the present embodiment with such a configuration can shorten the distance from the lens surface closest to the object side to the image plane.

In the optical system 1 in which the image plane of the first optical system OS1 and the image plane of the second optical system OS2 are disposed on the same plane, it is preferable that the first optical system OS1 further has, between the optical path splitter OB and the image plane, a first optical path deflector that deflects the optical path of the light reflected by the splitting plane BP1 to be parallel to the optical path of the light transmitted through the splitting plane BP1, and a second optical path deflector that deflects the optical path of the light reflected by the splitting plane BP1 deflected by the first optical path deflector so that the distance from the optical path of the light transmitted through the splitting plane BP1 becomes shorter.

The optical system 1 of the present embodiment with such a configuration can form two images close to each other, and an optical device can be configured to receives each image by the single light receiving unit.

An optical system that branches incident light and appropriately forms respective images can be achieved by the above configuration.

An optical device of the present embodiment includes an optical system configured as described above. This enables achieving an optical device that branches incident light, and acquires image data corresponding to each light.

The optical device of the present embodiment preferably includes a drive unit that changes the orientation of the optical system based on image information representing the image of the optical system with the shorter total focal length among the first optical system OS1 and the second optical system OS2.

The optical device of the present embodiment with such a configuration can appropriately change the orientation of the optical system based on the situation over a wide range area represented in the image formed by the wide-angle optical system.

The drive unit in the optical device of the present embodiment preferably changes the orientation of the optical system so that an object detected from the image information is included in the field angle of the optical system with the longer total focal length among the first optical system OS1 and the second optical system OS2.

The optical device of the present embodiment with such a configuration can change the orientation of the optical system so that an object included in the wide range area represented in the image formed by the wide-angle optical system is represented by the image formed by the telephoto optical system.

The optical device of the present embodiment preferably has a combining unit that combines first image information, which is an enlarged part of the image of the optical system with the shorter total focal length among the first optical system OS1 and the second optical system OS2, and second image information representing at least a part of the image of the optical system with the longer total focal length among the first optical system OS1 and the second optical system OS2.

According to the optical device of the present embodiment with such a configuration, a part included in the image formed by the wide-angle optical system and an image included in the image formed by the telephoto optical system can be compared.

A method for manufacturing an optical system of the present embodiment is a method for manufacturing an optical system including a splitting plane BP1 that transmits a first part of incident light and reflects at least a second part of the incident light different from the first part, and that forms images of first light that is at least a part of light reflected by the splitting plane BP1 and second light that is at least a part of light transmitted through the splitting plane BP1, the method including: arranging a first optical system OS1 to include, in order from an object side, a front lens group GF having negative refractive power, an optical path splitter OB having the splitting plane BP1, and a first rear lens group GR1 on which the first light is incident; arranging a second optical system OS2 to include, in order from the object side, the front lens group GF, the optical path splitter OB, and a second rear lens group GR2 on which the second light is incident; and configuring the second optical system OS2 to have a total focal length different from a total focal length of the first optical system OS1.

An optical system that branches incident light and appropriately forms respective images can be manufactured by such a method for manufacturing an optical system.

### NUMERICAL EXAMPLES

Examples of the present application will be described below with reference to the drawings.

### Example 1

In the optical system 1 of Example 1, the second optical system OS2 has a total focal length longer than a total focal length of the first optical system OS1. That is, the first optical system OS1 corresponds to a wide-angle optical system, and the second optical system OS2 corresponds to a telephoto optical system.

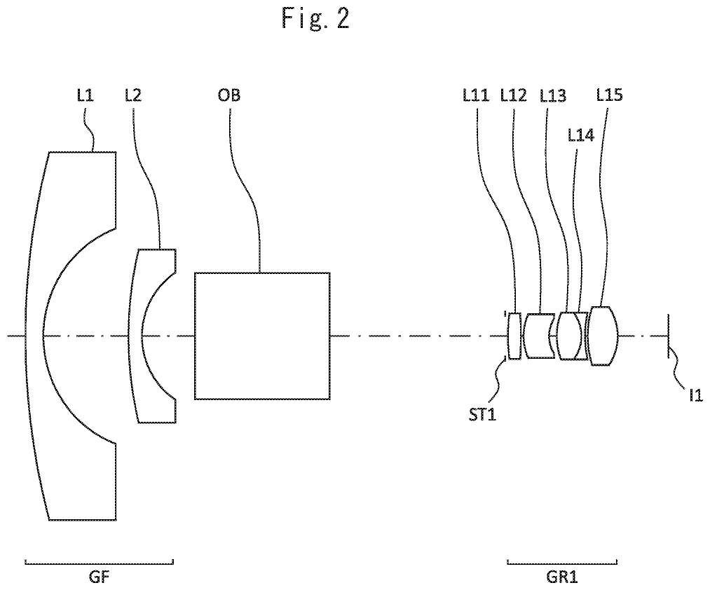

FIG. 2 is a cross-sectional view of the first optical system OS1 included in the optical system 1 of Example 1.

The first optical system OS1 of the present example has, in order from the object side, a meniscus-shaped negative lens L1 convex on the object side, a meniscus-shaped negative lens L2 convex on the object side, an optical path splitter OB, an aperture stop ST1, a biconvex positive lens L11, a meniscus-shaped negative lens L12 convex on the object side, a negative cemented lens composed of a biconvex positive lens L13 and a biconcave negative lens L14, and a biconvex positive lens L15.

A first imaging element (not shown) constructed from CCD or CMOS, or the like is disposed on the image plane I1.

In the first optical system OS1 of the present example, the negative lens L1 and the negative lens L2 are included in the front lens group GF.

In the first optical system OS1 of the present example, the positive lens L11, the negative lens L12, the negative cemented lens composed of the positive lens L13 and the negative lens L14, and the positive lens L15 are included in the first rear lens group GR1.

Table 1-1 below shows specifications of the first optical system OS1 of the present example.

In the [General Specifications] of Table 1-1, fA denotes the total focal length of the first optical system OS1, TLA the total optical length of the first optical system OS1, FnoA the F-number of the first optical system OS1, YmaxA the maximum image height, ωA the semi-field angle (degrees), and Wi the reflectance of the splitting plane BP1. These values listed in [General Specifications] are those at d-line (wavelength 587.6 nm).

In the [Lens Specifications] of Table 1-1, m denotes the number of the optical surface counted from the object side, r the radii of curvature, d the surface-to-surface distance, n(d) the refractive indices at d-line, and vd the Abbe number based on d-line. The radius of curvature r=∞ means a plane. In [Lens Specifications], the optical surfaces marked with “*” are aspherical surfaces.

The unit of the focal length, radii of curvature, and other lengths listed in Table 1-1 is “mm.” However, the values are not limited thereto because the optical performance of a proportionally enlarged or reduced optical system is the same as that of the original system.

The above reference symbols in Table 1-1 will also be used similarly in the table of the second optical system OS2 of the present example and the tables of the other examples described below.

TABLE 1-1
[General Specifications]

| | |
|---|---|
| fA | 1.89 |
| TLA | 71.74 |
| FnoA | 2.77 |
| YmaxA | 2.31 |
| ωA | 95.0° |
| Wi | 0.20 |

[Lens Specifications]

| m | r | d | n(d) | ν d | |
|---|---|---|---|---|---|
| 1) | 75.05511 | 2.000 | 1.755 | 52.34 | |
| 2) | 12.40126 | 9.500 | | | |
| 3) | 38.83349 | 1.500 | 1.618 | 63.34 | |
| 4) | 8.17008 | 5.930 | | | |
| 5) | ∞ | 15.000 | 1.517 | 63.88 | (optical path splitter OB) |
| 6) | ∞ | 19.600 | | | |
| 7> | ∞ | 0.300 | | | (aperture stop ST1) |
| 8) | 17.19965 | 1.450 | 1.744 | 44.80 | |
| 9) | −36.23617 | 0.300 | | | |
| 10) | 5.67181 | 2.850 | 1.755 | 27.57 | |
| 11) | 3.52376 | 0.850 | | | |
| 12) | 6.74559 | 2.750 | 1.498 | 82.57 | |
| 13) | −4.11947 | 0.400 | 1.755 | 27.57 | |
| 14) | 10.60417 | 0.300 | | | |
| 15) | 10.05953 | 3.350 | 1.593 | 67.90 | |
| 16) | −5.51384 | 5.657 | | | |

[Focal Length Data of Groups]

| Groups | Starting surfaces | Focal lengths |
|---|---|---|
| GF | 1 | −7.17 |
| GR1 | 8 | 10.92 |

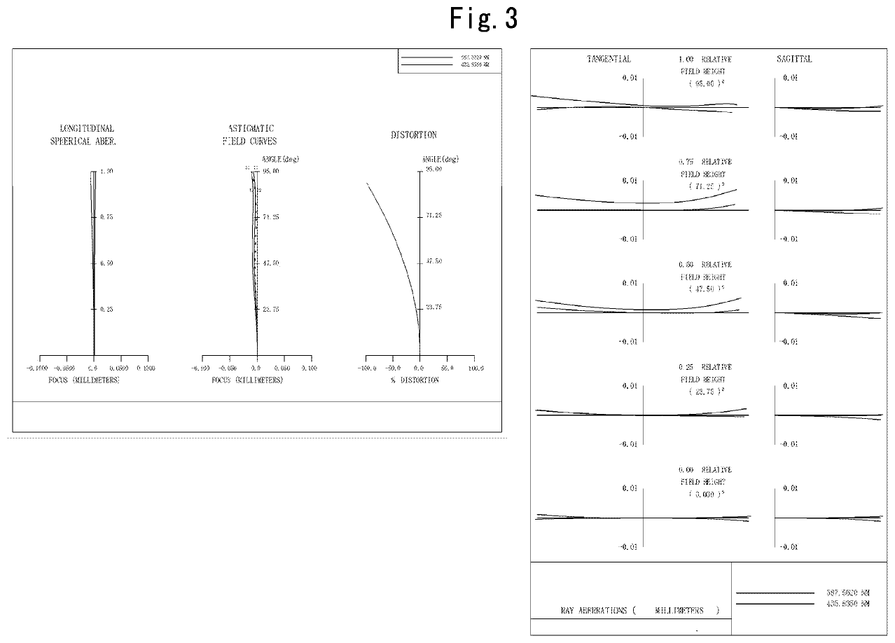

FIG. 3 shows aberrations of the first optical system OS1 included in the optical system 1 of Example 1.

Of the graphs of aberrations, the graph of the spherical aberration (LONGITUDINAL SPHERICAL ABER.) shows the ratio to the maximum aperture, the graphs of astigmatism and distortion (ASTIGMATIC FIELD CURVES and DISTORTION) show the values at the semi-field angle, and the graphs of coma aberration show the ratio to the maximum image height. The graphs of aberrations show the values at d-line and g-line (wavelength 435.8 nm). In the graph of astigmatism diagram, S and T indicate a sagittal plane and a meridional plane, respectively. The reference symbols in the graphs of aberrations of the present example will also be used in those of the other examples described below.

The graphs of aberrations suggest that the first optical system OS1 of the present example corrects aberrations appropriately and has high optical performance.

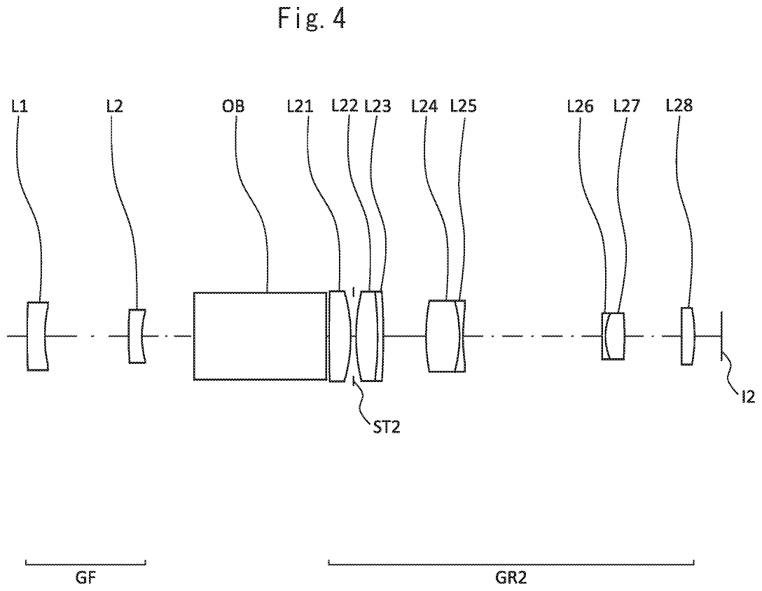

FIG. 4 is a cross-sectional view of a second optical system included in the optical system of Example 1.

The second optical system OS2 of the present example has, in order from the object side, a meniscus-shaped negative lens L1 convex on the object side, a meniscus-shaped negative lens L2 convex on the object side, an optical path splitter OB, a biconvex positive lens L21, an aperture stop ST2, a positive cemented lens composed of a biconvex positive lens L22 and a meniscus-shaped negative lens L23 concave on the object side, a negative cemented lens composed of a biconvex positive lens L24 and a biconcave negative lens L25, a negative cemented lens composed of a meniscus-shaped negative lens L26 convex on the object side and a biconvex positive lens L27, and a meniscus-shaped positive lens L28 concave on the object side.

An imaging element constructed from CCD or CMOS, or the like is disposed on the image plane 12.

In the second optical system OS2 of the present example, the negative lens L1 and the negative lens L2 are included in the front lens group GF. The front lens group GF is common with the first optical system OS1, and the same applies to other examples described below.

In FIG. 4, the front lens group GF is shown with an aperture smaller than the aperture of the front lens group GF in FIG. 2, and the same applies to the cross-sectional views of the second optical system OS2 in other examples described below.

In the second optical system OS2 of the present example, the positive lens L21, the aperture stop ST2, the positive cemented lens composed of the positive lens L22 and the negative lens L23, the negative cemented lens composed of the positive lens L24 and the negative lens L25, the negative cemented lens composed of the negative lens L26 and the positive lens L27, and the positive lens L28 are included in the second rear lens group GR2.

Table 1-2 below shows the specifications of the second optical system OS2 of the present example.

In the [General Specifications] of Table 1-2, fB denotes the total focal length of the second optical system OS2, TLB the total optical length of the second optical system OS2, FnoB the F-number of the second optical system OS2, YmaxB the maximum image height, and ωB the semi-field angle (degrees). These values listed in [General Specifications] are those at d-line.

The above reference symbols in Table 1-2 will also be used similarly in the table of the second optical system OS2 in each of the examples described below.

TABLE 1-2
[General Specifications]

| | |
|---|---|
| fB | 12.91 |
| TLB | 78.71 |
| FnoB | 6.32 |
| YmaxB | 2.39 |
| ωB | 10.5° |

[Lens Specifications]

| m | r | d | n(d) | ν d | |
|---|---|---|---|---|---|
| 1) | 75.05511 | 2.000 | 1.755 | 52.340 | |
| 2) | 12.40126 | 9.500 | | | |
| 3) | 38.83349 | 1.500 | 1.618 | 63.340 | |
| 4) | 8.17008 | 5.930 | | | |
| 5) | ∞ | 15.000 | 1.517 | 63.880 | (optical splitter OB) |
| 6) | ∞ | 0.300 | | | |
| 7) | 134.58685 | 2.450 | 1.498 | 82.570 | |
| 8) | −14.30327 | 0.300 | | | |
| 9> | ∞ | 0.300 | | | (aperture stop ST2) |
| 10) | 16.40331 | 2.450 | 1.498 | 82.570 | |
| 11) | −32.55198 | 0.650 | 1.697 | 55.520 | |
| 12) | −58.63655 | 4.830 | | | |
| 13) | 16.96489 | 3.800 | 1.498 | 82.570 | |
| 14) | −11.72973 | 0.400 | 1.744 | 44.800 | |
| 15) | 17.71501 | 15.750 | | | |
| 16) | 201.11629 | 0.400 | 1.744 | 44.800 | |
| 17) | 5.19003 | 2.150 | 1.487 | 70.320 | |
| 18) | −31.23476 | 6.500 | | | |
| 19) | −242.08751 | 1.450 | 1.620 | 36.400 | |
| 20) | −13.28229 | 3.049 | | | |

[Focal Length Data of Groups]

| Groups | Starting surfaces | Focal lengths |
|---|---|---|
| GF | 1 | −7.17 |
| GR2 | 7 | 57.12 |

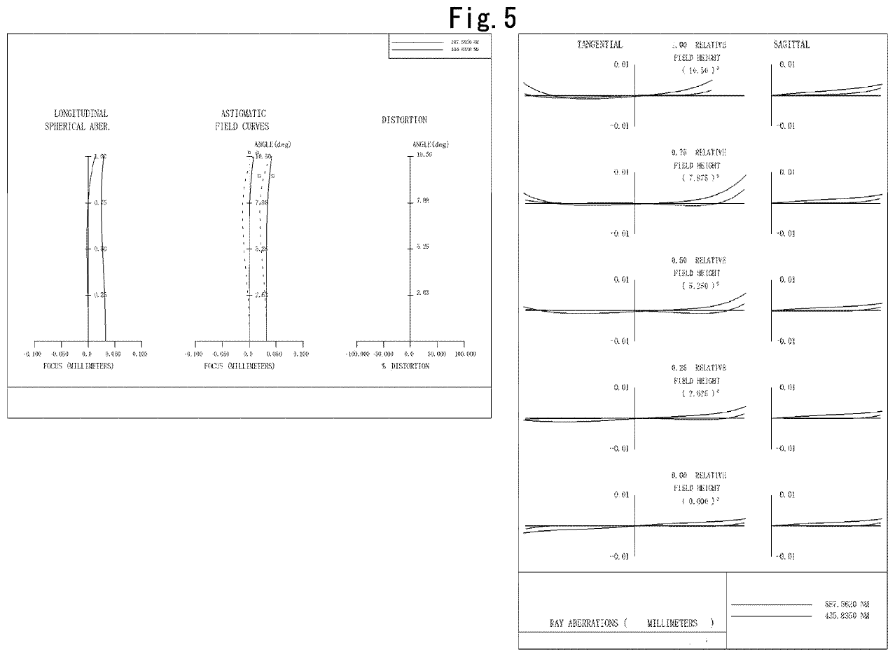

FIG. 5 shows aberrations of the second optical system OS2 included in the optical system 1 of Example 1.

The graphs of aberrations suggest that the second optical system OS2 of the present example corrects aberrations appropriately and has high optical performance.

### Example 2

In the optical system 1 of Example 2, the second optical system OS2 has a total focal length longer than a total focal length of the first optical system OS1. That is, the first optical system OS1 corresponds to a wide-angle optical system, and the second optical system OS2 corresponds to a telephoto optical system.

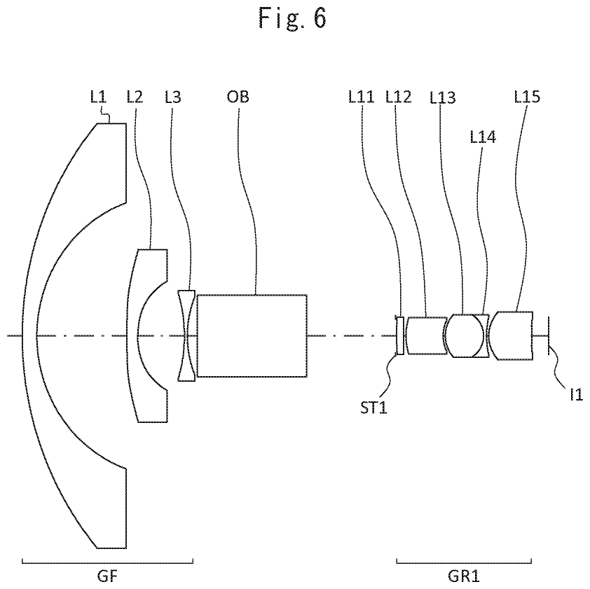

FIG. 6 is a cross-sectional view of a first optical system included in the optical system of Example 2.

The first optical system OS1 of the present example has, in order from the object side, a meniscus-shaped negative lens L1 convex on the object side, a meniscus-shaped negative lens L2 convex on the object side, a biconcave negative lens L3, an optical path splitter OB, an aperture stop ST1, a biconvex positive lens L11, a meniscus-shaped negative lens L12 convex on the object side, a positive cemented lens composed of a biconvex positive lens L13 and a biconcave negative lens L14, and a biconvex positive lens L15.

A first imaging element (not shown) constructed from a CCD or CMOS, or the like is disposed on the image plane I1.

In the first optical system OS1 of the present example, the negative lens L1, the negative lens L2, and the negative lens L3 are included in the front lens group GF.

In the first optical system OS1 of the present example, the positive lens L11, the negative lens L12, the positive cemented lens composed of the positive lens L13 and the negative lens L14, and the positive lens L15 are included in the first rear lens group GR1.

Table 2-1 below shows the specifications of the first optical system OS1 of the present example.

In [Aspherical Surface Data] of Table 2-1, m denotes the optical surfaces corresponding to the aspherical surface data, K the conic constants, and A4 to Al0 the aspherical coefficients.

The aspherical surfaces are expressed by expression (a) below, where y denotes the height in a direction perpendicular to the optical axis, S(y) the distance along the optical axis from the tangent plane at the vertex of an aspherical surface to the aspherical surface at height y (a sag), r the radius of curvature of a reference sphere (paraxial radius of curvature), K the conic constant, and An the nth-order aspherical coefficient. In the examples, the second-order aspherical coefficient A2 is 0. “E-n” means “×10⁻ⁿ.”

$$S ( y ) = ( {y}^{2} / r ) / \{ 1 + {( 1 - K \times {y}^{2} / {r}^{2} )}^{1 / 2} \} + A 4 \times {y}^{4} + A 6 \times {y}^{6} + A 8 \times {y}^{8} + A 10 \times {y}^{10} \qquad ( a )$$

The above reference symbols in Table 2-1 will also be used similarly in the table of the second optical system OS2 of the present example and the tables of the other examples described below.

TABLE 2-1
[General Specifications]

| | |
|---|---|
| fA | 1.48 |
| TLA | 72.20 |
| FnoA | 2.77 |
| YmaxA | 2.40 |
| ωA | 97.0° |
| Wi | 0.20 |

[Lens Specifications]

| m | r | d | n(d) | ν d | |
|---|---|---|---|---|---|
| 1) | 42.23761 | 2.000 | 1.773 | 49.62 | |
| 2) | 18.35239 | 12.350 | | | |
| *3) | 213.21931 | 1.500 | 1.694 | 53.20 | |
| *4) | 10.55620 | 6.400 | | | |
| 5) | −18.79738 | 0.400 | 1.593 | 67.90 | |
| 6) | 13.14408 | 1.350 | | | |
| 7) | ∞ | 15.000 | 1.517 | 63.88 | (optical path splitter OB) |
| 8) | ∞ | 12.250 | | | |
| 9> | ∞ | 0.100 | | | (aperture stop ST1) |
| 10) | 33.48408 | 1.000 | 1.744 | 44.80 | |
| 11) | −103.76024 | 0.300 | | | |
| 12) | 7.49600 | 5.100 | 1.755 | 27.57 | |
| 13) | 4.43565 | 0.300 | | | |
| 14) | 3.99229 | 5.250 | 1.519 | 69.89 | |
| 15) | −3.14423 | 0.400 | 1.755 | 27.57 | |
| 16) | 9.94355 | 0.300 | | | |
| *17) | 4.05633 | 5.900 | 1.694 | 53.20 | |
| *18) | −25.33643 | 2.300 | | | |

[Aspherical Surface Data]

| m | K | A4 | A6 | A8 | A10 |
|---|---|---|---|---|---|
| 3) | 5.7420 | 2.20E−04 | −1.62E−06 | 4.03E−09 | 2.36E−19 |
| 4) | 0.3929 | 3.75E−04 | 6.37E−07 | 3.65E−16 | 3.68E−19 |
| 17) | −0.3515 | −7.02E−04 | 2.51E−05 | −1.55E−06 | −3.91E−08 |
| 18) | −2.8412 | 3.85E−03 | 9.41E−04 | −1.14E−04 | 1.77E−05 |

[Focal Length Data of Groups]

| Groups | Starting surfaces | Focal lengths |
|---|---|---|
| GF | 1 | −3.95 |
| GR1 | 10 | 10.21 |

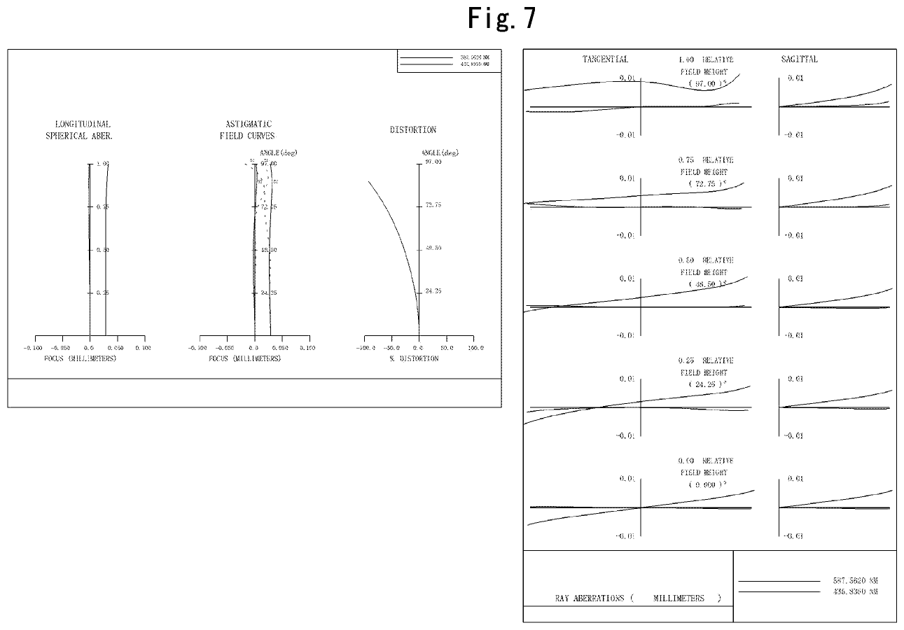

FIG. 7 shows aberrations of the first optical system OS1 included in the optical system 1 of Example 2.

The graphs of aberrations suggest that the first optical system OS1 of the present example corrects aberrations appropriately and has high optical performance.

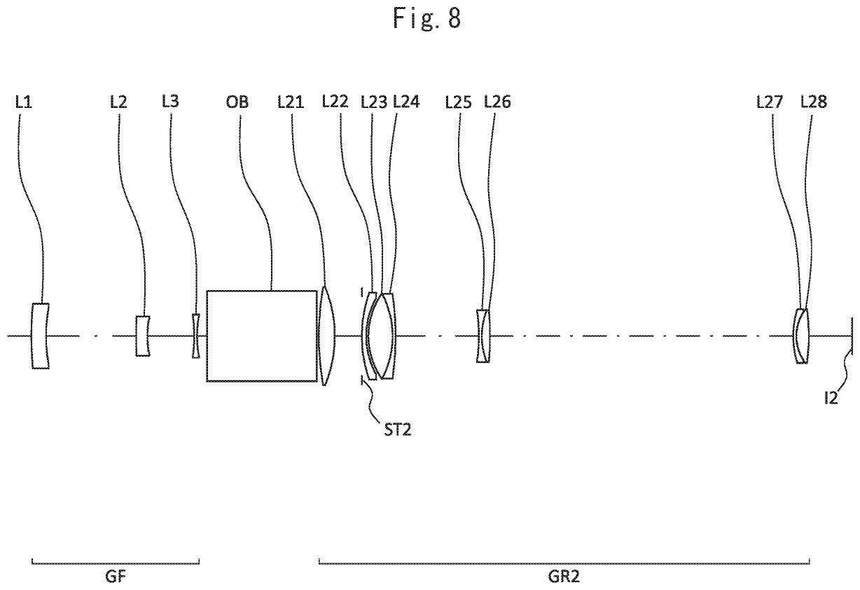

FIG. 8 is a cross-sectional view of a second optical system included in the optical system of Example 2.

The second optical system OS2 of the present example has, in order from the object side, a meniscus-shaped negative lens L1 convex on the object side, a meniscus-shaped negative lens L2 convex on the object side, a biconcave negative lens L3, an optical path splitter OB, a biconvex positive lens L21, an aperture stop ST2, a meniscus-shaped negative lens L22 convex on the object side, a positive cemented lens composed of a biconvex positive lens L23 and a meniscus-shaped negative lens L24 concave on the object side, a negative cemented lens composed of a biconcave negative lens L25 and a biconvex positive lens L26, and a positive cemented lens of a meniscus-shaped negative lens L27 convex on the object side and a biconvex positive lens L28.

An imaging element constructed from CCD or CMOS, or the like is disposed on the image plane 12.

In the second optical system OS2 of the present example, the negative lens L1, negative lens L2, and negative lens L3 are included in the front lens group GF.

In the second optical system OS2 of the present example, the positive lens L21, the aperture stop ST2, the negative lens L22, the positive cemented lens composed of the positive lens L23 and the negative lens L24, the negative cemented lens composed of the negative lens L25 and the positive lens L26, and the positive cemented lens composed of the negative lens L27 and the positive lens L28 are included in the second rear lens group GR2.

Table 2-2 below shows the specifications of the second optical system OS2 of the

TABLE 2-2
[General Specifications]

| | |
|---|---|
| fB | 12.85 |
| TLB | 112.18 |
| FnoB | 6.32 |
| YmaxB | 2.28 |
| ωB | 10.0° |

[Lens Specifications]

| m | r | d | n(d) | νd | |
|---|---|---|---|---|---|
| 1) | 42.23761 | 2.000 | 1.773 | 49.62 | |
| 2) | 18.35239 | 12.350 | | | |
| *3) | 213.21931 | 1.500 | 1.694 | 53.20 | |
| *4) | 10.55620 | 6.400 | | | |
| 5) | −18.79738 | 0.400 | 1.593 | 67.90 | |
| 6) | 13.14408 | 1.350 | | | |
| 7) | ∞ | 15.000 | 1.517 | 63.88 | (optical splitter OB) |
| 8) | ∞ | 0.300 | | | |
| 9) | 33.83714 | 2.170 | 1.603 | 60.69 | |
| 10) | −15.49196 | 3.700 | 0.000 | | |
| 11> | ∞ | 0.000 | | | (aperture stop ST2) |
| 12) | 15.63559 | 0.600 | 1.744 | 44.80 | |
| 13) | 9.50756 | 0.300 | | | |
| 14) | 9.04713 | 3.300 | 1.498 | 82.57 | |
| 15) | −10.90940 | 0.400 | 1.744 | 44.80 | |
| 16) | −35.61306 | 11.400 | | | |
| 17) | −19.84006 | 0.400 | 1.744 | 44.80 | |
| 18) | 8.37976 | 1.120 | 1.620 | 36.40 | |
| 19) | −33.60000 | 41.450 | | | |
| 20) | 11.10000 | 0.420 | 1.755 | 27.57 | |
| 21) | 5.35000 | 1.700 | 1.498 | 82.57 | |
| 22) | −21.60000 | 5.919 | | | |

[Aspherical Surface Data]

| m | K | A4 | A6 | A8 | A10 |
|---|---|---|---|---|---|
| 3) | 5.7420 | 2.20E−04 | −1.62E−06 | 4.03E−09 | 2.36E−19 |
| 4) | 0.3929 | 3.75E−04 | 6.37E−07 | 3.65E−16 | 3.68E−19 |

[Focal Length Data of Groups]

| Groups | Starting surfaces | Focal lengths |
|---|---|---|
| GF | 1 | −3.95 |
| GR2 | 9 | −12.32 |

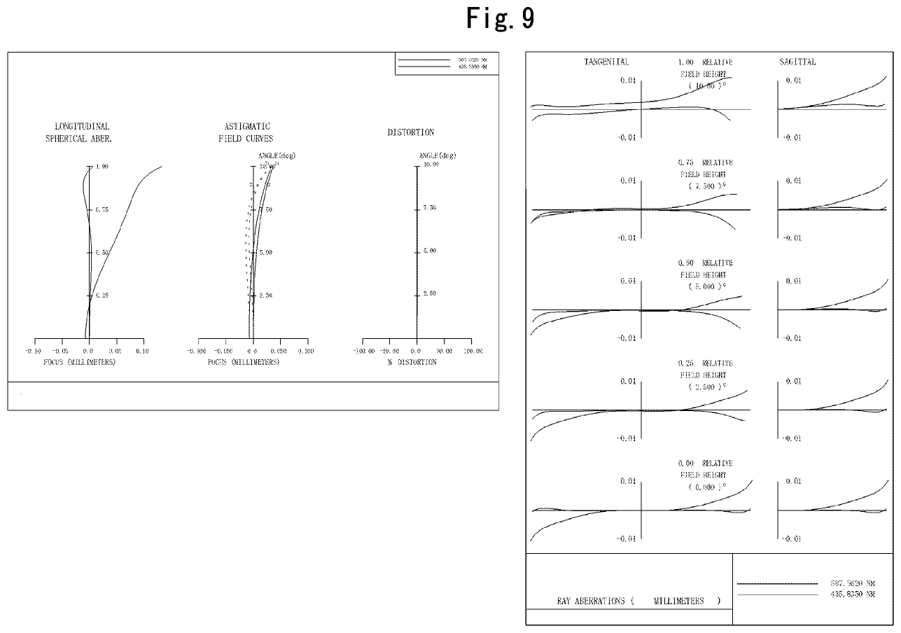

FIG. 9 shows aberrations of the second optical system OS2 included in the optical system 1 of Example 2.

The graphs of aberrations suggest that the second optical system OS2 of the present example corrects aberrations appropriately and has high optical performance.

### Example 3

In the optical system 1 of Example 3, the second optical system OS2 has a total focal length longer than a total focal length of the first optical system OS1. That is, the first optical system OS1 corresponds to a wide-angle optical system, and the second optical system OS2 corresponds to a telephoto optical system.

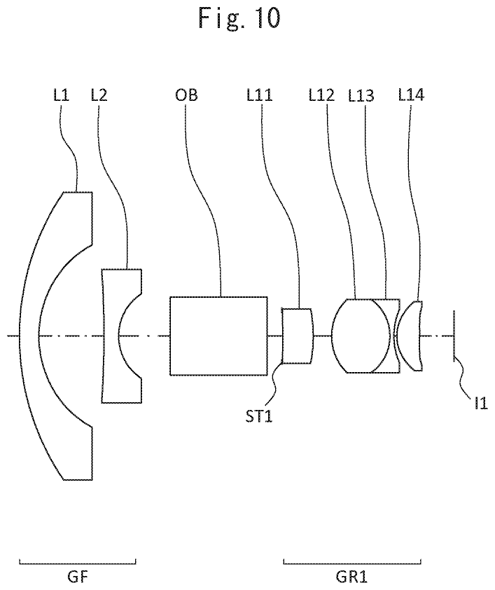

FIG. 10 is a cross-sectional view of a first optical system included in the optical system of Example 3.

The first optical system OS1 of the present example has, in order from the object side, a meniscus-shaped negative lens L1 convex on the object side, a biconcave negative lens L2, an optical path splitter OB, an aperture stop ST1, a meniscus-shaped positive lens L11 concave on the object side, a positive cemented lens composed of a biconvex positive lens L12 and a biconcave negative lens L13, and a meniscus-shaped positive lens L14 convex on the object side.

A first imaging element (not shown) constructed from a CCD or CMOS, or the like is disposed on the image plane I1.

In the first optical system OS1 of the present example, the negative lens L1 and the negative lens L2 are included in the front lens group GF.

In the first optical system OS2 of the present example, the positive lens L11, the negative lens L12, the positive cemented lens composed of the positive lens L13 and the negative lens L14, and the positive lens L15 are included in the first rear lens group GR1.

Table 3-1 below shows the specifications of the first optical system OS1 of the

TABLE 3-1
[General Specifications]

| | |
|---|---|
| fA | 2.06 |
| TLA | 44.69 |
| FnoA | 2.00 |
| YmaxA | 2.45 |
| ωA | 78.0° |
| Wi | 0.10 |

[Lens Specifications]

| m | r | d | n(d) | νd | |
|---|---|---|---|---|---|
| 1) | 23.88511 | 2.000 | 1.755 | 52.34 | |
| 2) | 9.94429 | 6.700 | | | |
| 3) | −83.42533 | 1.500 | 1.618 | 63.34 | |
| 4) | 4.78676 | 5.280 | | | |
| 5) | ∞ | 10.000 | 1.517 | 63.88 | (optical path splitter OB) |
| 6) | ∞ | 1.500 | | | |
| 7> | ∞ | 0.100 | | | (aperture stop ST1) |
| 8) | −242.51150 | 3.130 | 1.744 | 44.80 | |
| 9) | −13.46579 | 1.890 | | | |
| 10) | 4.81511 | 6.000 | 1.519 | 69.89 | |
| 11) | −4.20835 | 0.400 | 1.755 | 27.57 | |
| 12) | 6.09372 | 0.300 | | | |
| *13) | 3.54046 | 2.340 | 1.583 | 59.46 | |
| *14) | −80.74067 | 3.553 | | | |

[Aspherical Surface Data]

| m | K | A4 | A6 | A8 | A10 |
|---|---|---|---|---|---|
| 13) | −0.5664 | −5.22E−04 | 3.18E−05 | 1.03E−05 | −6.79E−07 |
| 14) | 6.1480 | 3.31E−03 | 1.12E−05 | 4.52E−05 | −3.75E−06 |

[Focal Length Data of Groups]

| Groups | Starting surfaces | Focal lengths |
|---|---|---|
| GF | 1 | −4.60 |
| GR1 | 8 | 7.17 |

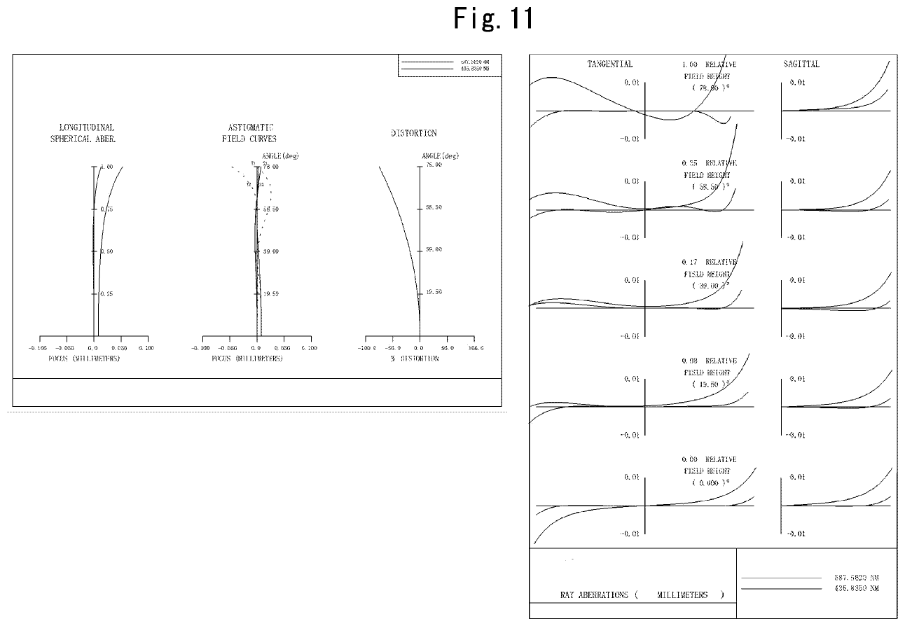

FIG. 11 shows aberrations of the first optical system OS1 included in the optical system 1 of Example 3.

The graphs of aberrations suggest that the first optical system OS1 of the present example corrects aberrations appropriately and has high optical performance.

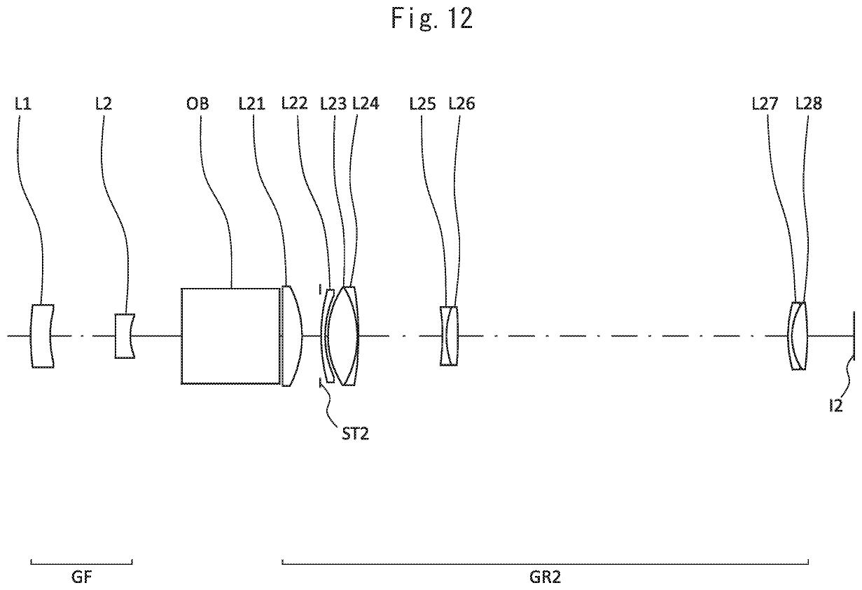

FIG. 12 is a cross-sectional view of a second optical system included in the optical system of Example 3.

The second optical system OS2 of the present example has, in order from the object side, a meniscus-shaped negative lens L1 convex on the object side, a biconcave negative lens L2, an optical path splitter OB, a meniscus-shaped positive lens L21 concave on the object side, an aperture stop ST2, a meniscus-shaped negative lens L22 convex on the object side, a positive cemented lens composed of a biconvex positive lens L23 and a meniscus-shaped negative lens L24 concave on the object side, a negative cemented lens composed of a biconcave negative lens L25 and a biconvex positive lens L26, and a positive cemented lens composed of a meniscus-shaped negative lens L27 convex on the object side and a biconvex positive lens L28.

An imaging element constructed from CCD or CMOS, or the like is disposed on the image plane 12.

In the second optical system OS2 of the present example, the negative lens L1 and the negative lens L2 are included in the front lens group GF.

In the second optical system OS2 of the present example, the positive lens L21, the aperture stop ST2, the negative lens L22, the positive cemented lens composed of the positive lens L23 and the negative lens L24, the negative cemented lens composed of the negative lens L25 and the positive lens L26, and the positive cemented lens composed of the negative lens L27 and the positive lens L28 are included in the second rear lens group GR2.

Table 3-2 below shows the specifications of the second optical system OS2 of the

TABLE 3-2
[General Specifications]

| | |
|---|---|
| fB | 12.90 |
| TLB | 84.32 |
| FnoB | 6.57 |
| YmaxB | 2.28 |
| ωB | 10.0° |

[Lens Specifications]

| m | r | d | n(d) | νd | |
|---|---|---|---|---|---|
| 1) | 23.88511 | 2.000 | 1.755 | 52.34 | |
| 2) | 9.94429 | 6.700 | | | |
| 3) | −83.42533 | 1.500 | 1.618 | 63.34 | |
| 4) | 4.78676 | 5.280 | | | |
| 5) | ∞ | 10.000 | 1.517 | 63.88 | (optical splitter OB) |
| 6) | ∞ | 0.300 | | | |
| 7) | −6118.32762 | 2.000 | 1.603 | 60.69 | |
| 8) | −9.74192 | 1.850 | | | |
| 9> | ∞ | 0.110 | | | (aperture stop ST2) |
| 10) | 15.72367 | 0.400 | 1.744 | 44.80 | |
| 11) | 8.88523 | 0.300 | | | |
| 12) | 7.99714 | 3.000 | 1.498 | 82.57 | |
| 13) | −8.68959 | 0.120 | 1.744 | 44.80 | |
| 14) | −25.95611 | 8.600 | | | |
| 15) | −18.47079 | 0.400 | 1.744 | 44.80 | |
| 16) | 7.52706 | 1.180 | 1.620 | 36.40 | |
| 17) | −33.60000 | 33.800 | | | |
| 18) | 11.10000 | 0.400 | 1.755 | 27.57 | |
| 19) | 5.35000 | 1.570 | 1.498 | 82.57 | |
| 20) | −21.60000 | 4.805 | | | |

[Focal Length Data of Groups]

| Groups | Starting surfaces | Focal lengths |
|---|---|---|
| GF | 1 | −4.60 |
| GR2 | 7 | −21.79 |

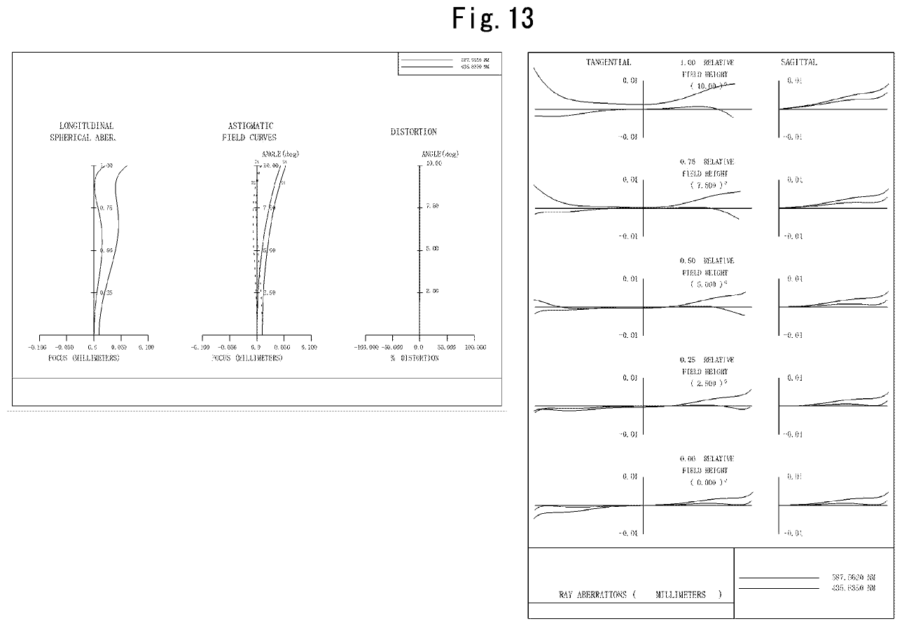

FIG. 13 shows aberrations of the second optical system OS2 included in the optical system 1 of Example 3.

The graphs of aberrations suggest that the second optical system OS2 of the present example corrects aberrations appropriately and has high optical performance.

### Example 4

In the optical system 1 of Example 4, the second optical system OS2 has a total focal length longer than a total focal length of the first optical system OS1. That is, the first optical system OS1 corresponds to a wide-angle optical system, and the second optical system OS2 corresponds to a telephoto optical system.

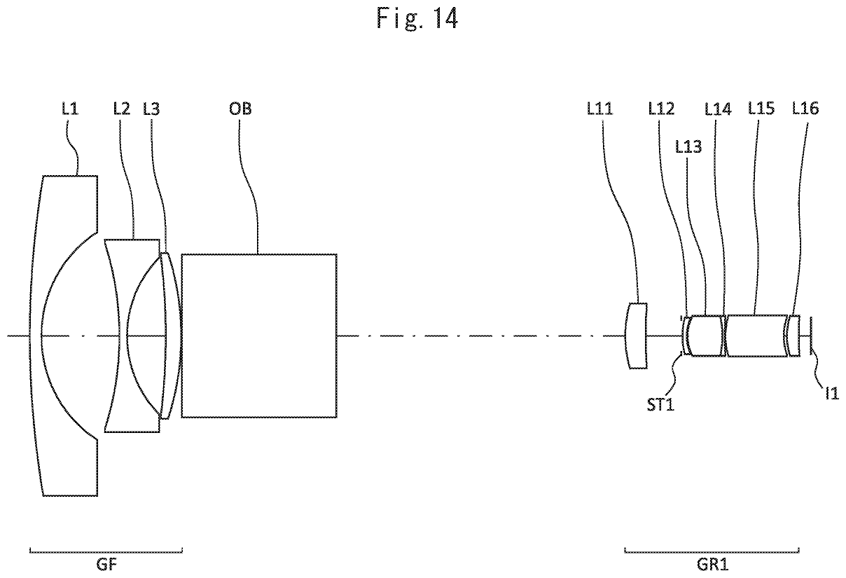

FIG. 14 is a cross-sectional view of a first optical system included in the optical system of Example 4.

The first optical system OS1 of the present example has, in order from the object side, a meniscus-shaped negative lens L1 convex on the object side, a biconcave negative lens L2, a meniscus-shaped positive lens L3 concave on the object side, an optical path splitter OB, a meniscus-shaped positive lens L11 convex on the object side, an aperture stop ST1, a meniscus-shaped negative lens L12 convex on the object side, a positive cemented lens composed of a biconvex positive lens L13 and a biconcave negative lens L14, a meniscus-shaped negative lens L15 convex on the object side, and a meniscus-shaped positive lens L16 convex on the object side.

A first imaging element (not shown) constructed from a CCD or CMOS, or the like is disposed on the image plane I1.

In the first optical system OS1 of the present example, the negative lens L1, the negative lens L2, and the negative lens L3 are included in the front lens group GF.

In the first optical system OS2 of the present example, the positive lens L11, the aperture stop ST1, the negative lens L12, the positive cemented lens of the positive lens L13 and the negative lens L14, the negative lens L15, and the positive lens L16 are included in the first rear lens group GR1.

Table 4-1 below shows the specifications of the first optical system OS1 of the

TABLE 4-1
[General Specifications]

| | |
|---|---|
| fA | 2.16 |
| TLA | 101.18 |
| FnoA | 2.78 |
| YmaxA | 2.28 |
| ωA | 91.0° |
| Wi | 0.20 |

[Lens Specifications]

| m | r | d | n(d) | νd | |
|---|---|---|---|---|---|
| 1) | 113.14209 | 1.500 | 1.744 | 44.80 | |
| 2) | 15.03926 | 10.100 | | | |
| 3) | −36.13818 | 1.000 | 1.487 | 70.32 | |
| 4) | 13.38947 | 5.000 | | | |
| 5) | −77.29143 | 2.000 | 1.755 | 27.57 | |
| 6) | −31.72172 | 0.100 | | | |
| 7) | ∞ | 20.000 | 1.517 | 63.88 | (optical path splitter OB) |
| 8) | ∞ | 37.400 | | | |
| 9) | 13.50027 | 2.650 | 1.750 | 35.25 | |
| 10) | 54.25029 | 4.610 | | | |
| 11> | ∞ | 0.160 | | | (aperture stop ST1) |
| 12) | 9.05782 | 0.550 | 1.755 | 27.57 | |
| 13) | 5.17965 | 0.110 | | | |
| 14) | 5.22254 | 4.500 | 1.519 | 69.89 | |
| 15) | −11.42347 | 0.300 | 1.755 | 27.57 | |
| 16) | 32.62581 | 0.100 | | | |
| 17) | 8.22833 | 7.550 | 1.620 | 60.24 | |
| 18) | 6.68071 | 0.410 | | | |
| 19) | 7.50400 | 1.540 | 1.620 | 60.24 | |
| 20) | 37.41418 | 1.598 | | | |

[Focal Length Data of Groups]

| Groups | Starting surfaces | Focal lengths |
|---|---|---|
| GF | 1 | −12.06 |
| GR1 | 9 | 12.20 |

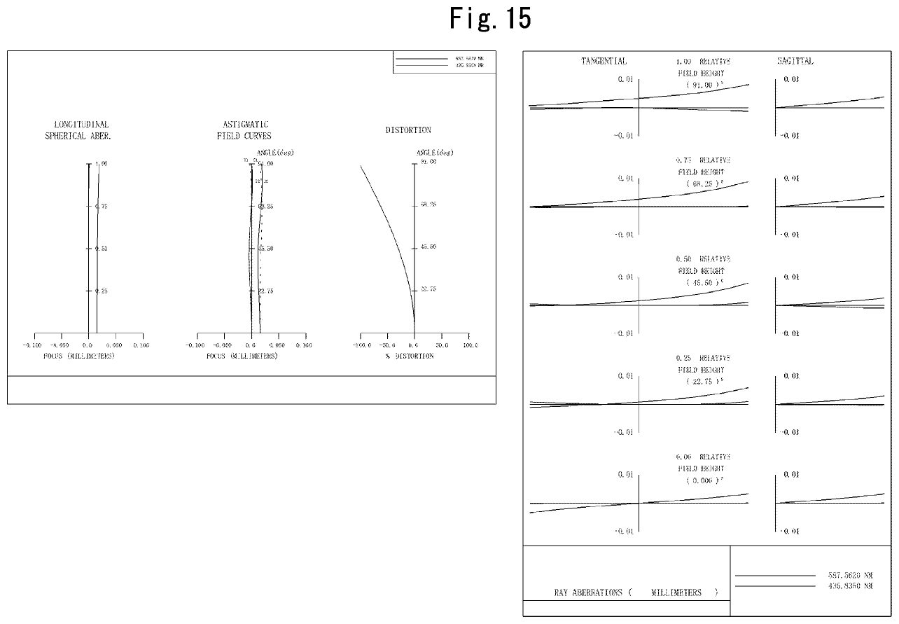

FIG. 15 shows aberrations of the first optical system OS1 included in the optical system 1 of Example 4.

The graphs of aberrations suggest that the first optical system OS1 of the present example corrects aberrations appropriately and has high optical performance.

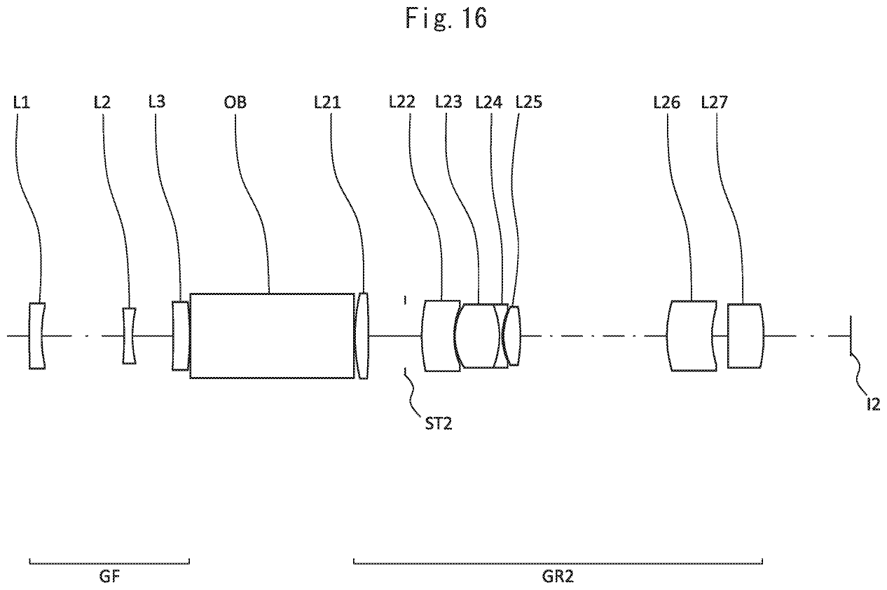

FIG. 16 is a cross-sectional view of a second optical system included in the optical system of Example 4.

The second optical system OS2 of the present example has, in order from the object side, a meniscus-shaped negative lens L1 convex on the object side, a biconcave negative lens L2, a meniscus-shaped positive lens L3 concave on the object side, an optical path splitter OB, a biconvex positive lens L21, an aperture stop ST2, a meniscus-shaped negative lens L22 convex on the object side, a negative cemented lens composed of a biconvex positive lens L23 and a biconcave negative lens L24, a biconvex positive lens L25, a meniscus-shaped negative lens L26 convex on the object side, and a meniscus-shaped positive lens L27 concave on the object side.

An imaging element constructed from CCD or CMOS, or the like is disposed on the image plane 12.

In the second optical system OS2 of the present example, the negative lens L1, negative lens L2, and negative lens L3 are included in the front lens group GF.

In the second optical system OS2 of the present example, the positive lens L21, the aperture stop ST2, the negative lens L22, the negative cemented lens composed of the positive lens L23 and the negative lens L24, the positive lens L25, the negative lens L26, and the positive lens L27 are included in the second rear lens group GR2.

Table 4-2 below shows the specifications of the second optical system OS2 of the

TABLE 4-2
[General Specifications]

| | |
|---|---|
| fB | 13.07 |
| TLB | 100.39 |
| FnoB | 5.25 |
| YmaxB | 2.28 |
| ωB | 10.0° |

[Lens Specifications]

| m | r | d | n(d) | νd | |
|---|---|---|---|---|---|
| 1) | 113.14209 | 1.500 | 1.744 | 44.80 | |
| 2) | 15.03926 | 10.100 | | | |
| 3) | −36.13818 | 1.000 | 1.487 | 70.32 | |
| 4) | 13.38947 | 5.000 | | | |
| 5) | −77.29143 | 2.000 | 1.755 | 27.57 | |
| 6) | −31.72172 | 0.100 | | | |
| 7) | ∞ | 20.000 | 1.517 | 63.88 | (optical splitter OB) |
| 8) | ∞ | 0.100 | | | |
| 9) | 20.67358 | 1.660 | 1.699 | 30.13 | |
| 10) | −69.69443 | 4.450 | | | |
| 11) | ∞ | 2.050 | | | (aperture stop ST2) |
| 12) | 18.45580 | 3.940 | 1.750 | 35.25 | |
| 13) | 8.14654 | 0.100 | | | |
| 14) | 6.40148 | 5.450 | 1.487 | 70.32 | |
| 15) | −9.26710 | 0.350 | 1.850 | 32.35 | |
| 16) | 6.70776 | 0.170 | | | |
| 17) | 7.36263 | 2.050 | 1.589 | 61.22 | |
| 18) | −18.62826 | 17.900 | | | |
| 19) | 13.55205 | 5.500 | 1.755 | 27.57 | |
| 20) | 10.51263 | 2.000 | | | |
| 21) | 204.26697 | 4.320 | 1.755 | 27.57 | |
| 22) | −16.00927 | 10.651 | | | |

[Focal Length Data of Groups]

| Groups | Starting surfaces | Focal lengths |
|---|---|---|
| GF | 1 | −12.06 |
| GR2 | 9 | 53.94 |

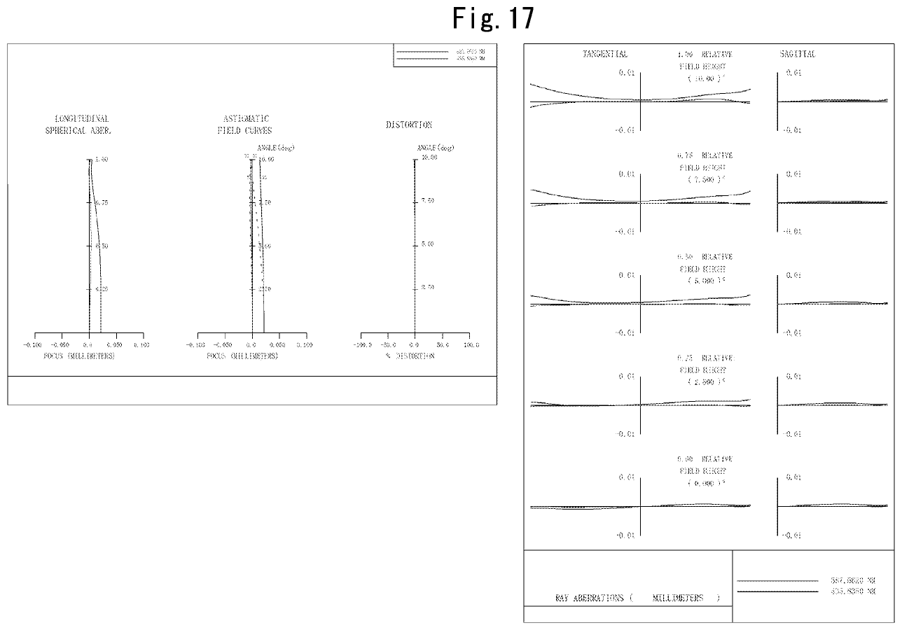

FIG. 17 shows aberrations of the second optical system OS2 included in the optical system 1 of Example 4.

The graphs of aberrations suggest that the second optical system OS2 of the present example corrects aberrations appropriately and has high optical performance.

### Example 5

In the optical system 1 of Example 5, the second optical system OS2 has a total focal length longer than a total focal length of the first optical system OS1. That is, the first optical system OS1 corresponds to a wide-angle optical system, and the second optical system OS2 corresponds to a telephoto optical system.

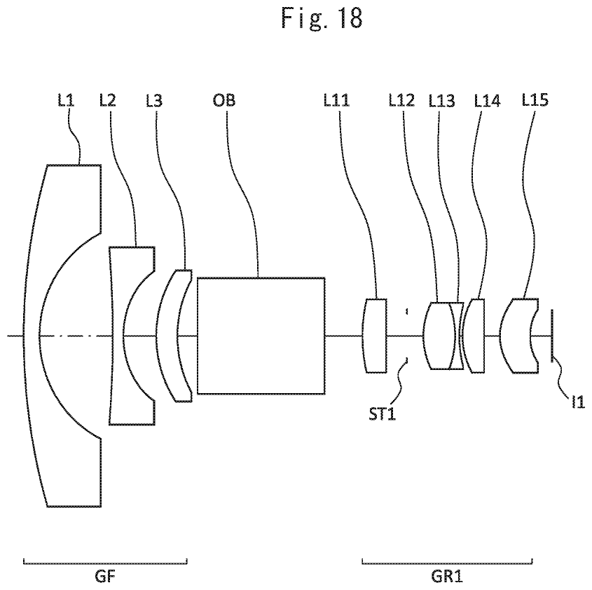

FIG. 18 is a cross-sectional view of a first optical system included in the optical system of Example 5.

The first optical system OS1 of the present example has, in order from the object side, a meniscus-shaped negative lens L1 convex on the object side, a biconcave negative lens L2, a meniscus-shaped positive lens L3 convex on the object side, an optical path splitter OB, a biconvex positive lens L11, an aperture stop ST1, a negative cemented lens composed of a biconvex positive lens L12 and a biconcave negative lens L13, a biconvex positive lens L14, and a meniscus-shaped positive lens L15 convex on the object side.

A first imaging element (not shown) constructed from a CCD or CMOS, or the like is disposed on the image plane I1.

In the first optical system OS1 of the present example, the negative lens L1, the negative lens L2, and the negative lens L3 are included in the front lens group GF.

In the first optical system OS2 of the present example, the positive lens L11, the aperture stop ST1, the negative cemented lens composed of the positive lens L12 and the negative lens L13, the positive lens L14, and the positive lens L15 are included in the first rear lens group GR1.

Table 5-1 below shows the specifications of the first optical system OS1 of the

TABLE 5-1
[General Specifications]

| | |
|---|---|
| fA | 1.91 |
| TLA | 50.00 |
| FnoA | 1.90 |
| YmaxA | 2.29 |
| ωA | 91.0° |
| Wi | 0.10 |

[Lens Specifications]

| m | r | d | n(d) | νd | |
|---|---|---|---|---|---|
| 1) | 52.94033 | 1.500 | 1.720 | 50.27 | |
| 2) | 10.22772 | 6.940 | | | |
| *3) | −86.42248 | 1.000 | 1.553 | 71.68 | |
| *4) | 7.86002 | 3.110 | | | |
| 5) | 10.21092 | 2.000 | 1.847 | 23.80 | |
| 6) | 10.22927 | 1.916 | | | |
| 7) | ∞ | 12.000 | 1.517 | 63.88 | (optical path splitter OB) |
| 8) | ∞ | 3.600 | | | |
| 9) | 13.72573 | 2.250 | 1.755 | 27.57 | |
| 10) | −1445.37868 | 1.970 | | | |
| 11> | ∞ | 1.550 | | | (aperture stop ST1) |
| 12) | 6.35540 | 3.000 | 1.519 | 69.89 | |
| 13) | −8.00624 | 0.400 | 1.847 | 23.80 | |
| 14) | 10.34236 | 0.300 | | | |
| 15) | 6.40110 | 2.050 | 1.640 | 60.19 | |
| 16) | −1099.36165 | 1.500 | | | |
| *17) | 4.48330 | 2.860 | 1.801 | 45.45 | |
| *18) | 4.93022 | 2.052 | | | |

[Aspherical Surface Data]

| m | K | A4 | A6 | A8 | A10 |
|---|---|---|---|---|---|
| 3) | −9.3823 | 7.30E−06 | 5.43E−11 | 6.84E−24 | 0.00E+00 |
| 4) | 0.4220 | 6.82E−06 | −1.39E−11 | 2.07E−28 | 0.00E+00 |
| 17) | −0.2893 | −4.86E−05 | −5.84E−05 | 4.78E−06 | −7.43E−07 |
| 18) | −2.5897 | 7.06E−03 | −2.43E−04 | 6.71E−05 | −1.12E−05 |

[Focal Length Data of Groups]

| Groups | Starting surfaces | Focal lengths |
|---|---|---|
| GF | 1 | −6.07 |
| GR1 | 9 | 7.14 |

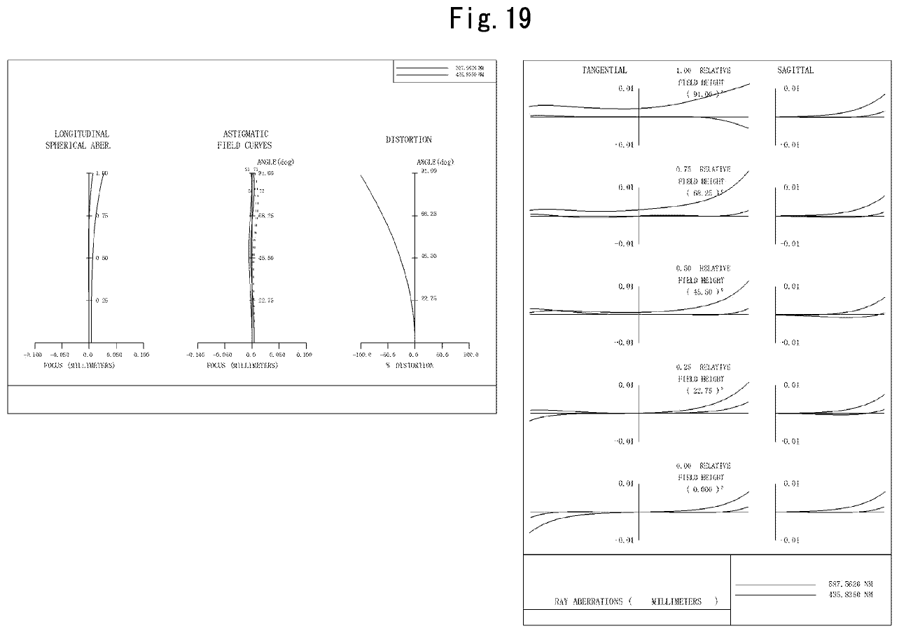

FIG. 19 shows aberrations of the first optical system OS1 included in the optical system 1 of Example 5.

The graphs of aberrations suggest that the first optical system OS1 of the present example corrects aberrations appropriately and has high optical performance.

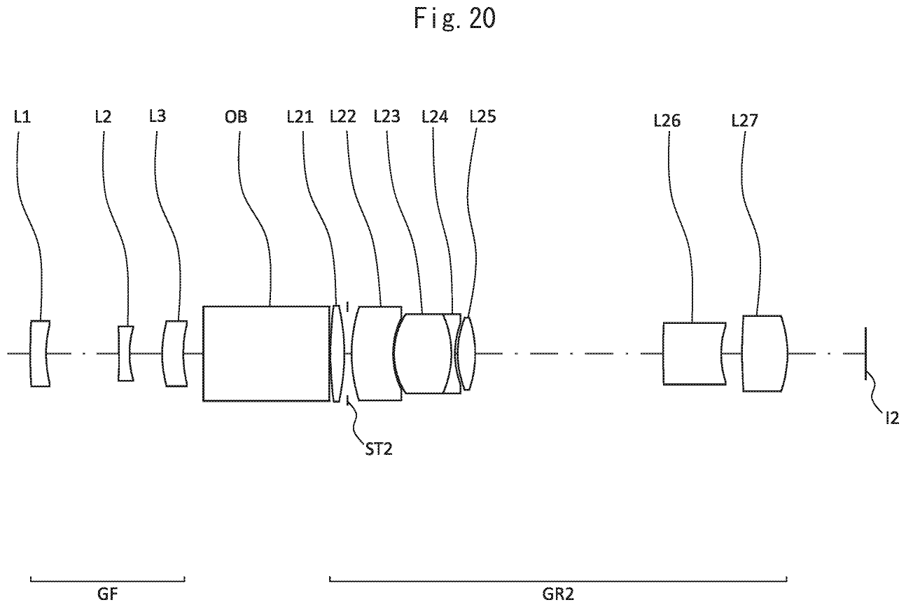

FIG. 20 is a cross-sectional view of a second optical system included in the optical system of Example 5.

The second optical system OS2 of the present example has, in order from the object side, a meniscus-shaped negative lens L1 convex on the object side, a biconcave negative lens L2, a meniscus-shaped positive lens L3 convex on the object side, an optical path splitter OB, a biconvex positive lens L21, an aperture stop ST2, a meniscus-shaped negative lens L22 convex on the object side, a negative cemented lens composed of a biconvex positive lens L23 and a biconcave negative lens L24, a biconvex positive lens L25, a meniscus-shaped negative lens L26 convex on the object side, and a biconvex positive lens L27.

An imaging element constructed from CCD or CMOS, or the like is disposed on the image plane 12.

In the second optical system OS2 of the present example, the negative lens L1, negative lens L2, and negative lens L3 are included in the front lens group GF.

In the second optical system OS2 of the present example, the positive lens L21, the aperture stop ST2, the negative lens L22, the negative cemented lens composed of the positive lens L23 and the negative lens L24, the positive lens L25, the negative lens L26, and the positive lens L27 are included in the second rear lens group GR2.

Table 5-2 below shows the specifications of the second optical system OS2 of the

TABLE 5-2
[General Specifications]

| | |
|---|---|
| fB | 12.91 |
| TLB | 79.52 |
| FnoB | 6.25 |
| YmaxB | 2.28 |
| ωB | 10.0° |

[Lens Specifications]

| m | r | d | n(d) | νd | |
|---|---|---|---|---|---|
| 1) | 52.94033 | 1.500 | 1.720 | 50.27 | |
| 2) | 10.22772 | 6.940 | | | |
| *3) | −86.42248 | 1.000 | 1.553 | 71.68 | |
| *4) | 7.86002 | 3.110 | | | |
| 5) | 10.21092 | 2.000 | 1.847 | 23.80 | |
| 6) | 10.22927 | 1.916 | | | |
| 7) | ∞ | 12.000 | 1.517 | 63.88 | (optical splitter OB) |
| 8) | ∞ | 0.100 | | | |
| 9) | 30.93140 | 1.310 | 1.699 | 30.13 | |
| 10) | −18.03001 | 0.300 | | | |
| 11> | ∞ | 0.400 | | | (aperture stop ST2) |
| 12) | 12.63426 | 3.940 | 1.750 | 35.25 | |
| 13) | 6.79988 | 0.100 | | | |
| 14) | 6.13728 | 5.450 | 1.487 | 70.32 | |
| 15) | −8.01512 | 0.350 | 1.850 | 32.35 | |
| 16) | 7.58006 | 0.260 | | | |
| 17) | 8.09915 | 1.660 | 1.487 | 70.32 | |
| 18) | −9.37886 | 17.900 | | | |
| 19) | 74.85170 | 5.500 | 1.755 | 27.57 | |
| 20) | 7.26414 | 2.000 | | | |
| 21) | 42.09757 | 4.320 | 1.755 | 27.57 | |
| 22) | −9.31976 | 7.460 | | | |

[Aspherical Surface Data]

| m | K | A4 | A6 | A8 | A10 |
|---|---|---|---|---|---|
| 3) | −9.3823 | 7.30E−06 | 5.43E−11 | 6.84E−24 | 0.00E+00 |
| 4) | 0.4220 | 6.82E−06 | −1.39E−11 | 2.07E−28 | 0.00E+00 |

[Focal Length Data of Groups]

| Groups | Starting surfaces | Focal lengths |
|---|---|---|
| GF | 1 | −6.07 |
| GR2 | 9 | −300.89 |

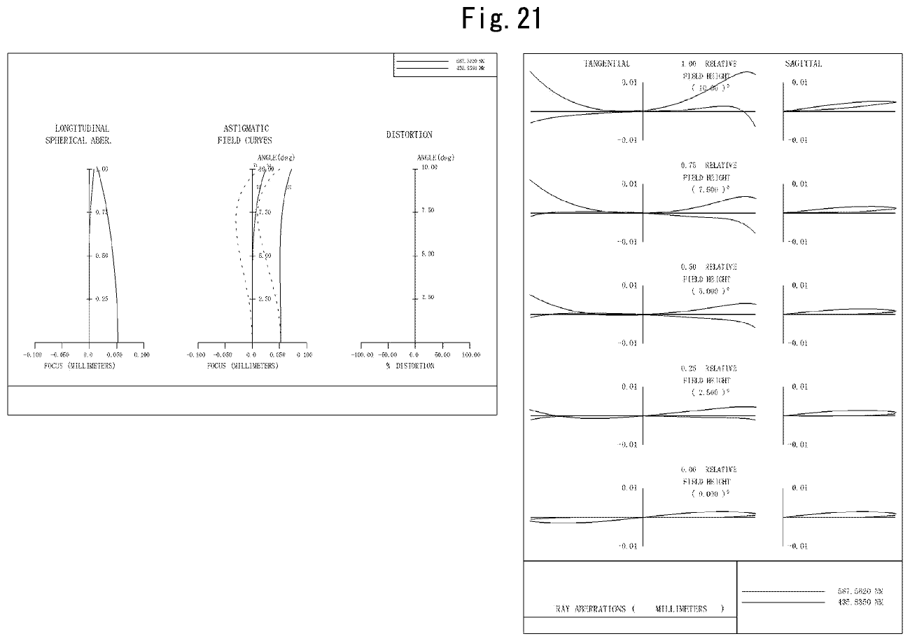

FIG. 21 shows aberrations of the second optical system OS2 included in the optical system 1 of Example 5.

The graphs of aberrations suggest that the second optical system OS2 of the present example corrects aberrations appropriately and has high optical performance.

### Example 6

In the optical system 1 of Example 6, the second optical system OS2 has a total focal length longer than a total focal length of the first optical system OS1. That is, the first optical system OS1 corresponds to a wide-angle optical system, and the second optical system OS2 corresponds to a telephoto optical system.

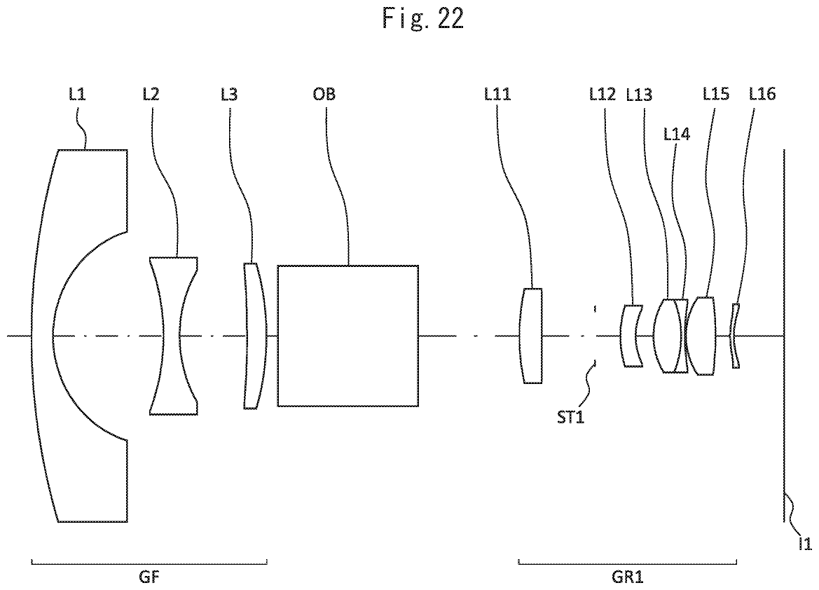

FIG. 22 is a cross-sectional view of a first optical system included in the optical system of Example 6.

The first optical system OS1 of the present example has, in order from the object side, a meniscus-shaped negative lens L1 convex on the object side, a biconcave negative lens L2, a meniscus-shaped positive lens L3 concave on the object side, an optical path splitter OB, a biconvex positive lens L11, an aperture stop ST1, a meniscus-shaped negative lens L12 convex on the object side, a positive cemented lens composed of a biconvex positive lens L13 and a biconcave negative lens L14, a biconvex positive lens L15, and a meniscus-shaped negative lens L16 convex on the object side.

A first imaging element (not shown) constructed from a CCD or CMOS, or the like is disposed on the image plane I1.

In the first optical system OS1 of the present example, the negative lens L1, the negative lens L2, and the negative lens L3 are included in the front lens group GF.

In the first optical system OS1 of the present example, the positive lens L11, the aperture stop ST1, the positive lens L12, the positive cemented lens composed of the positive lens L13 and the negative lens L14, the positive lens L15, and the negative lens L16 are included in the first rear lens group GR1.

Table 6-1 below shows the specifications of the first optical system OS1 of the

TABLE 6-1
[General Specifications]

| | |
|---|---|
| fA | 1.92 |
| TLA | 69.94 |
| FnoA | 2.31 |
| YmaxA | 2.28 |
| ωA | 90.5° |
| Wi | 0.30 |

[Lens Specifications]

| m | r | d | n(d) | νd | |
|---|---|---|---|---|---|
| 1) | 55.24628 | 2.009 | 1.755 | 27.57 | |
| 2) | 9.61973 | 10.260 | | | |
| 3) | −17.84622 | 1.500 | 1.618 | 63.34 | |
| 4) | 11.21493 | 6.270 | | | |
| 5) | −71.15753 | 1.800 | 1.755 | 27.57 | |
| 6) | −22.22626 | 1.080 | | | |
| 7) | ∞ | 13.000 | 1.517 | 63.88 | (optical path splitter OB) |
| 8) | ∞ | 9.420 | | | |
| 9) | 18.37359 | 2.070 | 1.750 | 35.25 | |
| 10) | −522.06366 | 4.950 | | | |
| 11> | ∞ | 2.370 | | | (aperture stop ST1) |
| 12) | 8.49437 | 1.420 | 1.755 | 27.57 | |
| 13) | 5.23094 | 1.650 | | | |
| 14) | 5.83639 | 2.570 | 1.519 | 69.89 | |
| 15) | −8.16757 | 0.350 | 1.755 | 27.57 | |
| 16) | 17.26271 | 0.100 | | | |
| 17) | 5.85248 | 2.740 | 1.620 | 60.24 | |
| 18) | −26.28387 | 1.370 | | | |
| *19) | 6.96368 | 0.350 | 1.589 | 61.25 | |
| *20) | 6.13135 | 4.665 | | | |

[Aspherical Surface Data]

| m | K | A4 | A6 | A8 | A10 |
|---|---|---|---|---|---|
| 19) | −9.3396 | 1.38E−03 | −6.73E−04 | 1.64E−05 | −9.36E−07 |
| 20) | −0.2775 | 7.44E−06 | −3.66E−04 | 6.94E−06 | 2.95E−07 |

[Focal Length Data of Groups]

| Groups | Starting surfaces | Focal lengths |
|---|---|---|
| GF | 1 | −7.39 |
| GR1 | 9 | 11.73 |

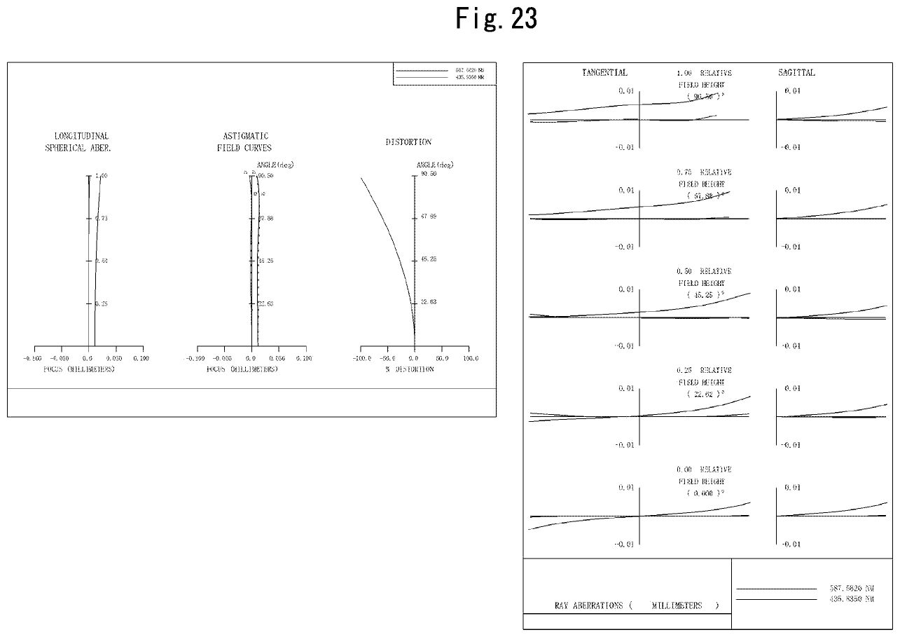

FIG. 23 shows aberrations of the first optical system OS1 included in the optical system 1 of Example 6.

The graphs of aberrations suggest that the first optical system OS1 of the present example corrects aberrations appropriately and has high optical performance.

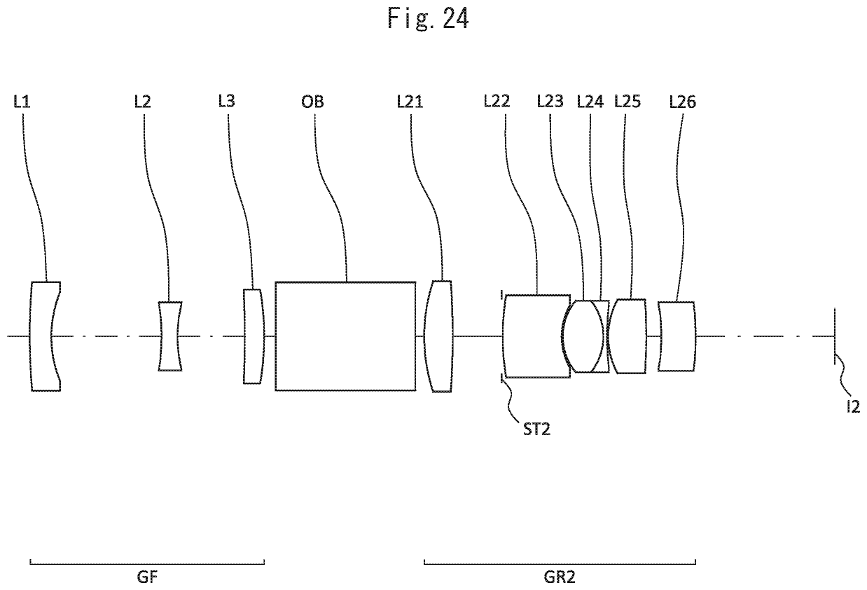

FIG. 24 is a cross-sectional view of a second optical system included in the optical system of Example 6.

The second optical system OS2 of the present example has, in order from the object side, a meniscus-shaped negative lens L1 convex on the object side, a biconcave negative lens L2, a meniscus-shaped positive lens L3 concave on the object side, an optical path splitter OB, a biconvex positive lens L21, an aperture stop ST2, a meniscus-shaped negative lens L22 convex on the object side, a positive cemented lens composed of a biconvex positive lens L23 and a biconcave negative lens L24, a biconvex positive lens L25, and a meniscus-shaped negative lens L26 concave on the object side.

An imaging element constructed from CCD or CMOS, or the like is disposed on the image plane 12.

In the second optical system OS2 of the present example, the negative lens L1, negative lens L2, and negative lens L3 are included in the front lens group GF.

In the second optical system OS2 of the present example, the positive lens L21, the aperture stop ST2, the negative lens L22, the positive cemented lens composed of the positive lens L23 and the negative lens L24, the positive lens L25, and the negative lens L26 are included in the second rear lens group GR2.

Table 6-2 below shows the specifications of the second optical system OS2 of the

TABLE 6-2
[General Specifications]

| | |
|---|---|
| fB | 6.59 |
| TLB | 75.00 |
| FnoB | 4.15 |
| YmaxB | 2.28 |
| ωB | 20.0° |

[Lens Specifications]

| m | r | d | n(d) | νd | |
|---|---|---|---|---|---|
| 1) | 55.24628 | 2.009 | 1.755 | 27.57 | |
| 2) | 9.61973 | 10.260 | | | |
| 3) | −17.84622 | 1.500 | 1.618 | 63.34 | |
| 4) | 11.21493 | 6.270 | | | |
| 5) | −71.15753 | 1.800 | 1.755 | 27.57 | |
| 6) | −22.22626 | 1.080 | | | |
| 7) | ∞ | 13.000 | 1.517 | 63.88 | (optical splitter OB) |
| 8) | ∞ | 0.830 | | | |
| 9) | 14.43212 | 2.650 | 1.658 | 50.83 | |
| 10) | −66.29208 | 4.560 | | | |
| 11> | ∞ | 0.100 | | | (aperture stop ST2) |
| 12) | 20.00592 | 5.500 | 1.744 | 44.80 | |
| 13) | 5.22811 | 0.100 | | | |
| 14) | 4.64067 | 3.780 | 1.487 | 70.32 | |
| 15) | −4.78843 | 0.350 | 1.750 | 35.25 | |
| 16) | 24.84195 | 0.100 | | | |
| 17) | 6.34924 | 3.540 | 1.487 | 70.32 | |
| 18) | −53.28985 | 1.400 | | | |
| *19) | −26.24408 | 3.200 | 1.553 | 71.68 | |
| *20) | −31.44606 | 12.970 | | | |

[Aspherical Surface Data]

| m | K | A4 | A6 | A8 | A10 |
|---|---|---|---|---|---|
| 19) | 9.4243 | −1.46E−03 | −5.94E−05 | 3.96E−06 | −5.04E−07 |
| 20) | −10.0000 | −7.02E−04 | 4.07E−06 | 5.37E−08 | −3.82E−10 |

[Focal Length Data of Groups]

| Groups | Starting surfaces | Focal lengths |
|---|---|---|
| GF | 1 | −7.39 |
| GR2 | 9 | 16.75 |

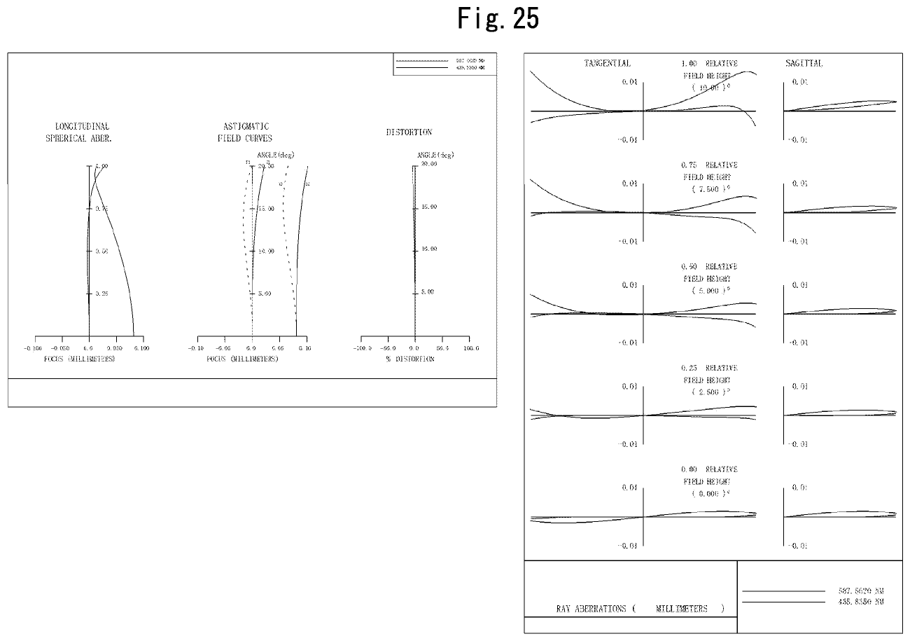

FIG. 25 shows aberrations of the second optical system OS2 included in the optical system 1 of Example 6.

The graphs of aberrations suggest that the second optical system OS2 of the present example corrects aberrations appropriately and has high optical performance.

### Example 7

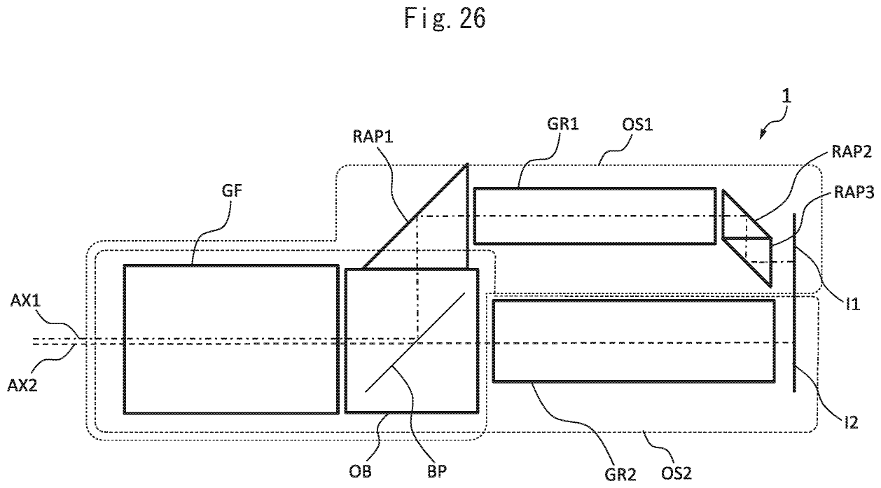

FIG. 26 schematically shows an overall configuration of the optical system of Example 7.

In the optical system 1 of Example 7, the first optical system OS1 has a total focal length longer than a total focal length of the second optical system OS2. That is, the first optical system OS1 corresponds to a telephoto optical system, and the second optical system OS2 corresponds to a wide-angle optical system.

In the present example, the image plane I1 of the first optical system OS1 and the image plane 12 of the second optical system OS2 are disposed on the same plane.

The first optical system OS1 of the present example has a first optical path deflector between the optical path splitter OB and the image plane I1 that deflects the optical path of light reflected by the splitting plane BPT to be parallel to the optical path of light transmitted through the splitting plane BP1.

In the present example, the first optical path deflector is implemented as a right-angle prism RAP1 having a reflecting plane that deflects incident light to be parallel to the optical path of light transmitted through the splitting plane BP1. The first optical path deflector may be implemented as a mirror having a reflecting plane that deflects incident light to be parallel to the optical path of light transmitted through the splitting plane BPT.

The first optical system OS1 of the present example has a second optical path deflector between the first optical path deflector the image plane that deflects the optical path of light reflected by the splitting plane BPT, which has been deflected by the first optical path deflector, so that the distance from the optical path of light transmitted through the splitting plane BP1 becomes shorter.

In the present example, the second optical path deflector is implemented as a right-angle prism RAP2 having a reflecting plane that emits incident light in a direction approaching the optical path of light transmitted through the splitting plane BP1, and a right-angle prism RAP3 that deflects incident light to be parallel to the optical path of light transmitted through the splitting plane BP1 and emits it toward the image plane I1. At least one of the right-angle prisms RAP2 and RAP3 may be implemented as a mirror.

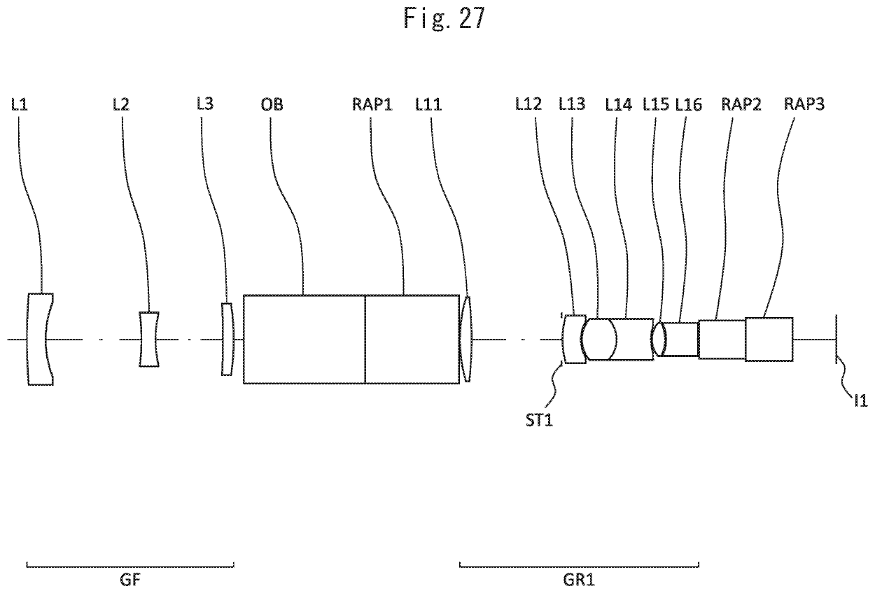

FIG. 27 is a cross-sectional view of a first optical system included in the optical system of Example 7.

The first optical system OS1 of the present example has, in order from the object side, a meniscus-shaped negative lens L1 convex on the object side, a biconcave negative lens L2, a meniscus-shaped positive lens L3 concave on the object side, an optical path splitter OB, a right-angle prism RAP1, a biconvex positive lens L ii, an aperture stop ST1, a meniscus-shaped negative lens L12 convex on the object side, a positive cemented lens composed of a biconvex positive lens L13 and a biconcave negative lens L14, a biconvex positive lens L15, a meniscus-shaped negative lens L16 concave on the object side, a right-angle prism RAP2, and a right-angle prism RAP3.

An imaging element constructed from a CCD or CMOS, or the like is disposed on the image plane I1.

In the first optical system OS1 of the present example, the negative lens L1, the negative lens L2, and the negative lens L3 are included in the front lens group GF.

In the first optical system OS1 of the present example, the positive lens L11, the aperture stop ST1, the negative lens L12, the positive cemented lens composed of the positive lens L13 and the negative lens L14, the positive lens L15, and the negative lens L16 are included in the first rear lens group GR1.

Table 7-1 below shows the specifications of the first optical system OS1 of the

TABLE 7-1
[General Specifications]

| | |
|---|---|
| fB | 6.55 |
| TLB | 83.09 |
| FnoB | 6.34 |
| YmaxB | 2.28 |
| ωB | 20.0° |

[Lens Specifications]

| m | r | d | n(d) | νd | |
|---|---|---|---|---|---|
| 1) | 55.24628 | 2.000 | 1.755 | 27.57 | |
| 2) | 9.61973 | 10.250 | | | |
| 3) | −17.84622 | 1.500 | 1.618 | 63.34 | |
| 4) | 11.21493 | 7.200 | | | |
| 5) | −71.15753 | 1.150 | 1.755 | 27.57 | |
| 6) | −22.22626 | 1.080 | | | |
| 7) | ∞ | 13.000 | 1.517 | 63.88 | (optical path splitter OB) |
| 8) | ∞ | 10.000 | 1.517 | 63.88 | (right-angle prism RAP1) |
| 9) | ∞ | 0.100 | | | |
| 10) | 13.67209 | 1.250 | 1.487 | 70.32 | |
| 11) | −36.76898 | 9.620 | | | |
| 12> | ∞ | 0.100 | | | (aperture stop ST1) |
| 13) | 7.88779 | 1.980 | 1.700 | 48.10 | |
| 14) | 3.58263 | 0.100 | | | |
| 15) | 2.98620 | 3.700 | 1.487 | 70.32 | |
| 16) | −2.83913 | 3.690 | 1.744 | 44.80 | |
| 17) | 4.49639 | 0.100 | | | |
| 18) | 2.48008 | 1.410 | 1.517 | 52.20 | |
| 19) | −3.50305 | 0.100 | | | |
| *20) | −3.69419 | 3.410 | 1.801 | 45.45 | |
| *21) | −101.19485 | 11.353 | | | |

[Aspherical Surface Data]

| m | K | A4 | A6 | A8 | A10 |
|---|---|---|---|---|---|
| 20) | 1.4129 | −1.82E−03 | −6.13E−04 | 1.07E−04 | 1.97E−05 |
| 21) | −10.0000 | 1.59E−03 | −1.76E−04 | 3.12E−04 | −3.67E−05 |

[Focal Length Data of Groups]

| Groups | Starting surfaces | Focal lengths |
|---|---|---|
| GF | 1 | −7.48 |
| GR1 | 10 | 15.40 |

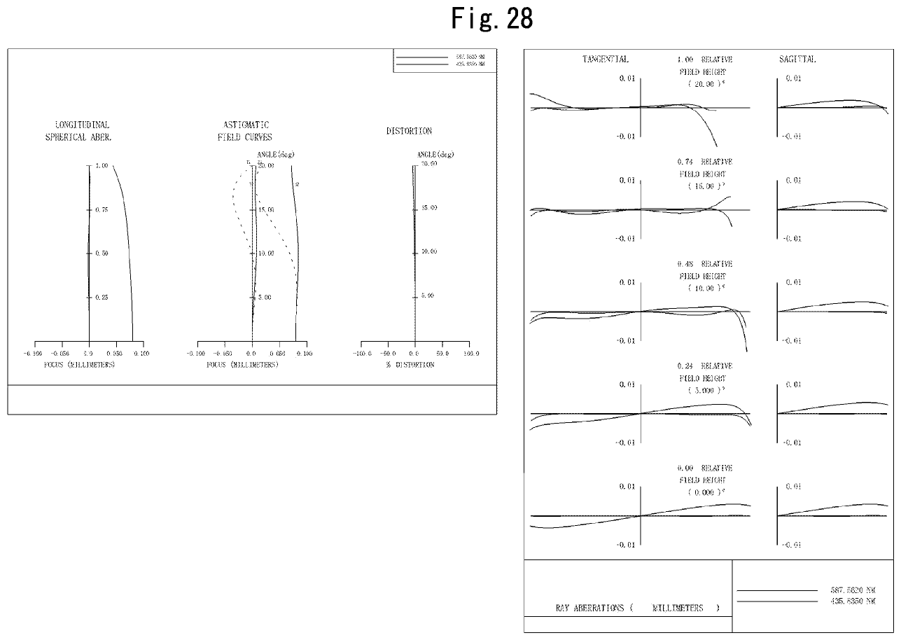

FIG. 28 shows aberrations of the first optical system OS1 included in the optical system 1 of Example 7.

The graphs of aberrations suggest that the first optical system OS1 of the present example corrects aberrations appropriately and has high optical performance.

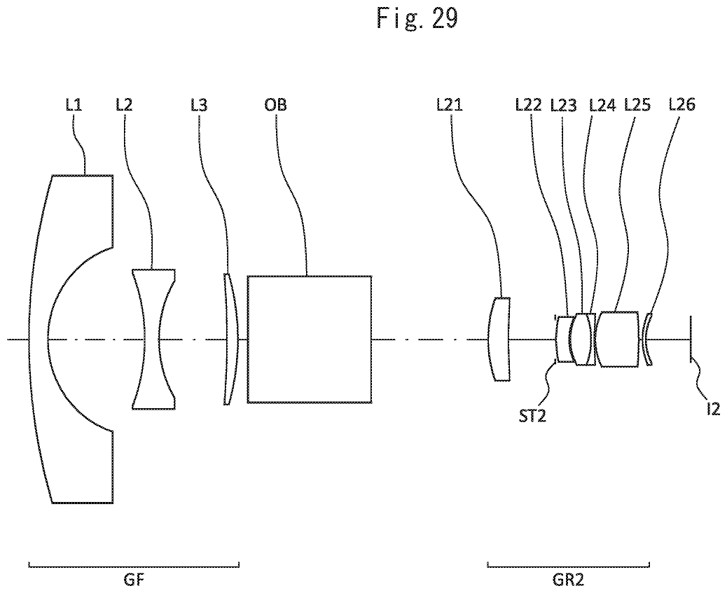

FIG. 29 is a cross-sectional view of a second optical system included in the optical system of Example 7.

The second optical system OS2 of the present example has, in order from the object side, a meniscus-shaped negative lens L1 convex on the object side, a biconcave negative lens L2, a meniscus-shaped positive lens L3 concave on the object side, an optical path splitter OB, a meniscus-shaped positive lens L21 convex on the object side, an aperture stop ST2, a meniscus-shaped negative lens L22 convex on the object side, a positive cemented lens composed of a biconvex positive lens L23 and a biconcave negative lens L24, a biconvex positive lens L25, and a meniscus-shaped negative lens L26 convex on the object side.

An imaging element constructed from CCD or CMOS, or the like is disposed on the image plane 12.

In the second optical system OS2 of the present example, the negative lens L1, negative lens L2, and negative lens L3 are included in the front lens group GF.

In the second optical system OS2 of the present example, the positive lens L21, the aperture stop ST1, the negative lens L22, the positive cemented lens composed of the positive lens L23 and the negative lens L24, the positive lens L25, and the negative lens L26 are included in the second rear lens group GR2.

Table 7-2 below shows the specifications of the second optical system OS2 of the

TABLE 7-2
[General Specifications]

| | |
|---|---|
| fA | 1.92 |
| TLA | 70.00 |
| FnoA | 2.50 |
| YmaxA | 2.28 |
| ωA | 90.0° |
| Wi | 0.10 |

[Lens Specifications]

| m | r | d | n(d) | νd | |
|---|---|---|---|---|---|
| 1) | 55.24628 | 2.000 | 1.755 | 27.57 | |
| 2) | 9.61973 | 10.250 | | | |
| 3) | −17.84622 | 1.500 | 1.618 | 63.34 | |
| 4) | 11.21493 | 7.200 | | | |
| 5) | −71.15753 | 1.150 | 1.755 | 27.57 | |
| 6) | −22.22626 | 1.080 | | | |
| 7) | ∞ | 13.000 | 1.517 | 63.88 | (optical splitter OB) |
| 8) | ∞ | 12.400 | | | |
| 9) | 11.78881 | 2.150 | 1.717 | 29.57 | |
| 10) | 64.32439 | 4.930 | | | |
| 11> | ∞ | 0.100 | | | (aperture stop ST2) |
| 12) | 10.16492 | 1.370 | 1.755 | 27.57 | |
| 13) | 4.67717 | 0.125 | | | |
| 14) | 5.03005 | 2.200 | 1.519 | 69.89 | |
| 15) | −6.87158 | 0.350 | 1.755 | 27.57 | |
| 16) | 27.60947 | 0.100 | | | |
| 17) | 5.84371 | 4.590 | 1.620 | 60.24 | |
| 18) | −28.71086 | 0.400 | | | |
| *19) | 5.57062 | 0.350 | 1.620 | 60.24 | |
| *20) | 4.72991 | 4.755 | | | |

[Aspherical Surface Data]

| m | K | A4 | A6 | A8 | A10 |
|---|---|---|---|---|---|
| 19) | −0.5510 | −7.61E−04 | −1.43E−04 | 1.23E−05 | −3.04E−07 |
| 20) | −0.1419 | −1.46E−04 | −1.09E−04 | 1.55E−05 | 7.86E−07 |

[Focal Length Data of Groups]

| Groups | Starting surfaces | Focal lengths |
|---|---|---|
| GF | 1 | −7.48 |
| GR2 | 9 | 10.99 |

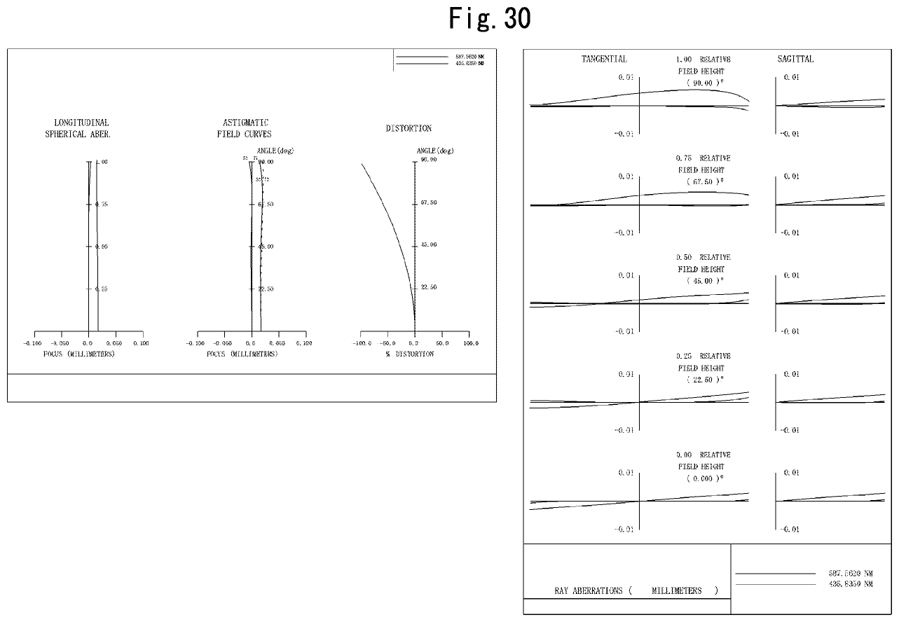

FIG. 30 shows aberrations of the second optical system OS2 included in the optical system 1 of Example 7.

The graphs of aberrations suggest that the second optical system OS2 of the present example corrects aberrations appropriately and has high optical performance.

### Example 8

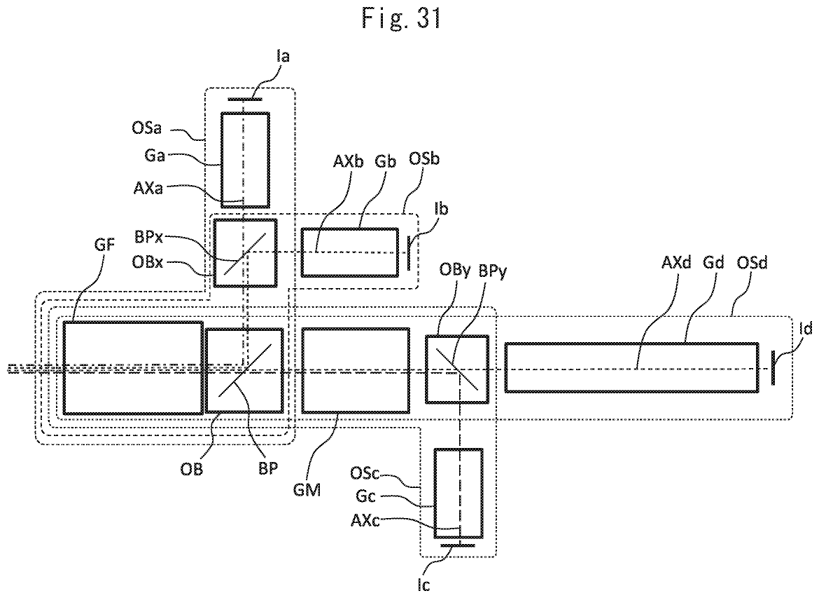

FIG. 31 schematically shows an overall configuration of the optical system of Example 8.

Light incident on the front lens group GF in the present example is split by the splitting plane BP1 of the optical path splitter OB into reflected light and transmitted light.

Light reflected by the splitting plane BPT enters an optical path splitter OBx having a splitting plane BPx that transmits a first portion of the incident light and reflects at least a second portion of the incident light different from the first portion, and is further split by the splitting plane BPx into reflected light and transmitted light. The optical path splitter OBx is a cube-type beam splitter (prism) having the splitting plane BPx. The optical path splitter OBx may be a plate-type beam splitter (half mirror) having the splitting plane BPx.

Light transmitted through the splitting plane BPx (optical axis AXa) enters the lens group Ga and forms an image on the image plane Ia. Light reflected by the splitting plane BPx (optical axis AXb) enters the lens group Gb and forms an image on the image plane Ib.

Light transmitted through the splitting surface BP1 passes through the intermediate lens group GM and enters an optical path splitter OBy having a splitting plane BPy that transmits a first portion of the incident light and reflects at least a second portion of the incident light different from the first portion, and is further split by the splitting plane BPy into reflected light and transmitted light. The optical path splitter OBy is a cube-type beam splitter (prism) having the splitting plane BPy. The optical path splitter OBy may be a plate-type beam splitter (half mirror) having the splitting plane BPy.

Light reflected by the splitting plane BPy (optical axis AXc) enters the lens group Gc and forms an image on the image plane Ic. Light transmitted through the splitting plane BPy (optical axis AXd) enters the lens group Gd and forms an image on the image plane Id.

In the optical system of Example 8, the first rear lens group GR1 into which the first light (optical axes AXa, AXb), which is at least a portion of the light reflected by the splitting plane BP, enters includes the optical path splitter OBx, the lens group Ga, and the lens group Gb. The optical path splitter OBx is an example of a second optical path splitter having a second splitting plane that reflects a first portion of the incident light and transmits at least a second portion of the incident light different from the first portion. The lens group Gb is an example of a third rear lens group into which at least a portion (optical axis AXb) of the light reflected by the second splitting plane enters. The lens group Ga is an example of a fourth rear lens group into which at least a portion (optical axis AXa) of the light transmitted through the second splitting plane enters.

In the optical system of Example 8, the second rear lens group GR2 into which the second light (optical axes AXc, AXd), which is at least a portion of the light transmitted through the splitting plane BP, enters includes the intermediate lens group GM, the optical path splitter OBy, the lens group Gc, and the lens group Gd. The optical path splitter OBy is another example of a second optical path splitter having a second splitting plane that reflects a first portion of the incident light and transmits at least a second portion of the incident light different from the first portion. The lens group Gc is another example of a third rear lens group into which at least a portion (optical axis AXc) of the light reflected by the second splitting plane enters. The lens group Gd is another example of a fourth rear lens group into which at least a portion (optical axis AXd) of the light transmitted through the second splitting plane enters.

An optical system having an optical system OSa including the front lens group GF, the optical path splitter OB, the optical path splitter OBx, and the lens group Ga as the first optical system OS1, and having an optical system OSd including the front lens group GF, the optical path splitter OB, the intermediate lens group GM, the optical path splitter OBy, and the lens group Gd as the second optical system OS2, is referred to as the optical system of Example 8-1. In the optical system of Example 8-1, the lens group Ga corresponds to the first rear lens group GR1, and the intermediate lens group GM, the optical path splitting member OBy, and the lens group Gd correspond to the second rear lens group GR2. In the optical system of Example 8-1, the second optical system OS2 has a total focal length longer than that of the first optical system OS1. That is, the first optical system OS1 corresponds to a wide-angle optical system, and the second optical system OS2 corresponds to a telephoto optical system.

An optical system having an optical system OSb including the front lens group GF, the optical path splitter OB, the optical path splitter OBx, and the lens group Gb as the first optical system OS1, and having an optical system OSc including the front lens group GF, the optical path splitter OB, the intermediate lens group GM, the optical path splitter OBy, and the lens group Gc as the second optical system OS2, is referred to as the optical system of Example 8-2. In the optical system of Example 8-2, the lens group Gb corresponds to the first rear lens group GR1, and the intermediate lens group GM, the optical path splitter OBy, and the lens group Gc correspond to the second rear lens group GR2. In the optical system of Example 8-2, the second optical system OS2 has a total focal length longer than that of the first optical system OS1. That is, the first optical system OS1 corresponds to a wide-angle side optical system, and the second optical system OS2 corresponds to a telephoto side optical system.

### Example 8-1

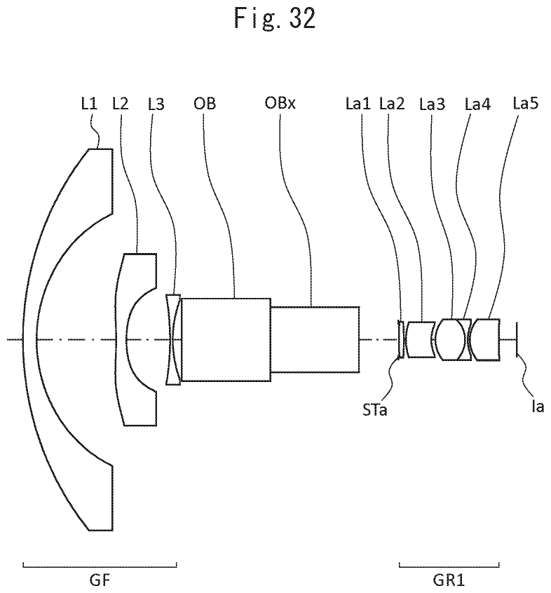

FIG. 32 is a cross-sectional view of a first optical system included in the optical system of Example 8-1.

The first optical system OS1 of the present example has, in order from the object side, a meniscus-shaped negative lens L1 convex on the object side, a biconcave negative lens L2, a biconcave negative lens L3, an optical path splitter OB, an optical path splitter OBx, an aperture stop STa, a biconvex positive lens La1, a meniscus-shaped negative lens La2 convex on the object side, a positive cemented lens composed of a biconvex positive lens La3 and a biconcave negative lens La4, and a biconvex positive lens La5.

A first imaging element (not shown) constructed from a CCD or CMOS, or the like is disposed on the image plane Ia.

In the first optical system OS1 of the present example, the negative lens L1, the negative lens L2, and the negative lens L3 are included in the front lens group GF.

In the first optical system OS1 of the present example, the positive lens La1, the negative lens La2, the positive cemented lens composed of the positive lens La3 and the negative lens La4, and the positive lens La5 are included in the first rear lens group GR1.

Table 8-1-1 below shows the specifications of the first optical system OS1 of the

TABLE 8-1-1
[General Specifications]

| | |
|---|---|
| fA | 1.49 |
| TLA | 72.51 |
| FnoA | 2.55 |
| YmaxA | 2.29 |
| ωA | 91.0° |
| Wi | 0.20 |

[Lens Specifications]

| m | r | d | n(d) | νd | |
|---|---|---|---|---|---|
| 1) | 39.16597 | 2.000 | 1.773 | 49.62 | |
| 2) | 18.66022 | 11.700 | | | |
| *3) | −38.70105 | 1.500 | 1.694 | 53.20 | |
| *4) | 13.43728 | 6.400 | | | |
| 5) | −32.89788 | 0.400 | 1.593 | 67.90 | |
| 6) | 14.35387 | 1.350 | | | |
| 7) | ∞ | 13.000 | 1.569 | 56.00 | (optical path splitter OB) |
| 8) | ∞ | 0.000 | | | |
| 9) | ∞ | 13.000 | 1.569 | 56.00 | (optical path splitter OBx) |
| 10) | ∞ | 5.772 | | | |
| 11> | ∞ | 0.100 | | | (aperture stop ST1) |
| 12) | 44.44798 | 0.720 | 1.744 | 44.80 | |
| 13) | −32.08087 | 0.300 | | | |
| 14) | 6.77592 | 3.730 | 1.755 | 27.57 | |
| 15) | 4.60673 | 0.600 | | | |
| 16) | 3.92339 | 4.350 | 1.519 | 69.89 | |
| 17) | −3.61688 | 0.400 | 1.755 | 27.57 | |
| 18) | 5.04451 | 0.300 | | | |
| *19) | 3.69377 | 4.290 | 1.694 | 53.20 | |
| *20) | −22.98903 | 2.600 | | | |

[Aspherical Surface Data]

| m | K | A4 | A6 | A8 | A10 |
|---|---|---|---|---|---|
| 3) | 5.7420 | 3.95E−04 | −2.07E−06 | 2.93E−09 | 5.51E−12 |
| 4) | 0.2784 | 6.62E−04 | −4.55E−06 | 3.07E−07 | −1.97E−09 |
| 19) | −0.2736 | −9.10E−04 | 7.22E−06 | −4.67E−06 | 2.19E−07 |
| 20) | 4.5259 | 3.65E−03 | 6.68E−04 | −7.89E−05 | 1.06E−05 |

[Focal Length Data of Groups]

| Groups | Starting surfaces | Focal lengths |
|---|---|---|
| GF | 1 | −4.45 |
| GR1 | 12 | 9.01 |

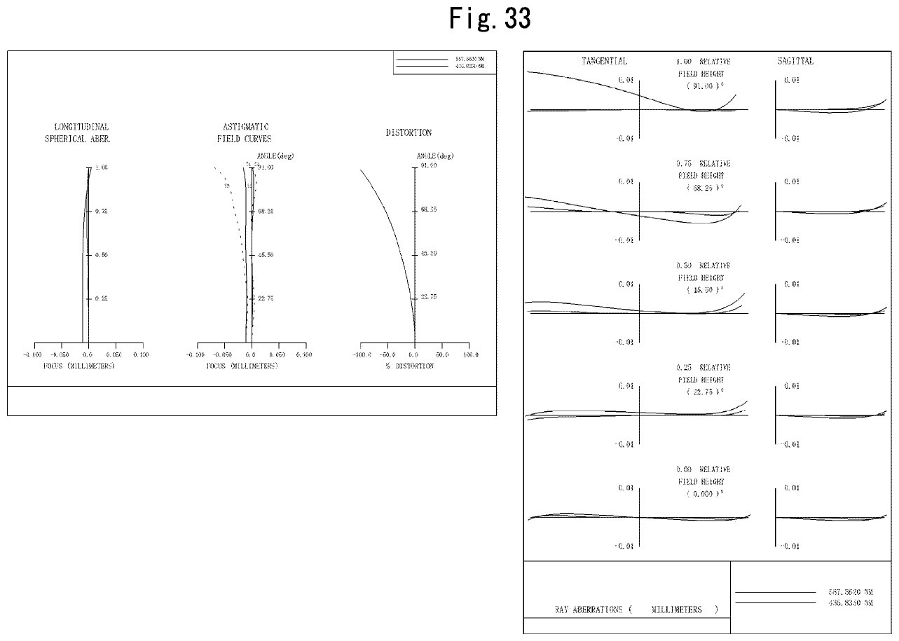

FIG. 33 shows aberrations of the first optical system OS1 included in the optical system 1 of Example 8-1.

The graphs of aberrations suggest that the first optical system OS1 of the present example corrects aberrations appropriately and has high optical performance.

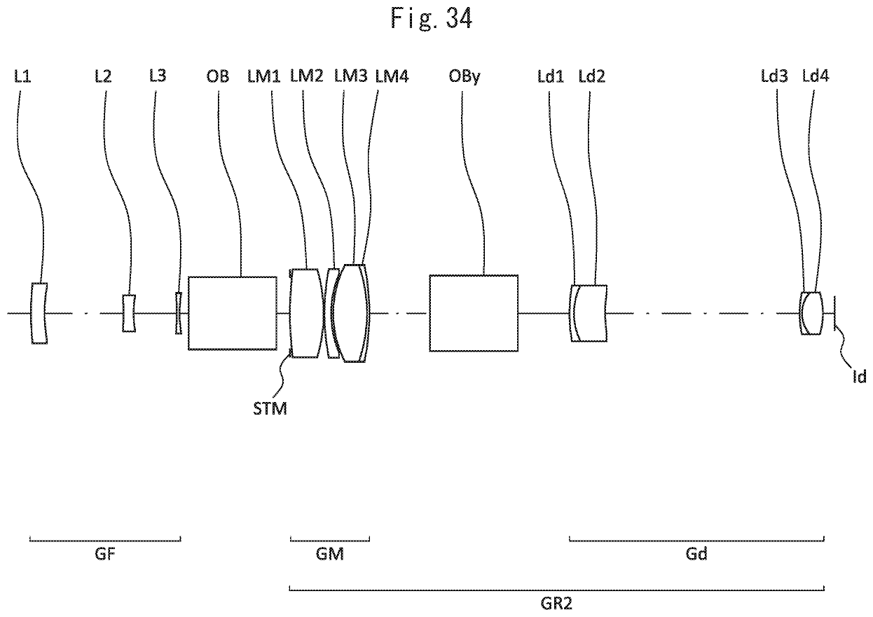

FIG. 34 is a cross-sectional view of a second optical system included in the optical system of Example 8-1.

The second optical system OS2 of the present example has, in order from the object side, a meniscus-shaped negative lens L1 convex on the object side, a biconcave negative lens L2, a biconcave negative lens L3, an optical path splitter OB, an aperture stop STM, a biconvex positive lens LM1, a meniscus-shaped negative lens LM2 convex on the object side, a positive cemented lens composed of a biconvex positive lens LM3 and a meniscus-shaped negative lens LM4 concave on the object side, an optical path splitter OBy, a negative cemented lens composed of a meniscus-shaped negative lens Ld1 convex on the object side and a meniscus-shaped positive lens Ld2 convex on the object side, and a positive cemented lens composed of a meniscus-shaped negative lens Ld3 convex on the object side and a biconvex positive lens Ld4.

An imaging element constructed from CCD or CMOS, or the like is disposed on the image plane Id.

In the second optical system OS2 of the present example, the negative lens L1, negative lens L2, and negative lens L3 are included in the front lens group GF.

In the second optical system OS2 of the present example, the positive lens LM1, the negative lens LM2, the positive cemented lens composed of the positive lens LM3 and the negative lens LM4, the optical path splitter OBy, the negative cemented lens composed of the negative lens Ld1 and the positive lens Ld2, and the positive cemented lens composed of the negative lens Ld3 and the positive lens Ld4 are included in the second rear lens group GR2.

Table 8-1-2 below shows the specifications of the second optical system OS2 of the

TABLE 8-1-2
[General Specifications]

| | |
|---|---|
| fB | 12.98 |
| TLB | 119.03 |
| FnoB | 6.24 |
| YmaxB | 2.26 |
| ωB | 10.0° |

[Lens Specifications]

| m | r | d | n(d) | νd | |
|---|---|---|---|---|---|
| 1) | 39.16597 | 2.000 | 1.773 | 49.62 | |
| 2) | 18.66022 | 11.700 | | | |
| *3) | −38.70105 | 1.500 | 1.694 | 53.20 | |
| *4) | 13.43728 | 6.400 | | | |
| 5) | −32.89788 | 0.400 | 1.593 | 67.90 | |
| 6) | 14.35387 | 1.350 | | | |
| 7) | ∞ | 13.000 | 1.569 | 56.00 | (optical splitter OB) |
| 8) | ∞ | 2.000 | | | |
| 9> | ∞ | 0.000 | | | (aperture stop STM) |
| 10) | 41.72564 | 5.000 | 1.603 | 60.69 | |
| 11) | −19.13995 | 0.120 | | | |
| 12) | 28.95936 | 1.000 | 1.744 | 44.80 | |
| 13) | 12.91167 | 0.300 | | | |
| 14) | 13.46515 | 5.000 | 1.498 | 82.57 | |
| 15) | −18.53975 | 0.350 | 1.744 | 44.80 | |
| 16) | −29.76038 | 8.990 | | | |
| 17) | ∞ | 13.000 | 1.569 | 56.00 | (optical splitter OBy) |
| 18) | ∞ | 7.665 | | | |
| 19) | 20.30377 | 0.666 | 1.700 | 48.10 | |
| 20) | 8.14493 | 4.634 | 1.518 | 58.82 | |
| 21) | 21.41908 | 28.790 | | | |
| 22) | 12.24203 | 0.350 | 1.755 | 27.57 | |
| 23) | 4.03397 | 3.110 | 1.498 | 82.57 | |
| 24) | −8.72384 | 1.708 | | | |

[Aspherical Surface Data]

| m | K | A4 | A6 | A8 | A10 |
|---|---|---|---|---|---|
| 3) | 5.7420 | 3.95E−04 | 2.07E−06 | 2.93E−09 | 5.51E−12 |
| 4) | 0.2784 | 6.62E−04 | −4.55E−06 | 3.07E−07 | −1.97E−09 |

[Focal Length Data of Groups]

| Groups | Starting surfaces | Focal lengths |
|---|---|---|
| GF | 1 | −4.45 |
| GR2 | 10 | −10.02 |

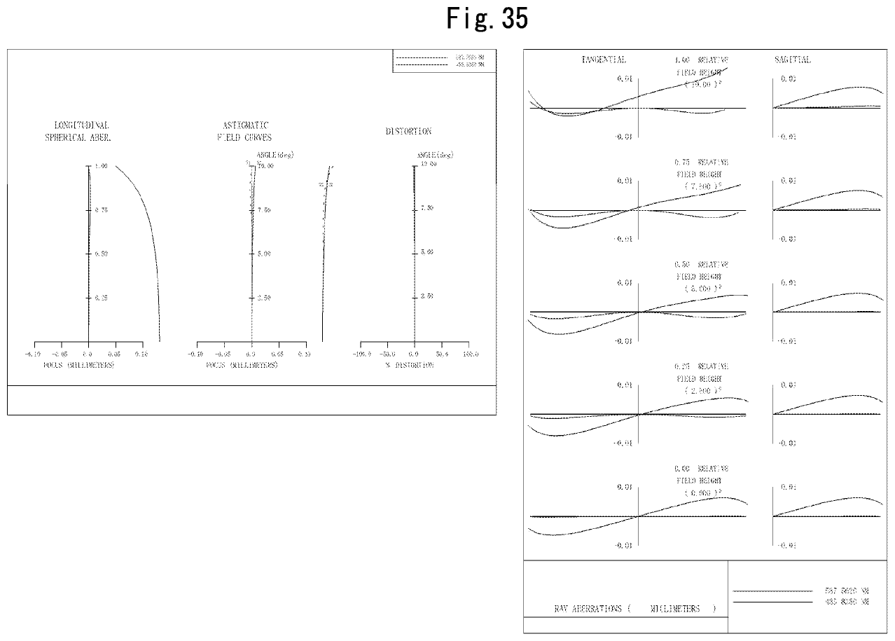

FIG. 35 shows aberrations of the second optical system OS2 included in the optical system 1 of Example 8-1.

The graphs of aberrations suggest that the second optical system OS2 of the present example corrects aberrations appropriately and has high optical performance.

### Example 8-2

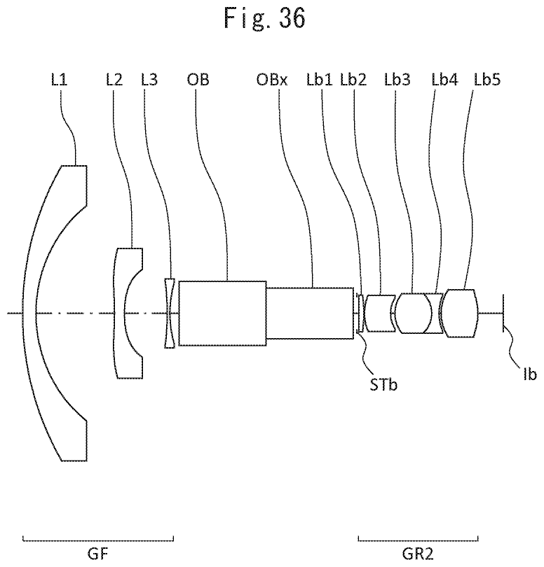

FIG. 36 is a cross-sectional view of a first optical system included in the optical system of Example 8-2.

The first optical system OS1 of the present example includes, in order from the object side, a meniscus-shaped negative lens L1 convex on the object side, a biconcave negative lens L2, a biconcave negative lens L3, an optical path splitter OB, an optical path splitter OBx, an aperture stop STb, a meniscus-shaped positive lens Lb1 concave on the object side, a meniscus-shaped negative lens Lb2 convex on the object side, a positive cemented lens composed of a biconvex positive lens Lb3 and a biconcave negative lens Lb4, and a biconvex positive lens Lb5.

A first imaging element (not shown) constructed from a CCD or CMOS, or the like is disposed on the image plane Ib.

In the first optical system OS1 of the present example, the negative lens L1, the negative lens L2, and the negative lens L3 are included in the front lens group GF.

In the first optical system OS1 of the present example, the positive lens Lb1, the negative lens Lb2, the positive cemented lens composed of the positive lens Lb3 and the negative lens Lb4, and the positive lens Lb5 are included in the first rear lens group GR1.

Table 8-2-1 below shows the specifications of the first optical system OS1 of the

TABLE 8-2-1
[General Specifications]

| | |
|---|---|
| fA | 2.09 |
| TLA | 71.81 |
| FnoA | 2.86 |
| YmaxA | 2.56 |
| ωA | 70.0° |
| Wi | 0.20 |

[Lens Specifications]

| m | r | d | n(d) | νd | |
|---|---|---|---|---|---|
| 1) | 39.16597 | 2.000 | 1.773 | 49.62 | |
| 2) | 18.66022 | 11.700 | | | |
| *3) | −38.70105 | 1.500 | 1.694 | 53.20 | |
| *4) | 13.43728 | 6.400 | | | |
| 5) | −32.89788 | 0.400 | 1.593 | 67.90 | |
| 6) | 14.35387 | 1.350 | | | |
| 7) | ∞ | 13.000 | 1.569 | 56.00 | (optical path splitter OB) |
| 8) | ∞ | 0.000 | | | |
| 9) | ∞ | 13.000 | 1.569 | 56.00 | (optical path splitter OBx) |
| 10) | ∞ | 0.570 | | | |
| 11> | ∞ | 0.300 | | | (aperture stop STb) |
| 12) | −584.04520 | 0.730 | 1.744 | 44.80 | |
| 13) | −17.93216 | 0.100 | | | |
| 14) | 6.09856 | 3.885 | 1.755 | 27.57 | |
| 15) | 3.68968 | 0.650 | | | |
| 16) | 4.10048 | 5.500 | 1.519 | 69.89 | |
| 17) | −3.59835 | 1.100 | 1.755 | 27.57 | |
| 18) | 6.16444 | 0.300 | | | |
| *19) | 5.60057 | 5.500 | 1.694 | 53.20 | |
| *20) | −6.43550 | 3.824 | | | |

[Aspherical Surface Data]

| m | K | A4 | A6 | A8 | A10 |
|---|---|---|---|---|---|
| 3) | 5.7420 | 3.95E−04 | −2.07E−06 | 2.93E−09 | 5.51E−12 |
| 4) | 0.2784 | 6.62E−04 | −4.55E−06 | 3.07E−07 | −1.97E−09 |
| 19) | −0.2252 | −1.17E−04 | 7.10E−05 | −3.93E−06 | 3.88E−08 |
| 20) | −2.8412 | −1.16E−04 | 1.71E−04 | −1.51E−05 | 1.11E−06 |

[Focal Length Data of Groups]

| Groups | Starting surfaces | Focal lengths |
|---|---|---|
| GF | 1 | −4.45 |
| GR1 | 12 | 13.33 |

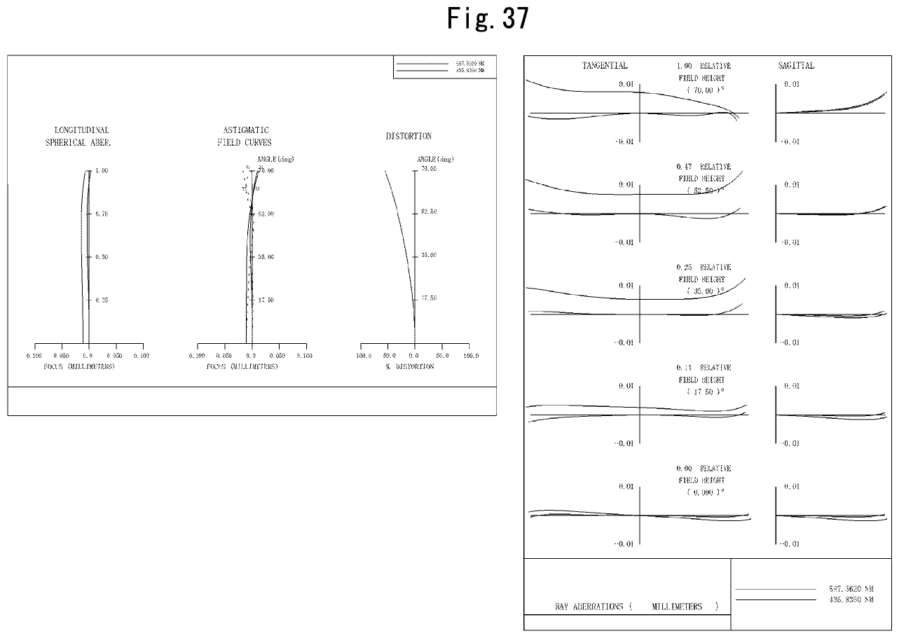

FIG. 37 shows aberrations of the first optical system OS1 included in the optical system 1 of Example 8-2.

The graphs of aberrations suggest that the first optical system OS1 of the present example corrects aberrations appropriately and has high optical performance.

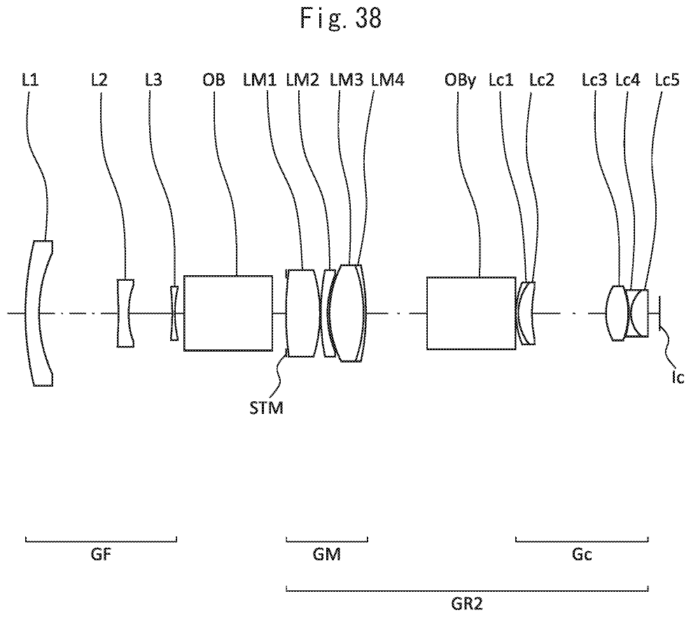

FIG. 38 is a cross-sectional view of a second optical system included in the optical system of Example 8-2.

The second optical system OS2 of the present example has, in order from the object side, a meniscus-shaped negative lens L1 convex on the object side, a biconcave negative lens L2, a biconcave negative lens L3, an optical path splitter OB, an aperture stop STM, a biconvex positive lens LM1, a meniscus-shaped negative lens LM2 convex on the object side, a positive cemented lens composed of a biconvex positive lens LM3 and a meniscus-shaped negative lens LM3 concave on the object side, an optical path splitter OBy, a positive cemented lens composed of a meniscus-shaped negative lens Lc1 convex on the object side and a meniscus-shaped positive lens Lc2 convex on the object side, a biconvex positive lens Lc3, and a negative cemented lens composed of a biconcave negative lens Lc4 and a biconvex positive lens Lc5.

An imaging element constructed from CCD or CMOS, or the like is disposed on the image plane Ic.

In the second optical system OS2 of the present example, the negative lens L1, negative lens L2, and negative lens L3 are included in the front lens group GF.

In the second optical system OS2 of the present example, the positive lens LM1, the negative lens LM2, the positive cemented lens composed of the positive lens LM3 and the negative lens LM4, the optical path splitter OBy, the positive cemented lens composed of the negative lens Lc1 and the positive lens Lc2, the positive lens Lc3, and the negative cemented lens composed of the negative lens Lc4 and the positive lens Lc5 are included in the second rear lens group GR2.

Table 8-2-2 below shows the specifications of the second optical system OS2 of the

TABLE 8-2-2
[General Specifications]

| | |
|---|---|
| fB | 4.44 |
| TLB | 93.35 |
| FnoB | 2.13 |
| YmaxB | 2.26 |
| ωB | 30.0° |

[Lens Specifications]

| m | r | d | n(d) | νd | |
|---|---|---|---|---|---|
| 1) | 39.16597 | 2.000 | 1.773 | 49.62 | |
| 2) | 18.66022 | 11.700 | | | |
| *3) | −38.70105 | 1.500 | 1.694 | 53.20 | |
| *4) | 13.43728 | 6.400 | | | |
| 5) | −32.89788 | 0.400 | 1.593 | 67.90 | |
| 6) | 14.35387 | 1.350 | | | |
| 7) | ∞ | 13.000 | 1.569 | 56.00 | (optical splitter OB) |
| 8) | ∞ | 2.000 | | | |
| 9> | ∞ | 0.000 | | | (aperture stop STM) |
| 10) | 41.72564 | 5.000 | 1.603 | 60.69 | |
| 11) | −19.13995 | 0.120 | | | |
| 12) | 28.95936 | 1.000 | 1.744 | 44.80 | |
| 13) | 12.91167 | 0.300 | | | |
| 14) | 13.46515 | 5.000 | 1.498 | 82.57 | |
| 15) | −18.53975 | 0.350 | 1.744 | 44.80 | |
| 16) | −29.76038 | 8.990 | | | |
| 17) | ∞ | 13.000 | 1.569 | 56.00 | (optical splitter OBy) |
| 18) | ∞ | 0.100 | | | |
| 19) | 10.30493 | 0.350 | 1.744 | 44.80 | |
| 20) | 6.39955 | 2.000 | 1.603 | 60.69 | |
| 21) | 16.50553 | 10.890 | | | |
| 22) | 7.20048 | 3.280 | 1.603 | 65.44 | |
| 23) | −9.50515 | 0.100 | | | |
| 24) | −9.57283 | 0.300 | 1.755 | 27.57 | |
| 25) | 4.00000 | 2.500 | 1.589 | 61.25 | |
| *26) | −556.35436 | 1.724 | | | |

[Aspherical Surface Data]

| m | K | A4 | A6 | A8 | A10 |
|---|---|---|---|---|---|
| 3) | 5.7420 | 3.95E−04 | −2.07E−06 | 2.93E−09 | 5.51E−12 |
| 4) | 0.2784 | 6.62E−04 | −4.55E−06 | 3.07E−07 | −1.97E−09 |
| 26) | −4.5724 | −9.34E−04 | 1.47E−04 | 6.10E−07 | 0.00E+00 |

[Focal Length Data of Groups]

| Groups | Starting surfaces | Focal lengths |
|---|---|---|
| GF | 1 | −4.45 |
| GR2 | 10 | 38.19 |

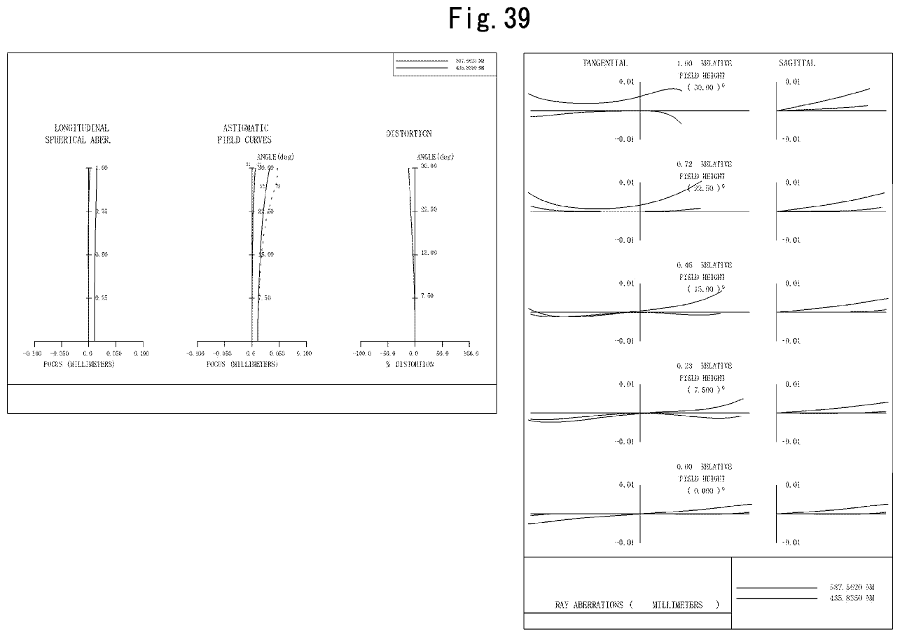

FIG. 39 shows aberrations of the second optical system OS2 included in the optical system 1 of Example 8-2.

The graphs of aberrations suggest that the second optical system OS2 of the present example corrects aberrations appropriately and has high optical performance.

### Example 9

The optical system of the present example has an overall configuration similar to the overall configuration of the optical system of Example 8 shown in FIG. 31.

An optical system having an optical system OSa including the front lens group GF, the optical path splitter OB, the optical path splitter OBx, and the lens group Ga as a first optical system OS1, and having an optical system OSd including the front lens group GF, the optical path splitter OB, the intermediate lens group GM, the optical path splitter OBy, and the lens group Gd as a second optical system OS2, is referred to as the optical system of Example 9-1. In the optical system of Example 9-1, the lens group Ga corresponds to the first rear lens group GR1, and the intermediate lens group GM, the optical path splitter OBy, and the lens group Gd correspond to the second rear lens group GR2. In the optical system of Example 9-1, the second optical system OS2 has a total focal length longer than the total focal length of the first optical system OS1. That is, the first optical system OS1 corresponds to a wide-angle optical system, and the second optical system OS2 corresponds to a telephoto optical system.

An optical system having an optical system OSb including the front lens group GF, the optical path splitter OB, the optical path splitter OBx, and the lens group Gb as a first optical system OS1, and having an optical system OSc including the front lens group GF, the optical path splitter OB, the intermediate lens group GM, the optical path splitter OBy, and the lens group Gc as a second optical system OS2, is referred to as the optical system of Example 9-2. In the optical system of Example 9-2, the lens group Gb corresponds to the first rear lens group GR1, and the intermediate lens group GM, the optical path splitting member OBy, and the lens group Gc correspond to the second rear lens group GR2. In the optical system of the 9-2 example, the second optical system OS2 has a total focal length longer than the total focal length of the first optical system OS1. That is, the first optical system OS1 corresponds to a wide-angle optical system, and the second optical system OS2 corresponds to a telephoto optical system.

The front lens group GF, optical path splitter OB, optical path splitter OBx, lens group Ga, and lens group Gb of the present example are the same as the front lens group GF, optical path splitter OB, optical path splitter OBx, lens group Ga, and lens group Gb of Example 8. That is, the first optical system OS1 of Example 9-1 and the first optical system OS1 of Example 9-2 are the same as the first optical system OS1 of Example 8-1 and the first optical system OS1 of Example 8-2, respectively. Therefore, descriptions of the configurations and aberration diagrams for these optical systems are omitted.

### Example 9-1

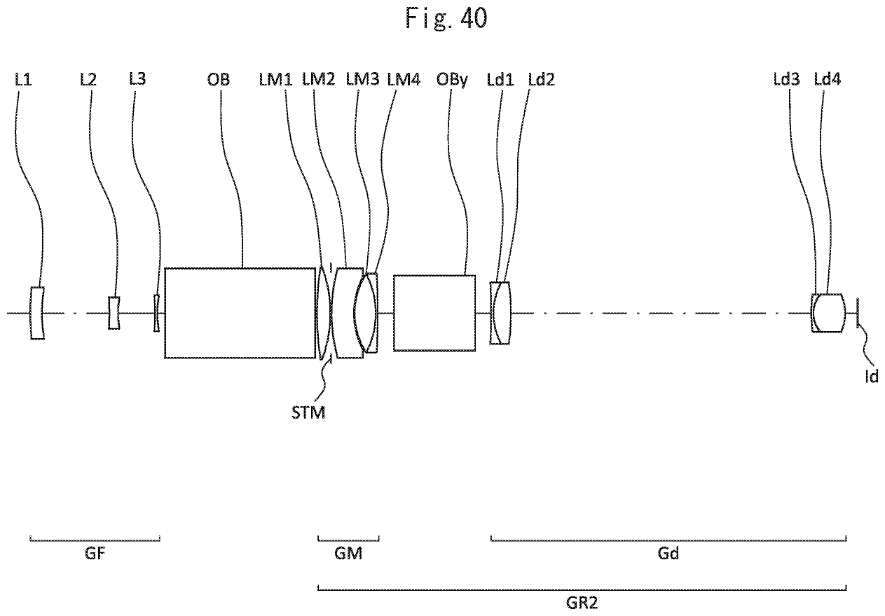

FIG. 40 is a cross-sectional view of a second optical system included in the optical system of Example 9-1.

The second optical system OS2 of the present example has, in order from the object side, a meniscus-shaped negative lens L1 convex on the object side, a biconcave negative lens L2, a biconcave negative lens L3, an optical path splitter OB, a biconvex positive lens LM1, an aperture stop STM, a meniscus-shaped negative lens LM2 convex on the object side, a positive cemented lens composed of a biconvex positive lens LM3 and a meniscus-shaped negative lens LM4 concave on the object side, an optical path splitter OBy, a negative cemented lens composed of a biconcave negative lens Ld1 and a biconvex positive lens Ld2, and a positive cemented lens composed of a meniscus-shaped negative lens Ld3 convex on the object side and a biconvex positive lens Ld4.

An imaging element constructed from CCD or CMOS, or the like is disposed on the image plane Id.

In the second optical system OS2 of the present example, the negative lens L1, negative lens L2, and negative lens L3 are included in the front lens group GF.

In the second optical system OS2 of the present example, the positive lens LM1, the aperture stop STM, the negative lens LM2, the positive cemented lens composed of the positive lens LM3 and the negative lens LM4, the optical path splitter OBy, the negative cemented lens composed of the negative lens Ld1 and the positive lens Ld2, and the positive cemented lens composed of the negative lens Ld3 and the positive lens Ld4 are included in the second rear lens group GR2.

Table 9-1-2 below shows the specifications of the second optical system OS2 of the

TABLE 9-1-2
[General Specifications]

| | |
|---|---|
| fB | 13.15 |
| TLB | 143.34 |
| FnoB | 6.34 |
| YmaxB | 2.26 |
| ωB | 10.0° |

[Lens Specifications]

| m | r | d | n(d) | νd | |
|---|---|---|---|---|---|
| 1) | 39.16597 | 2.000 | 1.773 | 49.62 | |
| 2) | 18.66022 | 11.700 | | | |
| *3) | −38.70105 | 1.500 | 1.694 | 53.20 | |
| *4) | 13.43728 | 6.400 | | | |
| 5) | −32.89788 | 0.400 | 1.593 | 67.90 | |
| 6) | 14.35387 | 1.350 | | | |
| 7) | ∞ | 26.000 | 1.569 | 56.00 | (optical splitter OB) |
| 8) | ∞ | 0.300 | | | |
| 9) | 42.94581 | 2.330 | 1.603 | 60.69 | |
| 10) | −19.44804 | 0.100 | | | |
| 11> | ∞ | 0.100 | | | (aperture stop STM) |
| 12) | 24.51982 | 3.900 | 1.744 | 44.80 | |
| 13) | 11.82353 | 0.100 | | | |
| 14) | 10.94909 | 3.660 | 1.498 | 82.57 | |
| 15) | −12.75472 | 0.350 | 1.744 | 44.80 | |
| 16) | −96.09217 | 2.830 | | | |
| 17) | ∞ | 14.000 | 1.569 | 56.00 | (optical splitter OBy) |
| 18) | ∞ | 2.820 | | | |
| 19) | −83.25237 | 0.400 | 1.744 | 44.80 | |
| 20) | 9.82815 | 3.000 | 1.620 | 36.40 | |
| 21) | −33.60000 | 52.050 | | | |
| 22) | 18.65139 | 0.350 | 1.755 | 27.57 | |
| 23) | 4.22340 | 5.500 | 1.498 | 82.57 | |
| 24) | −6.86700 | 2.204 | | | |

[Aspherical Surface Data]

| m | K | A4 | A6 | A8 | A10 |
|---|---|---|---|---|---|
| 3) | 5.7420 | 3.95E−04 | 2.07E−06 | 2.93E−09 | 5.51E−12 |
| 4) | 0.2784 | 6.62E−04 | 4.55E−06 | 3.07E−07 | −1.97E−09 |

[Focal Length Data of Groups]

| Groups | Starting surfaces | Focal lengths |
|---|---|---|
| GF | 1 | −4.45 |
| GR2 | 9 | −7.91 |

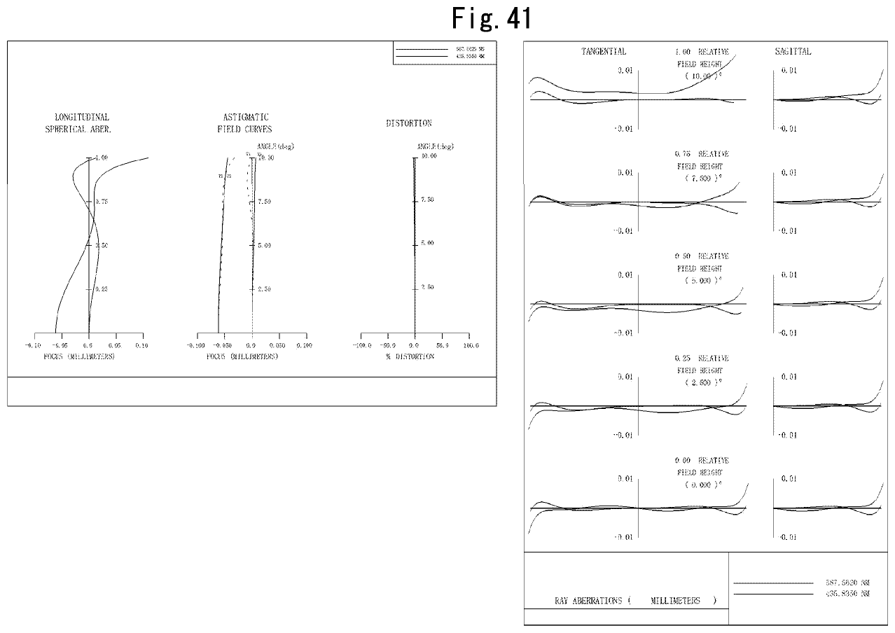

FIG. 41 shows aberrations of the second optical system OS2 included in the optical system 1 of Example 9-1.

The graphs of aberrations suggest that the second optical system OS2 of the present example corrects aberrations appropriately and has high optical performance.

### Example 9-2

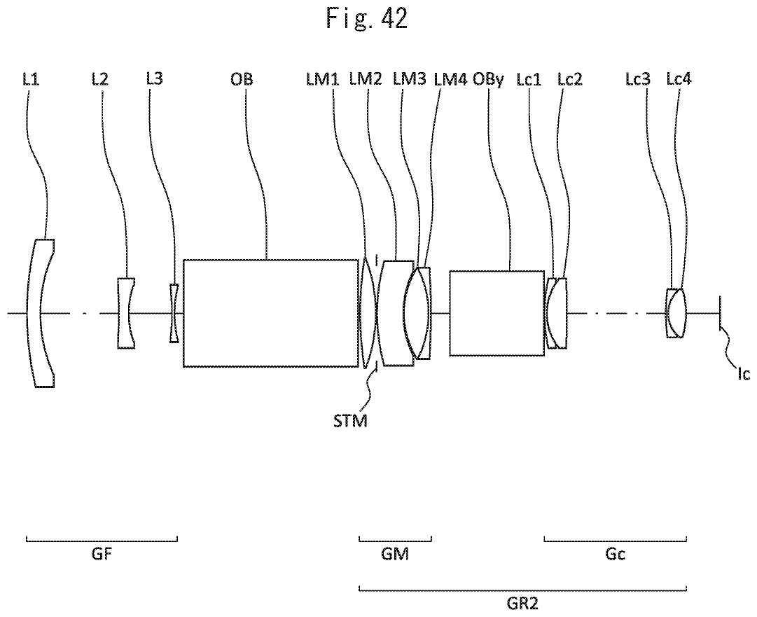

FIG. 42 is a cross-sectional view of a second optical system included in the optical system of Example 9-2.

The second optical system OS2 of the present example has, in order from the object side, a meniscus-shaped negative lens L1 convex on the object side, a biconcave negative lens L2, a biconcave negative lens L3, an optical path splitter OB, a biconvex positive lens LM1, an aperture stop STM, a meniscus-shaped negative lens LM2 convex surface on the object side, a positive cemented lens composed of a biconvex positive lens LM3 and a meniscus-shaped negative lens LLM4 concave on the object side, an optical path splitter OBy, a positive cemented lens composed of a meniscus-shaped negative lens Lc1 convex on the object side and a biconvex positive lens Lc2, and a positive cemented lens composed of a meniscus-shaped negative lens Lc3 convex on the object side and a biconvex positive lens Lc4.

An imaging element constructed from CCD or CMOS, or the like is disposed on the image plane Ic.

In the second optical system OS2 of the present example, the negative lens L1, negative lens L2, and negative lens L3 are included in the front lens group GF.

In the second optical system OS2 of the present example, the positive lens LM1, the negative lens LM2, the positive cemented lens consisting of the positive lens LM3 and the negative lens LM4, the optical path splitter OBy, the positive cemented lens composed of the negative lens Lc1 and the positive lens Lc2, and the positive cemented lens composed of the negative lens Lc3 and the positive lens Lc4 are included in the second rear lens group GR2.

Table 9-2-2 below shows the specifications of the second optical system OS2 of the

TABLE 9-2-2
[General Specifications]

| | |
|---|---|
| fB | 4.40 |
| TLB | 103.27 |
| FnoB | 2.24 |
| YmaxB | 2.26 |
| ωB | 30.0° |

[Lens Specifications]

| m | r | d | n(d) | νd | |
|---|---|---|---|---|---|
| 1) | 39.16597 | 2.000 | 1.773 | 49.62 | |
| 2) | 18.66022 | 11.700 | | | |
| *3) | −38.70105 | 1.500 | 1.694 | 53.20 | |
| *4) | 13.43728 | 6.400 | | | |
| 5) | −32.89788 | 0.400 | 1.593 | 67.90 | |
| 6) | 14.35387 | 1.350 | | | |
| 7) | ∞ | 26.000 | 1.569 | 56.00 | (optical splitter OB) |
| 8) | ∞ | 0.300 | | | |
| 9) | 42.94581 | 2.330 | 1.603 | 60.69 | |
| 10) | −19.44804 | 0.100 | | | |
| 11> | ∞ | 0.100 | | | (aperture stop STM) |
| 12) | 24.51982 | 3.900 | 1.744 | 44.80 | |
| 13) | 11.82353 | 0.100 | | | |
| 14) | 10.94909 | 3.660 | 1.498 | 82.57 | |
| 15) | −12.75472 | 0.350 | 1.744 | 44.80 | |
| 16) | −96.09217 | 2.830 | | | |
| 17) | ∞ | 14.000 | 1.569 | 56.00 | (optical splitter OBy) |
| 18) | ∞ | 0.100 | | | |
| 19) | 19.80441 | 0.350 | 1.744 | 44.80 | |
| 20) | 7.06065 | 3.000 | 1.581 | 40.98 | |
| 21) | −91.20537 | 14.735 | | | |
| 22) | 23.62158 | 0.350 | 1.755 | 27.57 | |
| 23) | 4.00000 | 2.660 | 1.589 | 61.25 | |
| *24) | −10.42435 | 5.052 | | | |

[Aspherical Surface Data]

| m | K | A4 | A6 | A8 | A10 |
|---|---|---|---|---|---|
| 3) | 5.7420 | 3.95E−04 | −2.07E−06 | 2.93E−09 | 5.51E−12 |
| 4) | 0.2784 | 6.62E−04 | −4.55E−06 | 3.07E−07 | −1.97E−09 |
| 24) | 3.4924 | 1.33E−04 | 9.88E−06 | 8.35E−08 | −9.66E−08 |

[Focal Length Data of Groups]

| Groups | Starting surfaces | Focal lengths |
|---|---|---|
| GF | 1 | −4.45 |
| GR2 | 9 | 153.04 |

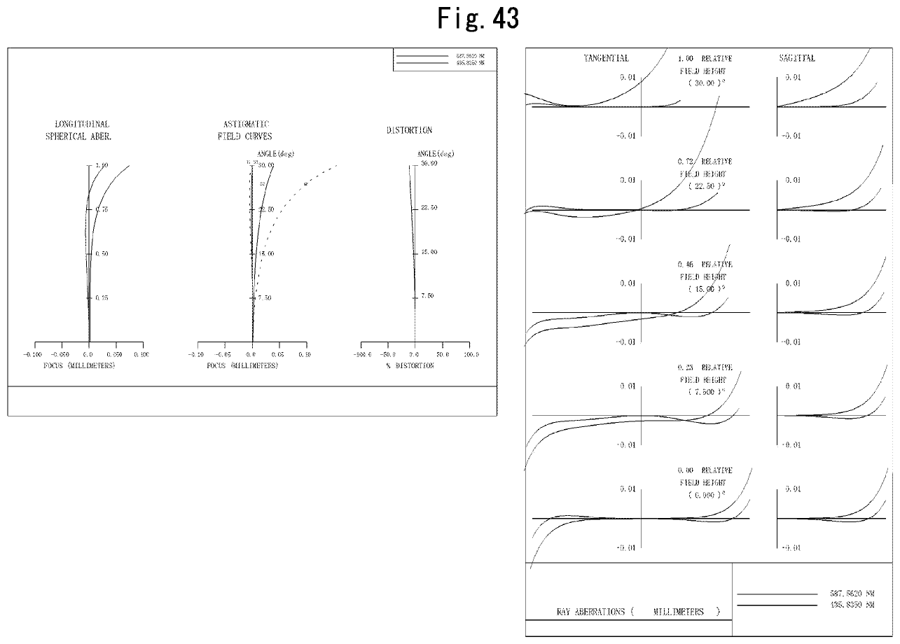

FIG. 43 shows aberrations of the second optical system OS2 included in the optical system 1 of Example 9-2.

The graphs of aberrations suggest that the second optical system OS2 of the present example corrects aberrations appropriately and has high optical performance.

### Example 10

In the optical system 1 of Example 10, the second optical system OS2 has a total focal length longer than a total focal length of the first optical system OS1. That is, the first optical system OS1 corresponds to a wide-angle optical system, and the second optical system OS2 corresponds to a telephoto optical system.

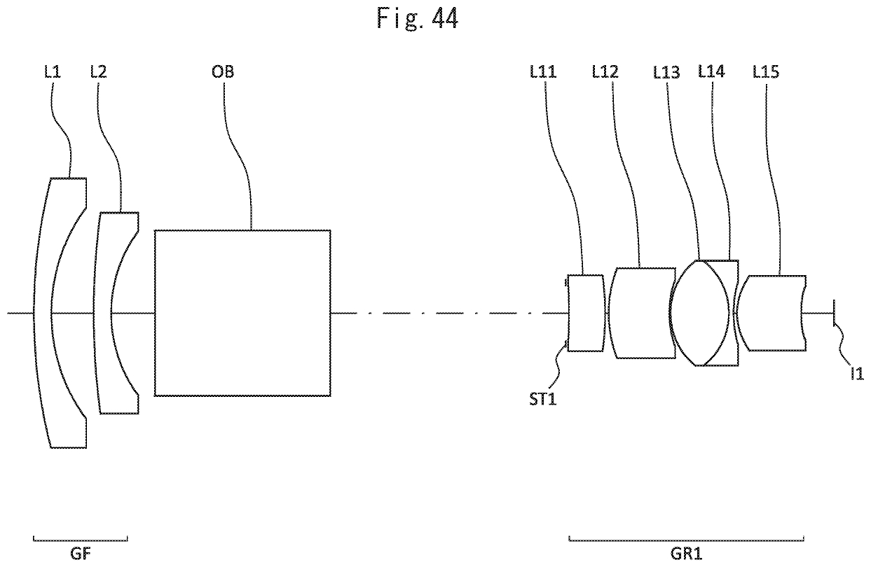

FIG. 44 is a cross-sectional view of a first optical system included in the optical system of Example 10.

The first optical system OS1 of the present example has, in order from the object side, a meniscus-shaped negative lens L1 convex on the object side, a meniscus-shaped negative lens L2 convex on the object side, an optical path splitter OB, an aperture stop ST1, a meniscus-shaped positive lens L11 concave on the object side, a meniscus-shaped negative lens L12 convex on the object side, a positive cemented lens composed of a biconvex positive lens L13 and a biconcave negative lens L14, and a meniscus-shaped positive lens L15 convex on the object side.

A first imaging element (not shown) constructed from a CCD or CMOS, or the like is disposed on the image plane I1.

In the first optical system OS1 of the present example, the negative lens L1 and the negative lens L2 are included in the front lens group GF.

In the first optical system OS1 of the present example, the positive lens L11, the negative lens L12, the positive cemented lens composed of the positive lens L13 and the negative lens L14, and the positive lens L15 are included in the first rear lens group GR1.

Table 10-1 below shows the specifications of the first optical system OS1 of the

TABLE 10-1
[General Specifications]

| | |
|---|---|
| fA | 2.80 |
| TLA | 68.48 |
| FnoA | 3.01 |
| YmaxA | 2.28 |
| ωA | 45.0° |
| Wi | 0.40 |

[Lens Specifications]

| m | r | d | n(d) | νd | |
|---|---|---|---|---|---|
| 1) | 39.35335 | 1.500 | 1.773 | 49.62 | |
| 2) | 13.16971 | 3.620 | | | |
| 3) | 54.65836 | 1.500 | 1.618 | 63.34 | |
| 4) | 10.24103 | 3.750 | | | |
| 5) | ∞ | 15.000 | 1.517 | 63.88 | (optical path splitter OB) |
| 6) | ∞ | 20.150 | | | |
| 7> | ∞ | 0.300 | | | (aperture stop ST1) |
| 8) | −33.44797 | 3.090 | 1.744 | 44.80 | |
| 9) | −19.90034 | 0.300 | | | |
| 10) | 9.22913 | 5.190 | 1.755 | 27.57 | |
| 11) | 7.29360 | 0.100 | | | |
| 12) | 5.06967 | 5.000 | 1.519 | 69.89 | |
| 13) | −4.98655 | 0.400 | 1.755 | 27.57 | |
| 14) | 8.28160 | 0.300 | | | |
| *15) | 4.27050 | 5.500 | 1.694 | 53.20 | |
| *16) | 11.53216 | 2.781 | | | |

[Aspherical Surface Data]

| m | K | A4 | A6 | A8 | A10 |
|---|---|---|---|---|---|
| 15) | −0.5510 | −7.61E−04 | −1.43E−04 | 1.23E−05 | −3.04E−07 |
| 16) | −0.1419 | −1.46E−04 | −1.09E−04 | 1.55E−05 | 7.86E−07 |

[Focal Length Data of Groups]

| Groups | Starting surfaces | Focal lengths |
|---|---|---|
| GF | 1 | −10.59 |
| GR1 | 8 | 9.57 |

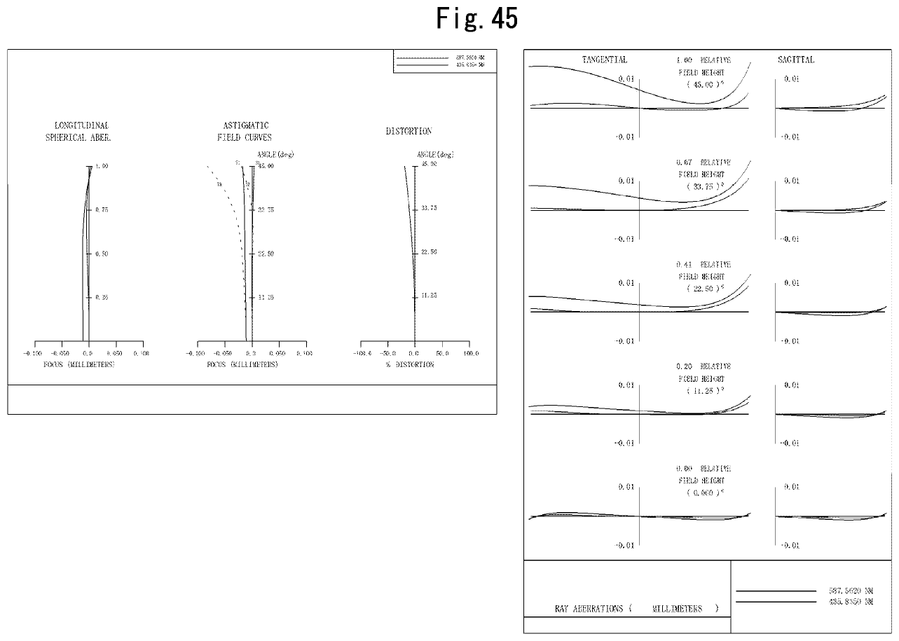

FIG. 45 shows aberrations of the first optical system OS1 included in the optical system 1 of Example 10.

The graphs of aberrations suggest that the first optical system OS1 of the present example corrects aberrations appropriately and has high optical performance.

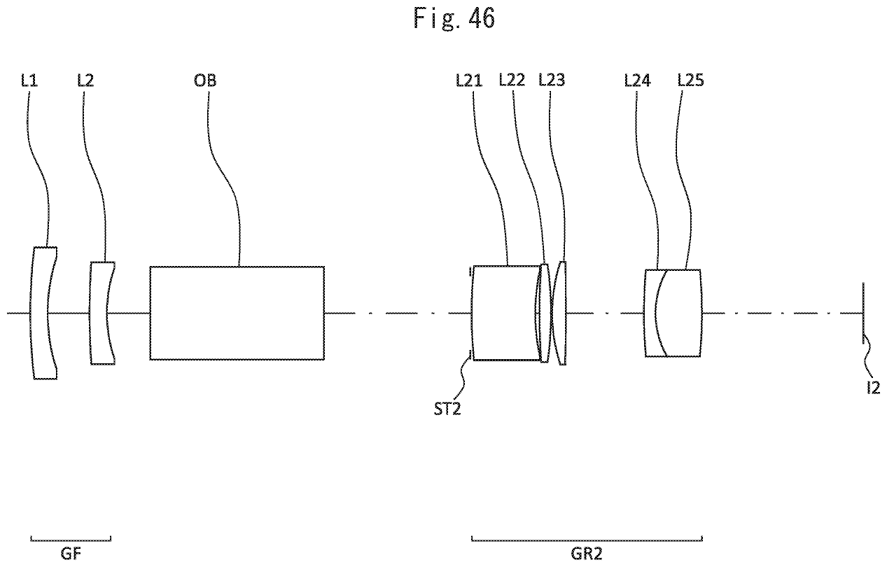

FIG. 46 is a cross-sectional view of a second optical system included in the optical system of Example 10.

The second optical system OS2 of the present example has, in order from the object side, a meniscus-shaped negative lens L1 convex on the object side, a meniscus-shaped negative lens L2 convex on the object side, an optical path splitter OB, an aperture stop ST2, a meniscus-shaped negative lens L21 convex on the object side, a biconvex positive lens L22, a biconvex positive lens L23, and a negative cemented lens composed of a meniscus-shaped negative lens L24 convex on the object side and a biconvex positive lens L25.

An imaging element constructed from CCD or CMOS, or the like is disposed on the image plane 12.

In the second optical system OS2 of the present example, the negative lens L1 and the negative lens L2 are included in the front lens group GF.

In the second optical system OS2 of the present example, the negative lens L21, the positive lens L22, the positive lens L23, and the negative cemented lens composed of the negative lens L24 and the positive lens L25 are included in the second rear lens group GR2.

Table 10-2 below shows the specifications of the second optical system OS2 of the

TABLE 10-2
[General Specifications]

| | |
|---|---|
| fB | 6.47 |
| TLB | 71.98 |
| FnoB | 3.94 |
| YmaxB | 2.26 |
| ωB | 20.0° |

[Lens Specifications]

| m | r | d | n(d) | νd | |
|---|---|---|---|---|---|
| 1) | 39.35335 | 1.500 | 1.773 | 49.62 | |
| 2) | 13.16971 | 3.620 | | | |
| 3) | 54.65836 | 1.500 | 1.618 | 63.34 | |
| 4) | 10.24103 | 3.750 | | | |
| 5) | ∞ | 15.000 | 1.517 | 63.88 | (optical splitter OB) |
| 6) | ∞ | 12.660 | | | |
| 7) | ∞ | 0.100 | | | (aperture stop ST2) |
| 8) | 33.53774 | 5.500 | 1.744 | 44.80 | |
| 9) | 14.64236 | 0.360 | | | |
| 10) | 47.95935 | 1.000 | 1.498 | 82.57 | |
| 11) | −25.09306 | 0.100 | | | |
| 12) | 12.03523 | 1.180 | 1.744 | 44.80 | |
| 13) | −169.40203 | 6.750 | | | |
| 14) | 37.30592 | 1.000 | 1.755 | 27.57 | |
| 15) | 6.38587 | 4.000 | 1.498 | 82.57 | |
| 16) | −34.22061 | 13.956 | | | |

[Focal Length Data of Groups]

| Groups | Starting surfaces | Focal lengths |
|---|---|---|
| GF | 1 | −10.59 |
| GR2 | 8 | 16.01 |

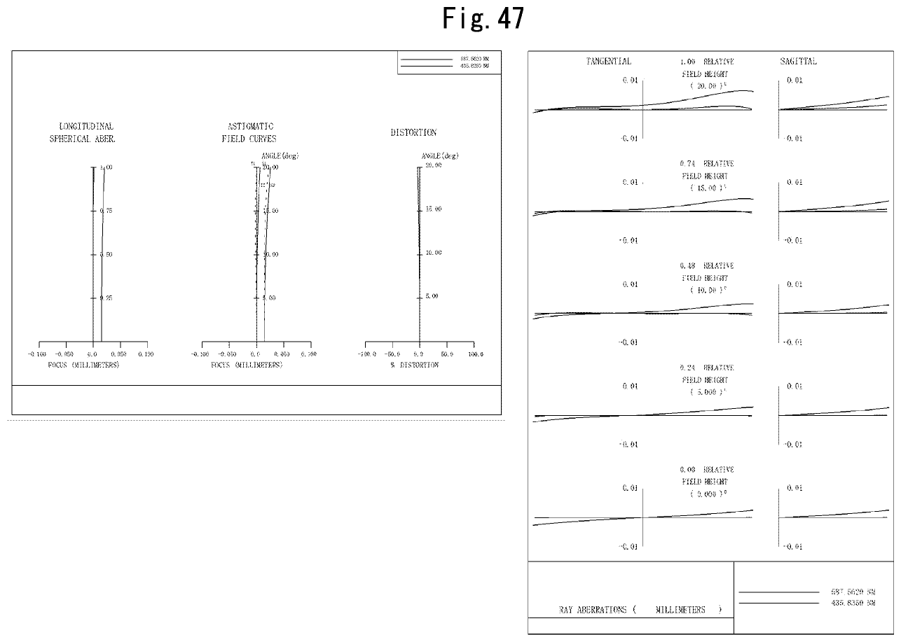

FIG. 47 shows aberrations of the second optical system OS2 included in the optical system 1 of Example 10.

The graphs of aberrations suggest that the second optical system OS2 of the present example corrects aberrations appropriately and has high optical performance.

An optical system that branches incident light and appropriately forms respective images can be achieved according to the above examples.

Values for the conditional expressions of the examples are listed below.

fA is the total focal length of the wide-angle optical system; fB is the total focal length of the telephoto optical system; fF is the focal length of the front lens group GF, and f1 is the focal length of the lens disposed closest to the object side in the front lens group GF. D12 is the distance on the optical axis between the lens disposed closest to the object side in the front lens group GF and the lens disposed adjacent to the image plane side of that lens.

TLA is the total optical length of the wide-angle optical system; TLB is the total optical length of the telephoto optical system. r11 is the radius of curvature of the object side lens surface of the lens disposed closest to the object side in the front lens group GF; r12 is the radius of curvature of the image side lens surface of the lens disposed closest to the object side in the front lens group GF; r21 is the radius of curvature of the object side lens surface of the lens disposed adjacent to the image side of the lens disposed closest to the object side in the front lens group GF. ωA is the semi-field angle of the wide-angle optical system; oB is the semi-field angle of the telephoto optical system.

fpA is the combined focal length of positive lens components continuously disposed toward the image side from the positive lens component disposed closest to the object side in the rear lens group included in the wide-angle optical system; fpB is the combined focal length of positive lens components continuously disposed toward the image side from the positive lens component disposed closest to the object side in the rear lens group included in the telephoto optical system. fRA is the focal length of the rear lens group included in the wide-angle optical system, and fRB is the focal length of the rear lens group included in the telephoto optical system.

nd1 is the refractive index at d-line of the lens disposed closest to the object side in the front lens group GF; nd2 is the refractive index at d-line of the lens disposed adjacent to the image side of the lens disposed closest to the object side in the front lens group GF; ndaveF is the average of the refractive indices at d-line of the lenses included in the front lens group GF. Wi is the reflectance or transmittance when the optical path of the wide-angle optical system is reflected or transmitted by the splitting plane BP.

### [Values for Conditional Expressions]

| Conditional expressions | Ex. 1 | Ex. 2 | Ex. 3 | Ex. 4 | Ex. 5 | Ex. 6 |
|---|---|---|---|---|---|---|
| (1) fB/fA | 6.843 | 8.691 | 6.260 | 6.039 | 6.768 | 3.429 |
| (2) −fF/fA | 3.800 | 2.670 | 2.233 | 5.576 | 3.182 | 3.842 |
| (3) −fF/fB | 0.555 | 0.307 | 0.357 | 0.923 | 0.470 | 1.120 |
| (4) −f1/fA | 10.576 | 29.494 | 11.672 | 10.846 | 9.367 | 8.176 |
| (5) −f1/fB | 1.546 | 3.393 | 1.864 | 1.796 | 1.384 | 2.384 |
| (6) −D12/f1 | 0.476 | 0.283 | 0.279 | 0.430 | 0.388 | 0.653 |
| (7) TLB/TLA | 1.097 | 1.554 | 1.887 | 0.992 | 1.590 | 1.072 |
| (8) −(r12 + r11)/(r12 − r11) | 1.396 | 2.537 | 2.427 | 1.307 | 1.479 | 1.422 |
| (9) (r21 + r12)/(r21 − r12) | 1.938 | 1.188 | 0.787 | 0.412 | 0.788 | 0.300 |
| (10) D12/fA | 5.036 | 8.354 | 3.251 | 4.668 | 3.638 | 5.336 |
| (11) D12/fB | 0.736 | 0.961 | 0.519 | 0.773 | 0.538 | 1.556 |
| (12) ωA/ωB | 9.048 | 9.700 | 7.800 | 9.100 | 9.100 | 4.525 |
| (13) fpA/fpB | 1.149 | 1.905 | 0.443 | 1.015 | 1.093 | 1.301 |
| (14) \|fRB/fRA\| | 5.230 | 1.206 | 3.041 | 4.421 | 42.160 | 1.428 |
| (15) TLB/fA | 41.726 | 75.880 | 40.917 | 46.401 | 41.681 | 39.006 |
| (16) TLA/fB | 5.558 | 5.619 | 3.464 | 7.744 | 3.872 | 10.608 |
| (17) nd1 | 1.755 | 1.773 | 1.755 | 1.744 | 1.720 | 1.755 |
| (18) nd2 | 1.618 | 1.694 | 1.618 | 1.487 | 1.553 | 1.618 |
| (19) ndaveF | 1.687 | 1.686 | 1.687 | 1.662 | 1.707 | 1.709 |
| (20) ωA | 95.0° | 97.0° | 78.0° | 91.0° | 91.0° | 90.5° |
| (21) ωB | 10.5° | 10.0° | 10.0° | 10.0° | 10.0° | 20.0° |
| (22) Wi/(1 − Wi) | 0.250 | 0.250 | 0.111 | 0.250 | 0.111 | 0.429 |
| Conditional expressions | Ex. 7 | Ex. 8-1 | Ex. 8-2 | Ex. 9-1 | Ex. 9-2 | Ex. 10 |
| (1) fB/fA | 3.412 | 8.696 | 2.121 | 8.813 | 2.104 | 2.308 |
| (2) −fF/fA | 3.894 | 2.983 | 2.128 | 2.983 | 2.128 | 3.780 |
| (3) −fF/fB | 1.141 | 0.343 | 1.003 | 0.339 | 1.011 | 1.637 |
| (4) −f1/fA | 8.186 | 32.286 | 23.030 | 32.286 | 23.030 | 9.381 |
| (5) −f1/fB | 2.399 | 3.713 | 10.856 | 3.664 | 10.947 | 4.064 |
| (6) −D12/f1 | 0.652 | 0.243 | 0.243 | 0.243 | 0.243 | 0.138 |
| (7) TLB/TLA | 1.187 | 1.642 | 1.300 | 1.977 | 1.438 | 1.051 |
| (8) −(r12 + r11)/(r12 − r11) | 1.422 | 2.820 | 2.820 | 2.820 | 2.820 | 2.006 |
| (9) (r21 + r12)/(r21 − r12) | 0.300 | 0.349 | 0.349 | 0.349 | 0.349 | 1.635 |
| (10) D12/fA | 5.337 | 7.839 | 5.592 | 7.839 | 5.592 | 1.292 |
| (11) D12/fB | 1.564 | 0.901 | 2.636 | 0.890 | 2.658 | 0.560 |
| (12) ωA/ωB | 4.500 | 9.100 | 2.333 | 9.100 | 2.333 | 2.250 |
| (13) fpA/fpB | 0.960 | 1.120 | 1.107 | 1.117 | 1.104 | — |
| (14) \|fRB/fRA\| | 1.401 | 1.112 | 2.864 | 0.878 | 11.478 | 1.674 |
| (15) TLB/fA | 43.269 | 79.756 | 44.619 | 96.045 | 49.357 | 25.694 |
| (16) TLA/fB | 10.683 | 5.587 | 16.179 | 5.513 | 16.314 | 10.590 |
| (17) nd1 | 1.755 | 1.773 | 1.773 | 1.773 | 1.773 | 1.773 |
| (18) nd2 | 1.618 | 1.694 | 1.694 | 1.694 | 1.694 | 1.618 |
| (19) ndaveF | 1.709 | 1.686 | 1.686 | 1.686 | 1.686 | 1.695 |
| (20) ωA | 90.0° | 91.0° | 70.0° | 91.0° | 70.0° | 45.0° |
| (21) ωB | 20.0° | 10.0° | 30.0° | 10.0° | 30.0° | 20.0° |
| (22) Wi/(1 − Wi) | 0.111 | 0.250 | 0.250 | 0.111 | 0.111 | 0.667 |

The above examples are specific examples of the present invention, and the present invention is not limited thereto. The following features can be appropriately employed unless the optical performance of the optical system of the present embodiment is compromised.

The optical system of the present embodiment may include an optical member, such as a filter, between the image plane and a lens surface closest to the image plane.

In the optical system of the present embodiment, lens surfaces may be spherical, plane, or aspherical surfaces. Spherical or plane lens surfaces are preferable because they facilitate lens machining, assembling, and adjustment and prevent a decrease in optical performance caused by errors in machining, assembling, and adjustment and because depiction performance does not decrease much when the image plane is shifted.

An aspherical lens surface may be formed by grinding glass or glass molding with a mold having an aspherical shape, or formed on the surface of resin bonded on a glass surface. In the optical system of the present embodiment, lens surfaces may be diffractive surfaces, and lenses may be graded index lenses (GRIN lenses) or plastic lenses.

The lens surfaces of the lenses constituting any of the optical systems of the present embodiment may be covered with antireflection coating having high transmittance in a wide wavelength range. This reduces flares and ghosts, and enables achieving optical performance with high contrast.

In the optical system of the present embodiment, a lens frame or the like may be used as a substitute of the aperture stop, without using a separate member.

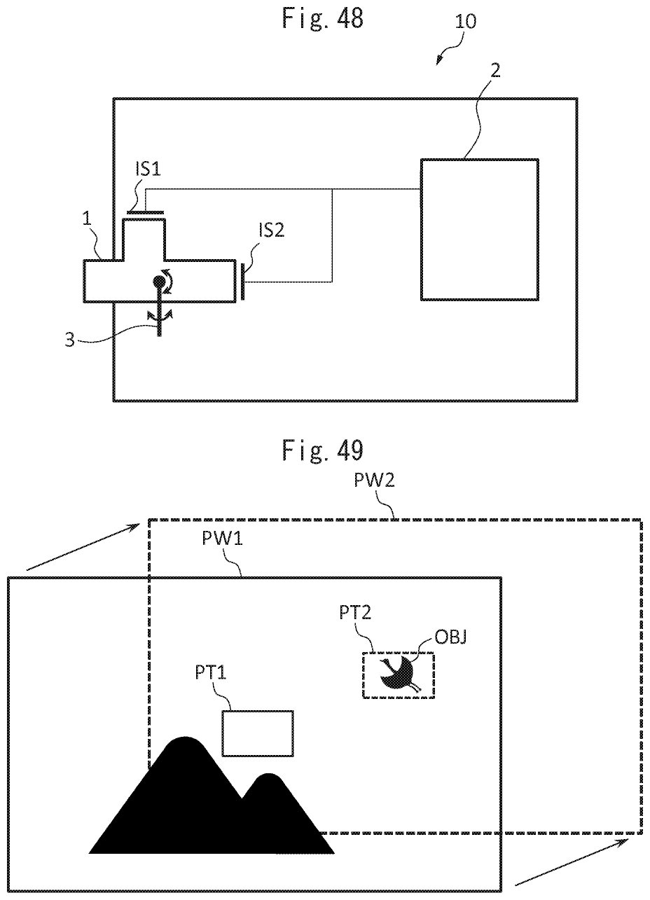

Next, an optical device including the optical system 1 of the present embodiment will be described with reference to FIG. 48. FIG. 48 schematically shows an optical device 10 including the optical system 1 of the present embodiment.

The optical device 10 includes the optical system 1 of Example 1, an information processor 2, a drive unit 3, a first imaging unit IS1, and a second imaging unit IS2.

The first imaging unit IS1 and the second imaging unit IS2 each include an imaging component constructed from CCD, CMOS, or the like. In the optical apparatus 10, the first imaging unit IS1 and the second imaging unit IS2 are disposed on the image plane I1 and the image plane 12 of the optical system 1, respectively, and output image information corresponding to incident light. The information processor 2 executes processing with image information outputted by the first imaging unit IS1 and the second imaging unit IS2.

The drive unit 3 has, for example, an actuator, and changes the orientation of the optical system 1 according to control signals received from the information processor 2. The information processor 2 may generate control signals based on image information representing an image from the wide-angle optical system.

FIG. 49 is a diagram illustrating an example of operation of a driving unit in the optical device of the embodiment. In the optical system 1 of Example 1, the first optical system OS1 that forms an image on the image plane I1 is the wide-angle optical system, and the second optical system OS2 that forms an image on the image plane 12 is the telephoto optical system. Therefore, the range represented in the image information PW1 outputted by the first imaging element IS1 is wider than the range represented in the image information PT1 outputted by the second imaging element IS2.

In the example of FIG. 49, the object OBJ is included in the image information PW1 but is not included in the image information PT1. The information processor 2 detects the object OBJ from the image information PW1 and identifies the direction of the object OBJ based on the position of the object OBJ in the image information PW1 and the focal length of the first optical system OS1. Then, the information processor 2 generates a control signal for causing the drive unit 3 to change the orientation of the optical system 1 toward the identified object OBJ.

The optical device 10 can acquire image information PT2 including the object OBJ by the telephoto optical system of the optical system 1, whose orientation is changed by the operation of the drive unit 3 according to such control signal. In this way, the optical device 10 of the present embodiment can appropriately change the orientation of the optical system 1 based on the situation over a wide range represented in the image obtained by the wide-angle optical system.

The drive unit 3 may be configured to change the orientation of the optical system 1 by changing the orientation of the optical device 10.

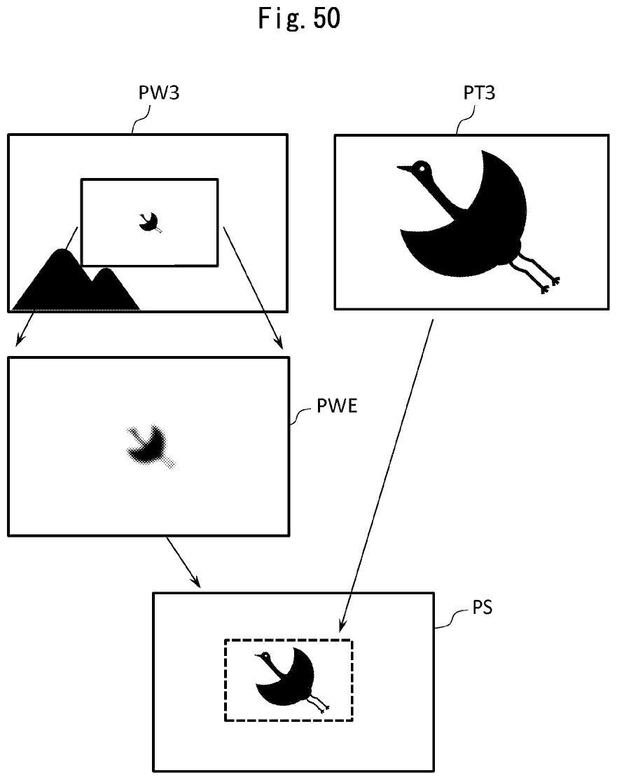

The optical device 10 may generate image information based on the image information representing an image of the wide-angle optical system and the image information representing an image of the telephoto optical system. FIG. 50 is a diagram showing an example of image information generated by the optical device of the embodiment.

The information processor 2 generates an enlarged image PWE by enlarging a part of the image information PW3 representing an image of the wide-angle optical system. The enlarged image PWE is an example of first image information that is an enlargement of a part of the image of the wide-angle optical system.

The information processor 2 generates a composite image PS including the enlarged image PWE and image information PT3 representing an image of the telephoto optical system. The image information PT3 is an example of second image information representing at least a part of the image of the telephoto optical system. The information processor 2 operates as a combining unit that combines the first image information and the second image information.

In the example of FIG. 50, the information processor 2 generates an image with a field angle between the field angle of the wide-angle optical system and the field angle of the telephoto optical system by enlarging the image information PW3 representing an image of the wide-angle optical system. By using at least a part of the image information PT3 representing an image of the telephoto optical system instead of an image obtained by enlarging the image information PW3 representing an image of the wide-angle side optical system for the central portion of the image, a composite image PS can be obtained with a clearly represented central portion. The information processor 2 may generate the composite image PS by using an image obtained by reducing at least a part of the image information PT3.

The composite image PS outputted by the optical apparatus 10 of this embodiment enables the comparison between a portion included in the image obtained by the wide-angle optical system and an image included in the image obtained by the telephoto optical system.

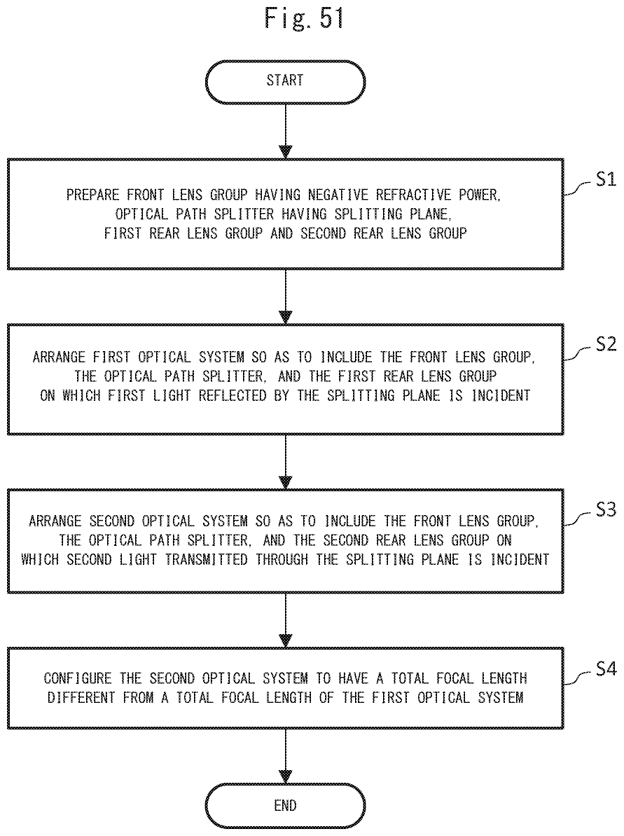

Finally, a method for manufacturing the optical system 1 of the present embodiment will be outlined with reference to FIG. 51. FIG. 51 is a flowchart outlining a method for manufacturing the optical system 1 of the present embodiment.

The method for manufacturing the optical system 1 of the present embodiment shown in FIG. 51 includes steps S1 through S4 below.

Step S1: a front lens group GF having negative refractive power, an optical path splitter OB having a splitting plane BP, a first rear lens group GR1, and a second rear lens group GR2 are prepared.

Step S2: the first optical system OS1 is arranged so as to include the front lens group GF, the optical path splitter OB, and the first rear lens group GR1 on which the first light reflected by the splitting plane BP is incident.

Step S3: the second optical system OS2 is arranged so as to include the front lens group GF, the optical path splitter OB, and the second rear lens group GR2 on which the second light transmitted through the splitting plane BP is incident.

Step S4: the second optical system OS2 is configured to have a total focal length different from a total focal length of the first optical system OS1.

An optical system that branches incident light and appropriately forms respective images can be manufactured by the method for manufacturing an optical system of the present embodiment.

It should be noted that those skilled in the art can make various changes, substitutions, and modifications without departing from the spirit and scope of the present disclosure.

What is claimed is:

1. An optical system comprising:
a first optical system including, in order from the object side, a front lens group, an optical path splitter having a splitting plane, and a first rear lens group on which light that enters the front lens group and the optical path splitter and that is reflected by the splitting plane is incident; and
a second optical system including, in order from the object side, the front lens group, the optical path splitter, and a second rear lens group on which light that enters the front lens group and the optical path splitter and that is transmitted through the splitting plane is incident,
wherein the second optical system has a total focal length different from a total focal length of the first optical system.

2. The optical system according to claim 1, wherein the following conditional expression is satisfied.
$$1. 20 < fB / fA < 13.00$$
where
fB: the longer of the total focal length of the first optical system and the total focal length of the second optical system
fA: the shorter of the total focal length of the first optical system and the total focal length of the second optical system

3. The optical system according to claim 1, wherein the following conditional expression is satisfied.
$$0.2 < - fF / fA < 10.00$$
where
fF: focal length of the front lens group
fA: the shorter of the total focal length of the first optical system and the total focal length of the second optical system

4. The optical system according to claim 1, wherein the following conditional expression is satisfied.
$$0.05 < - fF / fB < 3. 50$$
where
fF: focal length of the front lens group
fB: the longer of the total focal length of the first optical system and the total focal length of the second optical system

5. The optical system according to claim 1, wherein the following conditional expression is satisfied.
$$3.5 < - f 1 < fA < 50.30$$
where
f1: the focal length of the lens disposed closest to the object side in the front lens group
fA: the shorter of the total focal length of the first optical system and the total focal length of the second optical system

6. The optical system according to claim 1, wherein the following conditional expression is satisfied.
$$0.25 < - f 1 / fB / 15. 00$$
where
f1: the focal length of the lens disposed closest to the object side in the front lens group
fB: the longer of the total focal length of the first optical system and the total focal length of the second optical system

7. The optical system according to claim 1, wherein the following conditional expression is satisfied.
$$0.04 < - D 12 / f 1 < 1.50$$
where
D12: the distance on the optical axis between the image side lens surface of the lens disposed closest to the object side in the front lens group and the object side lens surface of the lens disposed adjacent to the image side of the lens disposed closest to the object side in the front lens group
f1: the focal length of the lens disposed closest to the object side in the front lens group

8. The optical system according to claim 1, wherein the following conditional expression is satisfied.
$$0.3 < - ( r 12 + r 11 ) / ( r 12 - r 11 ) < 4.70$$
where
r12: the radius of curvature of the image side lens surface of the lens disposed closest to the object side in the front lens group
r11: the radius of curvature of the object side lens surface of the lens disposed closest to the object side in the front lens group

9. The optical system according to claim 1, wherein the following conditional expression is satisfied.
$$0.1 < ( r 21 + r 12 ) / ( r 21 - r 12 ) < 3.30$$
where
r21: radius of curvature of the object side lens surface of the lens disposed adjacent to the image side of the lens disposed closest to the object side in the front lens group
r12: the radius of curvature of the image side lens surface of the lens disposed closest to the object side in the front lens group

10. The optical system according to claim 1, wherein the following conditional expression is satisfied.
$$0.3 < D 12 / fA < 11.3$$
where
D12: the distance on the optical axis between the image side lens surface of the lens disposed closest to the object side in the front lens group and the object side lens surface of the lens disposed adjacent to the image side of the lens disposed closest to the object side in the front lens group
fA: the shorter of the total focal length of the first optical system and the total focal length of the second optical system

11. The optical system according to claim 1, wherein the following conditional expression is satisfied.
$$0.07 < D 12 / fB < 4.3$$
where
D12: the distance on the optical axis between the image side lens surface of the lens disposed closest to the object side in the front lens group and the object side lens surface of the lens disposed adjacent to the image side of the lens disposed closest to the object side in the front lens group
fB: the longer of the total focal length of the first optical system and the total focal length of the second optical system

12. The optical system according to claim 1, wherein the following conditional expression is satisfied.
$$1. 20 < ω A / ω B < 15.00$$
where,
ωA: the semi-field angle of the optical system having the shorter total focal length among the first optical system and the second optical system
ωB: the semi-field angle of the optical system having the longer total focal length among the first optical system and the second optical system

13. The optical system according to claim 1, wherein the following conditional expression is satisfied.
$$0.2 < fpA / fpB < 2.50$$
where
fpA: the combined focal length of positive lens components continuously disposed toward the image plane side from the positive lens component disposed closest to the object side in a rear lens group among the first rear lens group and the second rear lens group, the rear lens group included in the optical system having the shorter total focal length among the first optical system and the second optical system
fpB: the combined focal length of positive lens components continuously disposed toward the image plane side from the positive lens component disposed closest to the object side in a rear lens group among the first rear lens group and the second rear lens group, the rear lens group included in the optical system having the longer total focal length among the first optical system and the second optical system

14. The optical system according to claim 1, wherein the following conditional expression is satisfied.
$$0.33 < \vert fRB / fRA \vert < 65.$$
where
fRB: the focal length of a rear lens group included in the first rear lens group and the second rear lens group, the rear lens group included in the optical system having the longer total focal length among the first optical system and the second optical system
fRA: the focal length of a rear lens group included in the first rear lens group and the second rear lens group, the rear lens group included in the optical system having the shorter total focal length among the first optical system and the second optical system

15. The optical system according to claim 1, wherein the following conditional expression is satisfied.
$$7. < TLB / fA < 11 \; 0.00$$
where
TLB: the total optical length of the optical system having the longer total focal length among the first optical system and the second optical system
fA: the shorter of the total focal length of the first optical system and the total focal length of the second optical system

16. The optical system according to claim 1, wherein the following conditional expression is satisfied.
$$1. 70 < nd 1 < 2.01$$
where
nd1: the refractive index at d-line of the lens disposed closest to the object side in the front lens group

17. The optical system according to claim 1, wherein the following conditional expression is satisfied.
$$1. 55 < ndaveF < 2.01$$
where
ndaveF: an average of the refractive indices at d-line of the lenses included in the front lens group

18. The optical system according to claim 1, wherein the following conditional expression is satisfied.
$$0. 10 < Wi / ( 1 - Wi ) \leq 1.$$
where,
Wi: When the optical path of the optical system with the shorter total focal length among the first optical system and the second optical system is reflected by the splitting plane, the reflectance of the splitting plane; when the optical path of the optical system with the shorter total focal length among the first optical system and the second optical system is transmitted through the splitting plane, the transmittance of the splitting plane

19. The optical system according to claim 1, wherein at least one of the first rear lens group and the second rear lens group has a second optical path splitter having a second splitting plane that reflects a part of incident light and transmits at least a part different from the part of incident light, a third rear lens group on which at least a part of the light reflected by the second splitting plane is incident, and a fourth rear lens group on which at least a part of the light transmitted through the second splitting plane is incident.

20. The optical system according to claim 19, wherein a lens group among the first rear lens group and the second rear lens group, having the second optical path splitter, the third rear lens group, and the fourth rear lens group, has an intermediate lens group with positive refractive power between the optical path splitter and the second optical path splitter.

21. The optical system according to claim 1, wherein the image plane of the first optical system and the image plane of the second optical system are disposed on the same plane

22. The optical system according to claim 21, wherein the first optical system further has, between the optical path splitter and the image plane, a first optical path deflector that deflects the optical path of the light reflected by the splitting plane to be parallel to the optical path of the light transmitted through the splitting plane, and a second optical path deflector that deflects the optical path of the light reflected by the splitting plane deflected by the first optical path deflector so that the distance from the optical path of the light transmitted through the splitting plane becomes shorter.

23. An optical device comprising the optical system according to claim 1.

24. The optical device according to claim 23, comprising a drive unit that changes orientation of the optical system based on image information representing the image of the optical system with the shorter total focal length among the first optical system and the second optical system.

25. The optical device according to claim 23, further comprising a combining unit that combines first image information, which is an enlarged part of the image of the optical system with the shorter total focal length among the first optical system and the second optical system, and second image information representing at least a part of the image of the optical system with the longer total focal length among the first optical system and the second optical system.

26. A method for manufacturing an optical system comprising a splitting plane that transmits a first part of incident light and reflects at least a second part of the incident light different from the first part, and that forms images of first light that is at least a part of light reflected by the splitting plane and second light that is at least a part of light transmitted through the splitting plane, the method including:
arranging a first optical system to include, in order from an object side, a front lens group having negative refractive power, an optical path splitter having the splitting plane, and a first rear lens group on which the first light is incident;
arranging a second optical system to include, in order from the object side, the front lens group, the optical path splitter, and a second rear lens group on which the second light is incident; and
configuring the second optical system to have a total focal length different from a total focal length of the first optical system.
